(19) United States
(12) Patent Application Publication
(10) Pub. No.: US 2018/0367862 A1
(43) Pub. Date: Dec. 20, 2018

(54) TERMINAL APPARATUS AND CONTROL SERVER

(71) Applicant: SHARP KABUSHIKI KAISHA, Sakai City, Osaka (JP)

(72) Inventors: MIHO HORII, Sakai City (JP); TADAMICHI ATSUMI, Sakai City (JP); MASAYUKI AOYAMA, Sakai City (JP); HIROSHI UCHIKI, Sakai City (JP); TORU UEDA, Sakai City (JP); KATSUYA MARUKI, Sakai City (JP); SHIGERU KOBAYASHI, Sakai City (JP)

(73) Assignee: SHARP KABUSHIKI KAISHA, Sakai City, Osaka (JP)

(21) Appl. No.: 15/753,113

(22) PCT Filed: Sep. 15, 2016
(86) PCT No.: PCT/JP2016/077206

§ 371 Date: Feb. 15, 2018

(30) Foreign Application Priority Data
Oct. 2, 2015 (JP) 2015-197098
Apr. 20, 2016 (JP) 2016-084696

(51) Int. Cl. H04N 21/482; H04N 21/466

(52) U.S. Cl. CPC H04N 21/4826; G10L 13/043; H04N 21/4668

(57) ABSTRACT

Diversity is provided to an output mode of recommendation information. A terminal apparatus (2) includes a recommendation information acquisition unit (208) that selects a layout at which recommendation information is output, from among a plurality of pieces of layout information (114), and a recommendation screen generation unit (208) that output the recommendation information at the selected layout.

### TECHNICAL FIELD

The present invention relates to a terminal apparatus or the like that outputs recommendation information on content.

### BACKGROUND ART

Technologies that recommend a program that meets a preference of a user are known in the related art. For example, in PTL 1, an information processing apparatus is disclosed that calculates the degree of similarity between a program feature vector and a user preference vector of each program that is being broadcast and determines a prescribed number of highly-ranked programs that have a high level of similarity, as recommendation programs. Furthermore, technologies that recommend the content to a user are also disclosed in PTL 2 and PTL 3.

### CITATION LIST

### Patent Literature

PTL 1: Japanese Unexamined Patent Application Publication No. 2011-142432 (published on Jul. 21, 2011)

PTL 2: Japanese Unexamined Patent Application Publication No. 2001-275048 (published on Oct. 5, 2001)

PTL 3: Japanese Unexamined Patent Application Publication No. 2012-248199 (published on Dec. 13, 2012)

### SUMMARY OF INVENTION

### Technical Problem

However, in the related art described above, a recommendation program can be determined, but there is a problem in that diversity cannot be provided to an output mode when a recommendation program is presented to a user. An object of the present invention, which was made in view of the problem described above, is to provide a terminal apparatus or the like that is capable of providing diversity to an output mode of recommendation information.

### Solution to Problem

In order to solve the problem described above, according to an aspect of the present invention, there is provided a terminal apparatus that outputs recommendation information, includes a format selection unit that selects a format in which the recommendation information is output, from among a plurality of formats; and an output control unit that outputs the recommendation information in the format that is selected by the format selection unit.

### Advantageous Effects of Invention

According to an aspect of the present invention, an effect of providing diversity to an output mode of recommendation information is achieved.

### BRIEF DESCRIPTION OF DRAWINGS

FIG. 1 is a block diagram illustrating an example of main configuration of an STB and a terminal apparatus according to an embodiment of the present invention.

FIG. 2 is a block diagram illustrating an example of main configuration of a server according to an embodiment of the present invention.

FIG. 3 is a block diagram illustrating an example of main configuration of a terminal apparatus according to an embodiment of the present invention.

FIG. 4 is a block diagram illustrating an outline of a recommending system according to an embodiment of the present invention.

FIG. 5 is a diagram illustrating an example of a display layout for recommendation information.

FIG. 6 is a diagram illustrating an example of switching between turning-on and turning-off of display in accordance with a result of detection of a user.

FIG. 7 is a diagram illustrating an example of a recommendation screen on which recommendation information dedicated for morning hours is displayed in a layout dedicated for the morning hours.

FIG. 8 is a diagram illustrating an example of the recommendation screen on which the recommendation information dedicated for afternoon hours is displayed in a layout dedicated for the afternoon hours.

FIG. 9 is a diagram illustrating an example of the recommendation screen on which the recommendation information dedicated for night hours is displayed in a layout dedicated for the night hours.

FIG. 10 is a diagram illustrating an example in which user-specified recommendation information is displayed in a highlighted manner.

FIG. 11 is a diagram illustrating an example of a recommendation screen in a layout in which a plurality of tiles are vertically arranged.

FIG. 12 is a diagram illustrating an example of the recommendation screen on which the recommendation information is displayed on a circular tile.

FIG. 13 is a diagram illustrating an example of the recommendation screen on which the recommendation information is displayed in text.

FIG. 14 is a flowchart illustrating an example of a flow for processing that is performed in the recommending system.

FIG. 15 is a flowchart illustrating an example of processing that dynamically changes a layout for the recommendation information.

FIG. 16 is a flowchart illustrating an example of processing that generates the recommendation information in accordance with a plurality of users.

FIG. 17 is a flowchart illustrating an example of processing that acquires the recommendation information and layout information in accordance with a time span.

FIG. 18 is a diagram illustrating an example of the recommendation screen.

FIG. 19 is a diagram illustrating an example of a hardware configuration for detection of the user by the terminal apparatus.

FIG. 20 is a sequence diagram illustrating an example of state transition of the terminal apparatus.

FIG. 21 is a flowchart illustrating an example of a flow for the processing of generation of the recommendation information.

FIG. 22 is a diagram illustrating an example of a configuration of the recommending system.

FIG. 23 is a diagram illustrating an example of the configuration of the recommending system.

FIG. 24 is a diagram for describing the recommendation information in accordance with a cycle and a timing of an action history.

FIG. 25 is a diagram for describing an operation of the recommending system according to an embodiment of the present invention.

FIG. 26 is a diagram illustrating an example of the recommendation screen.

FIG. 27 is a block diagram illustrating an outline of the recommending system.

FIG. 28 is a diagram illustrating a flow from generation of a card to display of the card.

FIG. 29 is a diagram for describing an outline of operation of each of the STB and the terminal apparatus that are included in the recommending system.

FIG. 30 is a diagram illustrating an example of the card for recommending broadcast content to the user.

FIG. 31 is a diagram illustrating an example of the card for recommending external content to the user.

FIG. 32 is a flowchart illustrating a flow for processing relating to display of the recommendation screen and selection of the card.

### DESCRIPTION OF EMBODIMENTS

### Embodiment 1

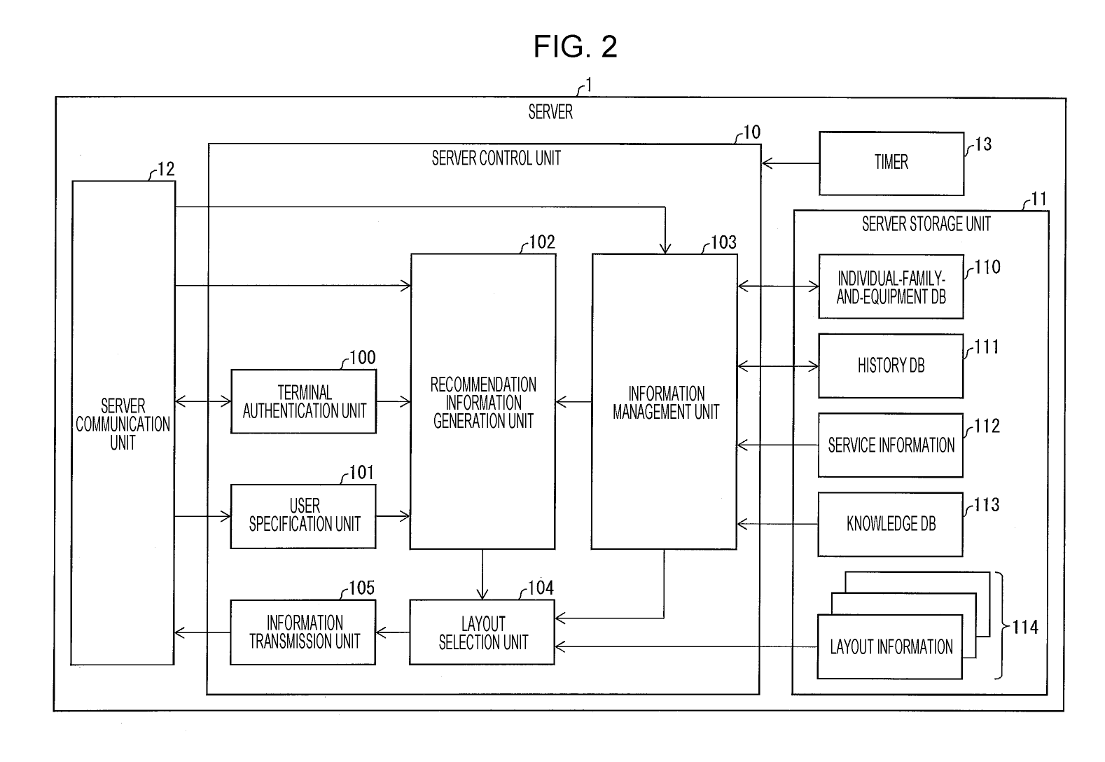

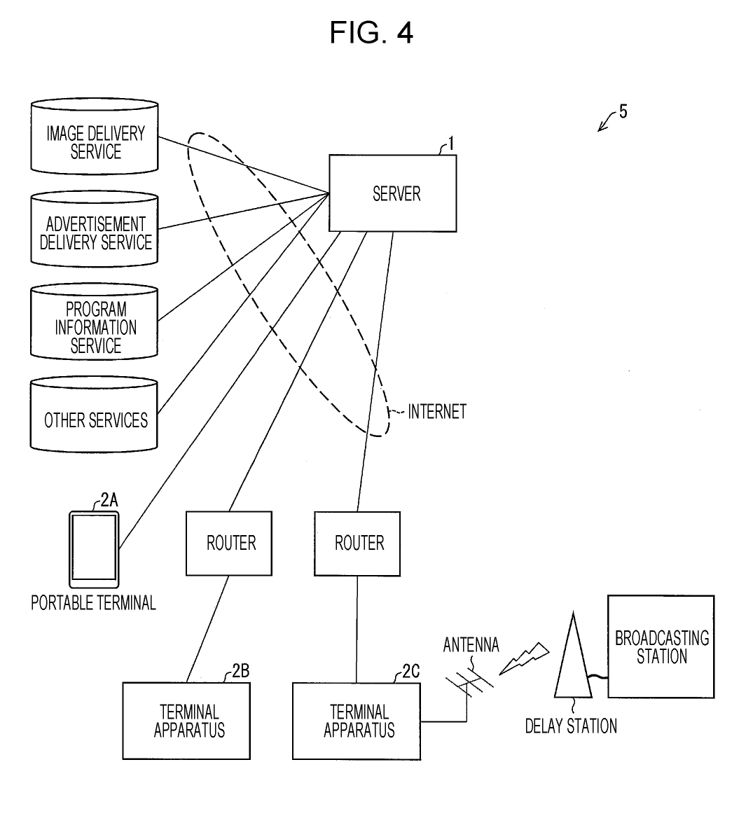

An embodiment 1 according to the present invention will be described below with reference to FIGS. 2 to 24. First, an overview of a recommending system 5 according to an embodiment of the present invention will be described with reference to FIG. 4. FIG. 4 is a block diagram illustrating an overview of the recommending system 5. As illustrated, the recommending system 5 includes a server (a control server) 1 and terminal apparatuses 2A to 2C. It is noted that the terminal apparatuses 2A to 2C are simply referred to as the terminal apparatus 2 when the terminal apparatuses 2A to 2C do not need to be distinguished from each other.

The server 1 generates recommendation information destined for a user of the terminal apparatus 2, based on information that is acquired from the terminal apparatus 2 and various services (an image delivery service, an advertisement delivery service, a program information service, and other services in an example that is illustrated). Then, the server 1 transmits the generated recommendation information to the terminal apparatus 2, along with layout information indicating a display layout for the recommendation information. The recommendation information, which will be described in detail below, is information indicating content for which viewing or reading is recommended to a user.

The terminal apparatus 2 not only includes a function of receiving and displaying broadcast content from a broadcasting station, but also includes a function of receiving and displaying content on the Internet (hereinafter expressed as Internet content or external content). Furthermore, the terminal apparatus 2, as described above, receives the recommendation information and the layout information that are transmitted by the server 1, and displays the recommendation information in a layout that is indicated by the layout information.

Among the terminal apparatuses 2 that are illustrated, the terminal apparatus 2A is an apparatus (for example, a smartphone or a portable telephone) that has access to the server 1 without a router being involved. Furthermore, the terminal apparatuses 2B and 2C are apparatuses that have access to the server 1 through the router. The terminal apparatuses 2B and 2C, for example, may be personal computers (hereinafter expressed as PCs) or television receivers (hereinafter expressed as television sets). It is noted that in an example that is illustrated, a situation where a radio wave (broadcast content) from a relay station is received through an antenna is illustrated, but that the broadcast content may be received with a cable television set or an Internet Protocol (IP) television set.

[Display Layout for the Recommendation Information]

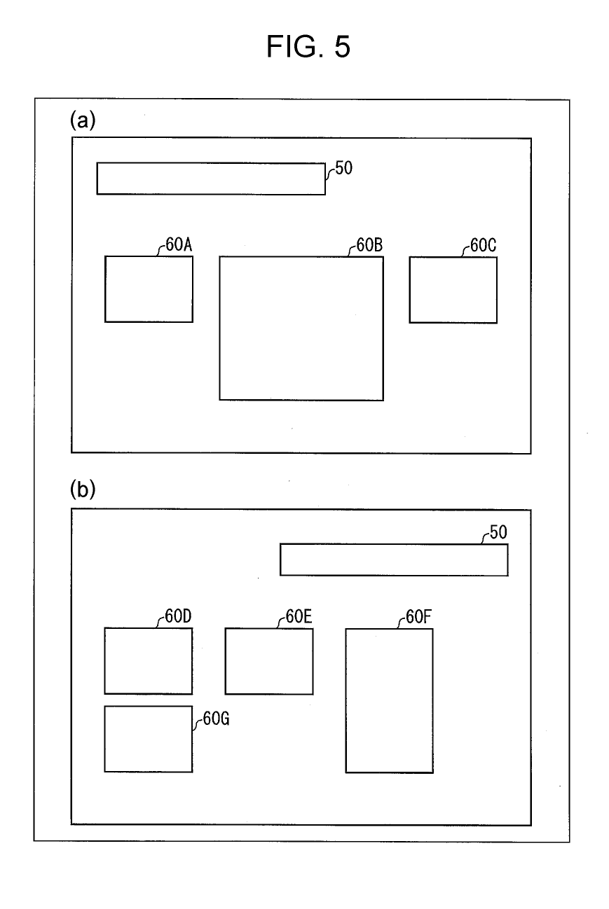

Next, the display layout for the recommendation information will be described with reference to FIG. 5. FIG. 5 illustrates an example of the display layout for the recommendation information. In FIG. 5, an example in which a tile 50 and tiles 60A to 60G are displayed for layout is illustrated. It is noted that the tiles 60A to 60G are simply referred to as the tile 50 when the tiles 60A to 60G do not need to be distinguished from each other. Furthermore, the tile 50 and the tiles 60 are simply referred to as the tile when the tile 50 and the tiles 60 do not need to be distinguished from each other.

Information for making a recommendation to the user of the terminal apparatus 2 is displayed on the tile. For example, information that attracts user's interest, such as information indicating the broadcast content or the Internet content that meets the preference of the user or weather information or traffic information on an area where the user resides, is displayed. Furthermore, selection of each of the tiles can cause content that is indicated by the tile to the terminal apparatus 2.

In order to make such display and output possible, a resource is associated with each tile. For example, a type, a reference image, a jump destination, a display size, an explanatory character string, and the like are given as resources (hereafter expressed as tile resources) each of which is associated with the tile.

The type indicates a display format of each of the tiles. The tile 50 that is illustrated is of the banner type (a type in which a text is scrolled for display). The tile 60 is of the box type (a type in which a still image or a moving image is displayed, but is not scrolled). In addition to these, it is also considered a sound type in which speech is output but display is not performed. Furthermore, information for outputting speech for reading may be included in recommendation information of the sound type. In this manner, an output format of the recommendation information is not limited to the display layout for the recommendation information, and may be an output format other than this, such as one for speech output. Furthermore, information indicating such an output format may be set to be a portion of the recommendation information, and may be set to be information that is different from the recommendation information, in the same manner as the layout information described above. As output formats for speech, for example, a volume of sound, a musical interval, a tone, a tempo (speed), and the like are given.

The reference image is information indicating an image that is displayed as the recommendation information, and may be, for example, Uniform Resource Identifier (URI) of a storage destination of the image. Furthermore, the jump destination is information for access to content that is recommended by the tile, and may be a URI of the content in the same manner as the reference image. By referring to such a URI, the image and the content can be acquired from a prescribed server. It is noted that the reference image may be an image which is stored in the terminal apparatus 2. In the same manner, the jump destination may be content (for example, content that is video-recorded, or content that is download-completed) that is stored in the terminal apparatus 2, or may be broadcast content. In addition, information indicating application software (hereafter expressed as an application) that is retained by the terminal apparatus 2, or information indicating that is acquirable by the terminal apparatus 2 from the server may be set to be the jump destination. In a case where the former information is the jump destination, at the time of selecting the tile, an application can be activated. In a case where the latter information is the jump destination, at the time of selecting each of the tiles, an application can be downloaded from the server and be installed on the terminal apparatus 2. Furthermore, at the time of selecting the tile with information indicating prescribed operation (for example, power-off or display of a configuration screen) of the terminal apparatus 2 as the jump destination, the prescribed operation may be performed.

The display size is information indicating a size and a shape of the tile. For example, because the tile 50 that is illustrated may be in the shape of a rectangle with a 1:10 aspect ratio, the display size may be expressed as (1, 10). Furthermore, a display size of the tile 60A that is illustrated is set as a reference size (1, 1), and sizes of the other tiles 60 may be expressed based on the reference size. In this case, display sizes of the tiles 60B, 60C, and 60F are (2, 2), (1, 1), and (2, 1), respectively. Of course, the display size may be information indicating the size or the shape of the tile, and for example, may be information indicating the numbers of vertical and horizontal dots of each of the tiles.

The explanatory character string is a character string for describing content that is a target which is recommended by the tile. For example, as the explanatory character string for the tile, which recommends a certain broadcast content, a program name of the certain broadcast content may be used.

In an example in (a) of FIG. 5, the tile 50 and the tile 60B are arranged at the upper left corner and the center, respectively, of a display screen. Then, the tile 60A and the tile 60C are arranged the left side and right side, respectively, of the tile 60B that is interposed between the tile 60A and the tile 60C. On the other hand, in an example in (b) of FIG. 5, the tile 50 is positioned on the upper right corner of the display screen, and the tiles 60D, 60E, and 60F in this order are arranged in the direction from the left end to the right end. Then, the tile 60G is positioned under the tile 60D.

Because the tile is displayed at such a prescribed layout, the terminal apparatus 2 uses the layout information. In addition to pieces of information that indicate the tiles which are arranged and an arrangement of the tiles, respectively, information indicating an image on which a background of the tile is displayed, and the like may be included in the layout information. In the present example, the terminal apparatus 2 receives the layout information from the server 1, and, according to the received layout information, displays the tile for the recommendation information. It is noted that the received layout information may be stored, for example, in a temporary storage unit such as a cache memory.

In this manner, the terminal apparatus 2 arranges the tiles according to the layout information and displays the recommendation information on the tile. Then, because a plurality of types of the layout information are prepared, as illustrated in FIGS. 5(a) and 5(b), the terminal apparatus 2 can display the recommendation information in various layouts.

[Configuration of Essential Constituents of the Server 1]

Configuration of essential constituents of the server 1 will be described with reference to FIG. 2. FIG. 2 is a block diagram illustrating an example of the configuration of the essential constituents of the server 1. As illustrated, the server 1 includes a server control unit 10 that controls units of the server 1 in an integrated manner, a server storage unit 11 in which various pieces of data that are used by the server 1 are stored, and a server communication unit 12 through which the server 1 communicates with an external apparatus.

As an apparatus that is a partner for communication in which the server communication unit 12 is involved, in addition to the terminal apparatus 2, an external server that provides a prescribed service, or the like is given. Furthermore, it is possible that with the use of one server 1, the recommendation information is provided to a plurality of terminal apparatuses 2. More precisely, for example, apparatuses that are partners for the communication in which the server communication unit 12 is involved includes a terminal apparatus 2 (for example, a television set) in a living room of the user, a terminal apparatus 2 (for example, a television set) in a bedroom, a portable terminal apparatus 2 (for example, a portable telephone) and a terminal apparatus (for example, a household robot) that has a telephone conversation function. Furthermore, because a vehicle such as an automobile, which has a communication function, is present, such a vehicle may be set to be the terminal apparatus 2 that is the communication partner. Furthermore, the communication partners may include equipment of which an owner is different, as is the case with a television set or the like in another house. It is noted that only one server communication unit 12 is illustrated in FIG. 2, but that a plurality of communication units may be included and thus communication unit that varies with the communication partner may be used.

Furthermore, a terminal authentication unit 100, a user specification unit 101, a recommendation information generation unit 102, an information management unit (an information acquisition unit) 103, a layout selection unit (a format selection unit) 104, and an information transmission unit (an output control unit) 105 are included in the server control unit 10. Then, an individual, family, and equipment DB 110, a history DB 111, service information 112, a knowledge DB 113, and layout information (a format) 114 are stored in the server storage unit 11.

The terminal authentication unit 100 performs authentication of the terminal apparatus 2. Specifically, the terminal authentication unit 100 determines whether equipment ID that is received from the terminal apparatus 2 and equipment ID that is registered in advance are consistent with each other. If two equipment IDs are consistent with each other, the authentication is regarded as succeeding. If not, the authentication is regarded as failing. The terminal apparatus 2 that succeeds in authentication is a target that is notified the recommendation information.

The user specification unit 101 specifies a user who is a target to which the recommendation information is presented. Specifically, the user specification unit 101 specifies a user with a user ID that is notified by the terminal apparatus 2, as the user who is the target to which the recommendation information is presented.

The recommendation information generation unit 102 generates the recommendation information. Specifically, the recommendation information generation unit 102 generates the recommendation information that is in accordance with at least one of the pieces of information that will be described below.

(1) User who is specified by the user specification unit 101

(2) Individual profile (gender, age, hobby, preference, and the like) of the user

(3) Family profile of a family of the user (address, family members, preference of each of the family members)

(4) Equipment profile (a type of equipment, a function of equipment and the like) of equipment (the terminal apparatus 2 and equipment other than the terminal apparatus 2) that is owned by the user

(5) Historical information (information on at which time which content is displayed to which user) on the use of the terminal apparatus 2 by the user or the members of the user's family

(6) Historical information on the use of equipment that is owned by the user

(7) Historical information on the use of equipment that is owned by another user, by the user

(8) Association knowledge database

(9) Index information of an external service

(10) Point in time (current time span) at which the recommendation information is output

(11) Information (content that is recommended by the server 1, a content list that is acquired from an external server, or the like) that is set to be a recommendation target.

It is noted that, in a case where the user specification unit 101 specifies two or more users, the recommendation information generation unit 102 may generate pieces of recommendation information that are in accordance with the plurality of users, respectively. In this case, the recommendation information generation unit 102 may generate pieces of recommendation information that are in accordance with combinations, respectively, of the plurality of users. For example, in a case where users who are identified are the father and the mother of the user, the recommendation information on content of a genre that was viewed in the past with high frequency by these two users may be generated. Furthermore, in a case where a prescribed user is included in the plurality of users, the recommendation information in accordance with the prescribed user may be generated. For example, in a case where a child at the age of twelve is included in the plurality of users, the recommendation information on content that the child at the age of twelve is also permitted to view may be generated without generating the recommendation information on a movie (content) that is suitable for a user at the age of fifteen or more.

Furthermore, it is also assumed that the user specification unit 101 fails in specifying a user. In such a case, based on the historical information on the use of the terminal apparatus 2 and historical information on operating of the terminal apparatus 2, the recommendation information generation unit 102 may include only content that is suitable for all users (for example, all family members) that are registered, in the recommendation information.

The information management unit 103 acquires and manages various pieces of information that are to be referred to at the time of generating the recommendation information and selecting the layout information. For example, the information management unit 103 acquires situation information that indicates a situation that exists when the terminal apparatus 2 outputs the recommendation information, and historical information on operation of another terminal apparatus that is different from the terminal apparatus 2. As the pieces of situation information described above, for example, a point in time or a time span, user IDs of users that are present in the vicinity of the terminal apparatus 2, the number of the users, and the like are given. Furthermore, the information on the operation, which is described above, is information indicating a history of the operation of the other terminal apparatus described above. The historical information on operation, which is described above, may be the historical information on the operating that includes, for example, date and time for activation start and date and time for activation stop. In this case, the date and time for activation start, which is described above, may be date and time at which a power-on or display-on operation is performed, and the date and time for activation stop, which is described above, may be date and time at which a power-off or display-off operation is performed. Furthermore, the historical information on the operation, which is described above, may be historical information on the operation, which indicates a history of a user operation that is performed on the other apparatus described above. In this case, in addition to the power-on or display-on operation, a history of an operation of selecting output content and the like are also included in the historical information on the operation. Because of this, with the acquisition of the historical information on the operation, it is also possible that the recommendation information relating to content for which a user of another terminal apparatus has a preference is generated. Furthermore, in a case where the other terminal apparatus described above is an apparatus that outputs content, the historical information on the operation, which is described above, may be historical information on viewing of the content in the other terminal apparatus. Moreover, the historical information on the operation (the historical information on the viewing), which is described above, may include information indicating a user (who views the content) who operates the other terminal apparatus). Accordingly, it is also possible that the recommendation information in accordance with a history (a history of the viewing) of operation by the user of another terminal apparatus, who has a preference similar to that of the user of the terminal apparatus 2, is generated.

The layout selection unit 104 selects the layout information that is to be used for outputting of the recommendation information, from among a plurality of pieces of layout information 114. It is noted that a detail of the layout information and a method of selecting the layout information will be described below.

The information transmission unit 105 notifies the terminal apparatus 2 of the recommendation information that is generated by the recommendation information generation unit 102, and the layout that is selected by the layout selection unit 104, and causes the recommendation information described above to be output at the layout.

The individual, family, and equipment DB 110 is a database in which an individual profile of the user, profiles of members of a user's family, and a profile of equipment that is used by the user or the member of the user's family.

The individual profile includes an ID of a user and various pieces of information (for example, age, gender, hobby, occupation, family members, user-owned equipment and the like) relating to the user. The individual profile, for example, may be information as will be described below.

Individual profile: the user ID is P1234, the age is 38, the gender is female, and the hobbies are cooking and dancing.

A profile of a family includes various pieces of information (for example, family members, a hobby that the family members have in common with each other, and the like) relating to the dancing family, in addition to a family ID. The family profile, for example, may be information as will be described below.

Family profile: the family ID is K2299, the member user ID is P2234, and the user ID is P3455

The equipment profile includes various pieces of information (for example, an owner or a family that owns the equipment, an installation place, a type of equipment, and the like) relating to the equipment, in addition to equipment ID of the apparatus. The equipment profile may be information as will be described below. It is noted that in an example that will be described below, the installation place is expressed as a postal code, but that if the installation place is possibly specified, information other than the postal code or an address can apply. For example, the installation may be expressed as latitude and longitude information, and may be expressed in terms of a relationship to the user, such as a room of the user with the user ID (P1234).

Equipment profile: the equipment ID is X2345, the type of equipment is television set, the screen size is 52 inches, and the installation place is postal code 123-4567

The history DB 111 is a database in which the history (also referred to as the history of the use, the history of the operation, the history of the viewing, or the history of the operating) of the operation of the terminal apparatus 2. Furthermore, a history of operation of the equipment (including equipment that is owned by the user of the terminal apparatus 2 or a member of the user's family, and equipment that is owned by a person different from the user) other than the terminal apparatus 2 is also recorded in the history DB 111. In this manner, pieces of historical information on various items of equipment and various users are collected and are kept recorded. Thus, it is possible that the recommendation information in accordance with an action history of another user is presented. For example, in a case where content that has a high viewing rating is present in a prescribed type of television set, the recommendation information on content that is similar to the content can be presented. Furthermore, for example, the recommendation information on the content that is viewed by another user who has a preference similar to that of the user can be presented.

For example, in a case where the terminal apparatus 2 is a television set, a history of operation by every user may be recorded in the history DB 111. In this case, in addition to equipment ID of the terminal apparatus 2 and a user ID of the user who viewed content, (i) a point in time (date and time may be included) when display on the television set was turned on and off, (ii) program information on a television program (a program that was recorded may be available) that was viewed, and (iii) a viewing point in time may be recorded. It is noted that a history of viewing of the Internet content, a history of download of an application, or the like may be recorded.

The service information 112 is information (index information on an external service) relating to an external service that is acquired from an external server. For example, the service information 112 relating to the broadcast content may include broadcast date and time, a broadcasting station, a content title, details of content, a genre (for example, a drama, a movie, SF, or the like), and the like. Furthermore, for example, the service information 112 relating to Video-On-Demand (VOD) content may include a content title, performers, details of content, a genre, and the like. Then, for example, the service information 112 relating to an application may include a title (a name of an application), a detail and a genre (a map application, a game application, or the like) of an application, an evaluation of the application by a user, and the like. It is noted that the service information 112 may be stored in a temporary storage unit that is not illustrated.

The knowledge DB 113 is a database in which other pieces of information for generating the recommendation information are recorded. For example, annual events (What day is today? and the like), local information (garbage pickup date and the like), and the like are recorded in the knowledge DB 113. In addition, a dictionary describing a distance of words and the like may also be recorded in the knowledge DB 113. The knowledge DB 113 is possibly set to be suitably updated with the newest knowledge. Furthermore, information that is recorded the knowledge DB 113 possibly experiences learning by making periodic visits to external servers. In addition, an output phrase for performing speech output of or text output of the recommendation information may be stored in the knowledge DB 113.

The layout information 114 is information indicating the display layout, among formats for outputting the recommendation information. As the present example, the example in which the recommendation information is caused to be displayed using the layout information that is selected from a plurality of layout information 114 is described, but the recommendation information can be selected from a plurality of candidates, in the same manner as at another output format (for example, a format for speech output), and can be caused to be output at that format.

[Configuration of Essential Constituents of the Terminal Apparatus 2]

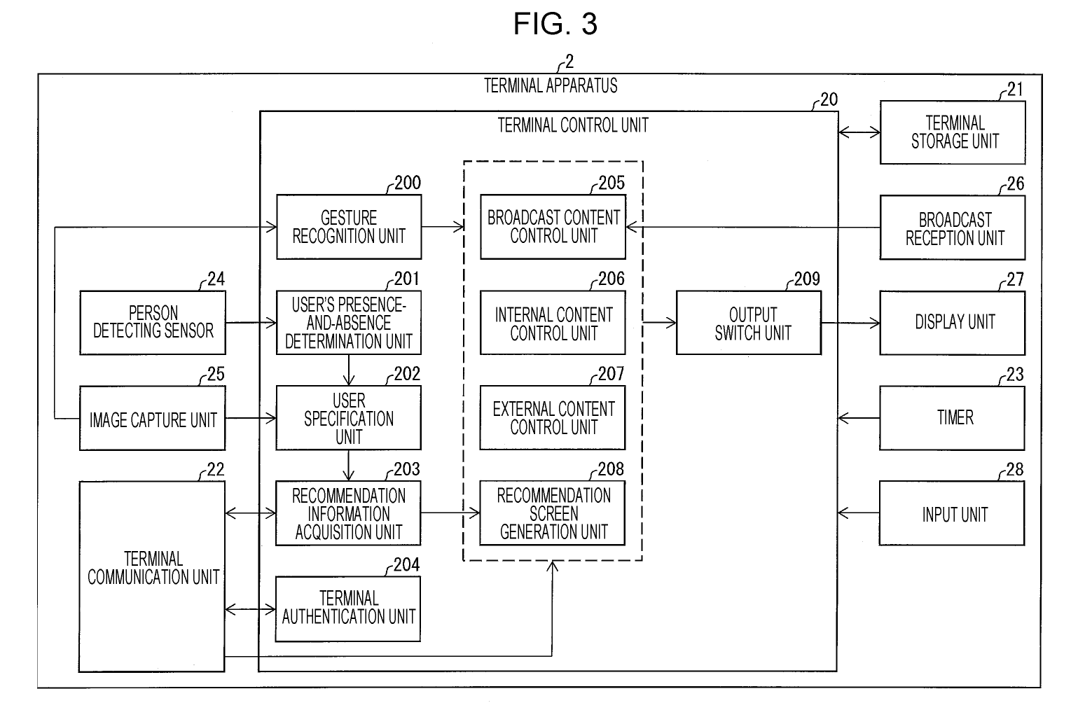

Configuration of essential constituents of the terminal apparatus 2 will be described with reference to FIG. 3. FIG. 3 is a block diagram illustrating an example of the configuration of the essential constituents of the terminal apparatus 2. As illustrated, the terminal apparatus 2 includes a terminal control unit 20 that controls units of the terminal apparatus 2 in an integrated manner, a terminal storage unit 21 in which various pieces of data that are used by the terminal apparatus 2 are stored, and a terminal communication unit 22 through the terminal apparatus 2 communicates with an external apparatus. In addition, the terminal apparatus 2 also includes a timer 23, a person detecting sensor 24, an image capture unit 25, a broadcast reception unit 26, a display unit 27, and an input unit 28. Furthermore, although not illustrated, the terminal apparatus 2 may include a speech input unit (for example, a microphone) that acquires a voice of the user and converts the voice into a speech signal, a speech output unit (for example, a speaker), and the like.

Furthermore, the terminal control unit 20 includes a gesture recognition unit 200, a user's presence-and-absence determination unit (an activation control unit) 201, a user specification unit (an information acquisition unit) 202, a recommendation information acquisition unit (a format selection unit) 203, a terminal authentication unit 204, a broadcast content control unit 205, an internal content control unit 206, an external content control unit 207, a recommendation screen generation unit (an output control unit) 208, and an output switch unit 209.

The timer 23 is a timer indicating a current point in time. The person detecting sensor 24 is a sensor that detects a person in the vicinity of the terminal apparatus 2. It is preferable that a detection range of the person detecting sensor 24 is a range where content that is displayed by the terminal apparatus 2 is possibly viewed. The image capture unit 25 captures an image of a user who views the content that is displayed by the terminal apparatus 2, and is, for example, a camera. The broadcast reception unit 26 receives broadcast content. An image is displayed on the display unit 27 under the control of the terminal control unit 20. An input operation is performed by the user of the terminal apparatus 2 on the input unit 28. The input unit 28 may be a reception unit that receives a signal (for example, an infrared signal) which is emitted by a remote controller that is not illustrated.

The gesture recognition unit 200 recognizes a gesture operation by the user. Specifically, the gesture recognition unit 200 not only detects a user's hand or finger from an image that is captured by the image capture unit 25, but also detects a prescribed gesture operation that is performed with the hand or the finger. The gesture recognition unit 200, for example, detects the gesture operation for selecting the recommendation information. Accordingly, the user can select the recommendation information without using the remote controller, and can start to view desired content and so forth. It is preferable that the gesture operation is performed in such a manner that the recommendation information can be intuitively selected. For example, the recommendation information at a selection position that results when a movement in which a selection position is caused to be moved in a direction in which the finger or the hand is moved and in which the finger or the hand is curved or the hand or the finger is pushed toward the terminal apparatus 2 is detected may be conclusively selected. Furthermore, in a case where the user wears a wearable device on his/her body, a movement of the user's hand or finger may be detected using an acceleration sensor or the like that is included in the device. With this configuration, the gesture recognition unit 200 acquires information on the user's hand or finger from the wearable device, and thus recognizes the gesture operation.

Based on a result of the detection by the person detecting sensor 24, the user's presence-and-absence determination unit 201 determines whether or not a person is present in the vicinity of the terminal apparatus 2 (a range where the recommendation information that is output by the terminal apparatus 2 is possibly perceived). Then, when it is determined that the person is present in a state where the display by the terminal apparatus 2 is turned on, switching to turning-on of the display takes place (the terminal apparatus 2 is caused to be activated). Furthermore, when it is determined that a person is not present in a state where the display by the terminal apparatus 2 is turned on, the user's presence-and-absence determination unit 201 performs switching to turning-off of the display (activation of the terminal apparatus 2 is caused to be stopped). Accordingly, the recommendation information can be displayed when the user comes into the vicinity of the terminal apparatus 2, and the display can be ended when the user moves out of the vicinity of the terminal apparatus 2. It is noted that a configuration may be employed in which the detection of the user and the control of the activation of the terminal apparatus 2 are performed with separate blocks, respectively.

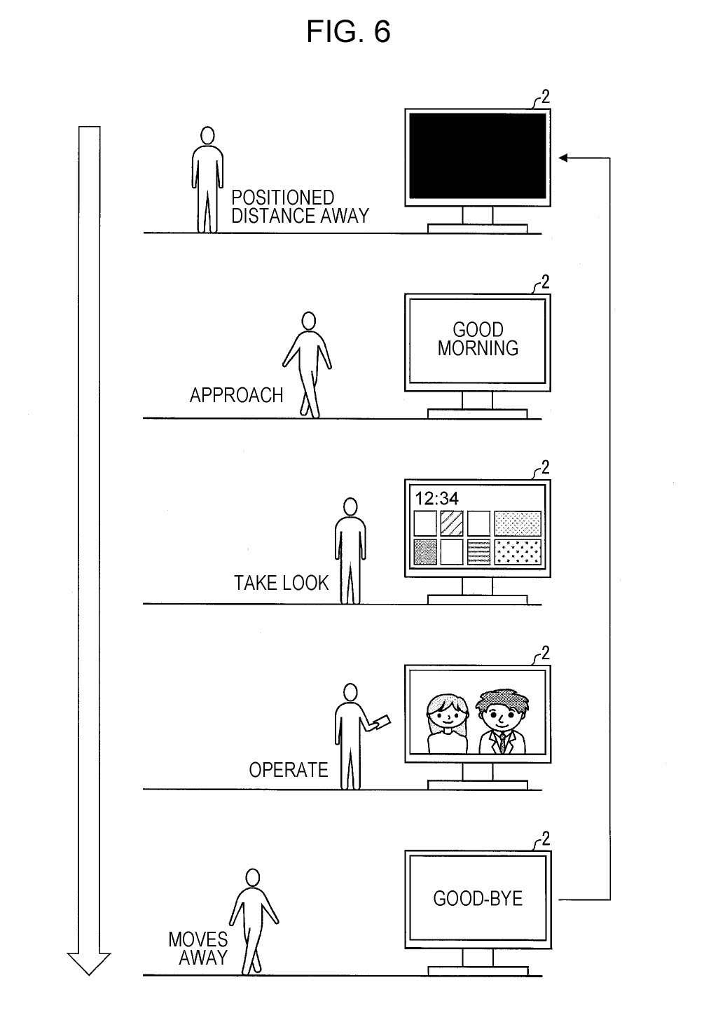

This will be described with reference to FIG. 6. FIG. 6 is a diagram illustrating an example of the switching between the turning-on and the turning-off of the display in accordance with the result of the detection of the user. As illustrated, although the display by the terminal apparatus 2 is turned off when the user is positioned a distance away from the terminal apparatus 2, the switching to the turning-on of the display by the terminal apparatus 2 takes place when the user approaches the terminal apparatus 2. Furthermore, in an example that is illustrated, a greeting expression (Good morning) to the user is displayed. On this occasion, the terminal apparatus 2 may output the greeting expression in speech.

It is noted that the greeting expression that is displayed when the switching to the turning-on of the display takes place maybe changed according to a time span. For example, in the morning, the greeting expressions “Good morning”, “Good afternoon”, and “Good night” may be displayed in the morning, in the afternoon, and in the night, respectively. Furthermore, details that are to be displayed may be randomly selected from a plurality of candidates. Moreover, the details that are to be displayed may be set in such a manner that the details can be updated by the user operation or the like. In these examples, the speech output may be performed along with the display, and the speech output may be performed without performing the display.

Furthermore, after the greeting, a recommendation screen on which the recommendation information described above is layout-displayed is displayed. The user performs an operation of selecting desired content from the recommendation screen, and causes the terminal apparatus 2 to display the desired content.

Then, when the viewing of content is ended, the user may move away from the terminal apparatus 2 without performing any operation, and thus may move outside a detection range of the person detecting sensor 24. Accordingly, the terminal apparatus 2 displays a parting expression (Good-bye) to the user and returns to a state where the operation is stopped (the display is turned off). It is noted that in the same manner as when the display is turned on, the terminal apparatus 2 may output the parting expressing in speech. Furthermore, in the same manner when the display is turned on, the greeting expression that is displayed when the switching to the turning-off of the display takes place may be changed according to the time span. For example, in the morning, “Have a good day” may be displayed, and in the night, “Good night” may be displayed. Furthermore, if the detected user is a person who is specified for identification, a message relating to the user may be displayed. Furthermore, details that are to be displayed may be randomly selected from a plurality of candidates. Moreover, the details that are to be displayed may be set in such a manner that the details can be updated by the user operation or the like. In these examples, the speech output may be performed along with the display, and the speech output may be performed without performing the display.

It is noted that a method of determining the presence and absence of the user is not limited to the example described above, and the presence and absence of the user may be determined, for example, using a result of image recognition with a camera, a result of voice recognition, or the like. Alternatively, in a case where wireless communication between equipment (for example, a smartphone, a vital sensor, or a wearable device) that is owned by the user and the terminal apparatus 2 is established, it may be determined that the user is nearby.

The user specification unit 202 specifies who the user detected by the user's presence-and-absence determination unit 201 is, among users who are registered in advance. The specification method is not particularly limited, and, for example, may be specified by analyzing an image that is captured by the user or user's voice. Furthermore, for example, the user may be specified by acquiring a unique ID that is retained by the equipment that is owned by the user or a pseudo-unique ID from the equipment. It is noted that the user specification unit 202 may acquire at least one of the situation information that indicates the situation that exists when the terminal apparatus 2 outputs the recommendation information, and the historical information on the operation of another terminal apparatus that is different from the terminal apparatus 2. Accordingly, it is possible that the recommendation information acquisition unit 203 makes a request to the server 1 for the recommendation information in accordance with the acquired information described above and acquires the recommendation information. Furthermore, in a case where the recommendation information in accordance with the acquired information described above is stored in the terminal apparatus 2, the stored recommendation information can be acquired. As the situation information described above, a point in time or a time span at the time of outputting the recommendation information, the number of users that are detected in the vicinity of the terminal apparatus 2, or the like is given.

The recommendation information acquisition unit 203 acquires the recommendation information. More specifically, the recommendation information acquisition unit 203 transmits a user ID of a user who is specified by the user specification unit 202 to the server 1 and acquires the recommendation information in accordance with the user from the server 1. It is noted that in addition to the user ID, the recommendation information acquisition unit 203 may notify the server 1 of information (for example, the situation information described above, the historical information on the operation, preference information indicating the preference of the user, or information designating a method of generating the recommendation information) that is a reference for generating the recommendation information in the server 1. Furthermore, by performing the same processing as the server 1, the recommendation information acquisition unit 203 may generate the recommendation information.

Furthermore, the recommendation information acquisition unit 203 acquires not only the recommendation information described above, but also the layout information. More precisely, the recommendation information acquisition unit 203 acquires the layout information in accordance with the notified user ID and the acquired recommendation information. It is noted that, as is the case with the acquisition of the recommendation information, the recommendation information acquisition unit 203 can notify the server 1 of the information as described above, which is a reference for selecting the layout information, and can acquire the layout information in accordance with the information.

Moreover, in a case where a plurality of pieces of layout information are present (for example, in a case where the plurality of pieces of layout information are acquired), in a case where the plurality of pieces of layout information are stored in the terminal apparatus 2, or in a case where the layout information is acquired when a layout state that is stored is present, the recommendation information acquisition unit 203 selects the layout information that is to be used from among these pieces of layout information. The same technique as in the selection of the layout information in the server 1 can apply to the selection at this time.

The terminal authentication unit 204 performs the authentication of the terminal apparatus 2. Specifically, the terminal authentication unit 204 transmits the equipment ID of the terminal apparatus 2 that is registered in advance with the server 1, the server 1, and thus causes the server 1 to authenticate the terminal apparatus 2.

The broadcast content control unit 205 displays the broadcast content on the display unit 27, the internal content control unit 206 displays internal content on the display unit 27, and the external content control unit 207 displays the external content on the display unit 27.

The recommendation screen generation unit 208 generates the recommendation screen on which the recommendation information that is acquired by the recommendation information acquisition unit 203 is positioned at a layout that is indicated by the layout information which is acquired along with the recommendation information, and displays the generated recommendation screen on the display unit 27. Furthermore, in a case where what has to be output in speech is included in the recommendation information, the recommendation screen generation unit 208 causes the recommendation information to be output from a speaker that is not illustrated. It is noted that, in a case where the recommendation information or the layout information is stored in the terminal apparatus 2, the recommendation screen generation unit 208 can also generate the recommendation screen using the recommendation information or the layout information.

The output switch unit 209 switches a target that is output by the terminal apparatus 2 to any of the broadcast content, the internal content, the external content, and the recommendation screen. It is noted that targets that are switched may include targets other than these.

[Example of the Recommendation Information and the Layout during Every Time Span (Morning)]

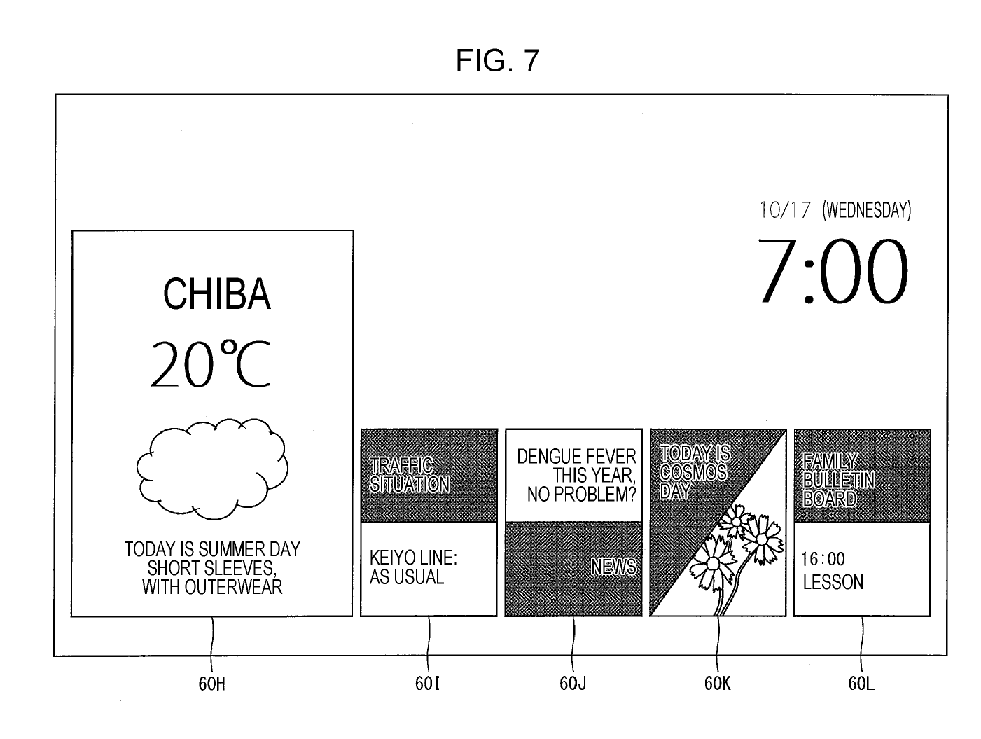

The server 1 can cause the terminal apparatus 2 to display the recommendation information in accordance with the time span to which a current point in time belongs, in a layout in accordance with the time span. At this point, an example of the recommendation information and the layout dedicated for morning hours is described with reference to FIG. 7. FIG. 7 is a diagram illustrating an example of the recommendation screen on which the recommendation information dedicated for the morning hours is displayed in a layout dedicated for the morning hours.

The recommendation screen in FIG. 7 is in a layout in which tiles 60H to 60L are horizontally arranged in a single row and a date, a day, and a point in time are displayed on the upper right side of the screen. In this manner, the tiles do not need to fill in the entire screen, and filing in only one portion of the screen is sufficient. Among the tiles 60 that are horizontally arranged in a single row, a size of the tile 60H is two times sizes of the other tiles, the tiles 60I to 60L, in both the length and the breadth.

In the tile 60H, comments relating to a weather forecast for a district (a user's house or workplace, a location of the school that the user attends, or the like) that is set in advance, a current temperature, and weather are displayed. Furthermore, on the background of these pieces of character information, an image of an atmospheric condition is displayed, and a state of the weather can be recognized at first sight.

Because the morning hours is a time span during which the user prepares for leaving the house to go to the workplace or the school, it is considered that information which has to be considered for the preparation (preparation of carrying articles such as clothes or an umbrella) is highly useful to the user. For this reason, as in an example that is illustrated, it is preferable that during the morning hours, the weather information is displayed on the tile 60H that has a greater size than the other tiles 60.

Furthermore, traffic information indicating a service situation of a transportation system, news, information indicating what day today is, and scheduling information that is registered on a family bulletin board are displayed on the tiles 60I to 60L, respectively, which are illustrated. It is noted that the family bulletin board is a Social Networking System (SNS) in which a member in a prescribed group (for example, a family) performs message posting and message reading.

Regarding the information that is displayed on the tile, the recommendation information may be possibly recognized by the user. For example, an icon, a shortcut, or the like that activates a recommendation application may be available. However, it is preferable that information is displayed in such a manner that the user can easily recognize details of the recommendation. For example, in the example that is illustrated, among pieces of information that are provided by an application (a webpage or the like) which provides the weather information, the weather information on the district in accordance with the user is picked up and displayed. In the same manner, regarding the traffic information, the service situation of the transportation system that is used by the user is picked up and displayed. Furthermore, regarding the news, a headline is displayed as characters and thus can be recognized at first sight. A detail of the news or other news is possibly displayed by selecting the tile 60J. Furthermore, an image (an image of a cosmos in this case) that is matched to an image of the day is displayed on the tile 60K indicating what day today is, and thus the user impressively knows what day today is. Then, because the scheduling information, like news or the like, has high reliability, the scheduling information is succinctly displayed as characters, and thus, necessary information is set in such a manner that the user can easily recognize the necessary information.

It is noted that display details on the recommendation screen are updated with the passage of time. In a case where a current point in time is inclusively displayed on the recommendation screen, the frequency with which the display is updated is highest. Because of this, in this case, first, the display of the point in time is displayed and thereafter, the recommendation information that is displayed on each tile is updated.

Furthermore, at the time of the display of the recommendation screen, speech relating to the recommendation screen may be output. For example, in a case where the weather information is included in the recommendation screen, the message “Check the weather before leaving the house!” may be output in speech. In this manner, the user is urged to read the recommendation information, and speech is output in such a manner that the user unconsciously wants to take a look at the recommendation information. Thus, the user's interest in the terminal apparatus 2 can be increased and an effect of displaying the recommendation information can be increased. It is noted that the speech that is output is not limited to the message, and for example, a sound effect, such as “BA-BA-BA-BAN” or a melody (a piece of music associated with the recommendation information may be available) may be output. A timing at which such speech is output is not particularly limited, but for example, in a case where point-in-time information is output in speech, after the point-in-time information is output in speech, the output may be performed before until the recommendation information is displayed or updated.

Furthermore, the terminal apparatus 2 may read in speech one or several portions of or all portions of the recommendation information that is included in the recommendation screen. Moreover, the recommendation information that is not included in the recommendation screen may also be a target for reading. For example, the recommendation information that is acquired from the server 1 may be displayed on the recommendation screen, and the recommendation information that is generated by the terminal apparatus 2 may be read in speech. In this case, because the terminal apparatus 2 may acquire the recommendation screen from the server 1 and may display the acquired recommendation screen as is, a load on the processing can be reduced and the recommendation information that is generated by the terminal apparatus 2 can also be presented to the user.

In a case where one or several of the plurality of pieces of recommendation information are set to be a target for reading (speech output), the terminal apparatus 2 selects the recommendation information that is set to be the target for reading, for example, according to a priority level or details (for example, whether or not a text is included) of the recommendation information, or the like. This selection may be selected in the server 1. In this case, the terminal apparatus 2 specifies recommendation information that is set to be the target for reading, with a notification from the server 1. In this manner, in the recommending system 5, in addition to the recommendation information and the layout information, the selection of the recommendation information (content) that is output in speech may be selected.

[Example of the Recommendation Information and the Layout during Every Time Span (Afternoon)]

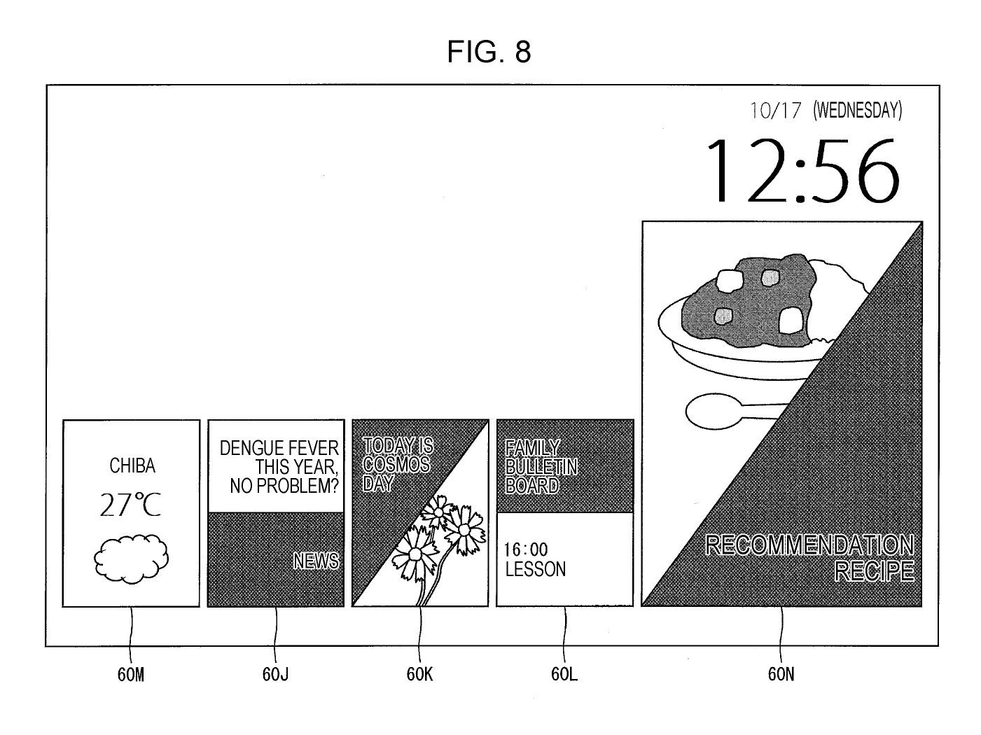

Subsequently, an example of the recommendation information and the layout dedicated for afternoon hours will be described with reference to FIG. 8. FIG. 8 is a diagram illustrating an example of the recommendation screen on which the recommendation information dedicated for the afternoon hours is displayed in a layout dedicated for the afternoon hours.

The recommendation screen in FIG. 8 is in a layout in which tiles 60M, 60J, 60K, 60L, and 60N in this order is horizontally arranged in a single row in the direction from left to right and a date, a day, and a point in time are displayed on the upper right side of the screen. Among the tiles 60 that are horizontally arranged in a single row, a size of the tile 60N is two times sizes of the other tiles 60, in both the length and the breadth.

The recommendation information of a webpage (or an application) that introduces a recommendation recipe is displayed on the tile 60N. A cooking image is displayed on the tile 60N, and it is understood at first sight that the recommendation information relating to cooking is present. Because it is considered that during the afternoon hours, there are also many users who consider a dinner menu, it is considered that information on a cooking recipe is highly useful to the user during the afternoon hours. For this reason, as in an example that is illustrated, it is preferable that during the afternoon hours, recipe information is displayed on the tile 60N that has a greater size than the other tiles 60.

It is noted that the weather information is displayed on the tile 60M in FIG. 8 in the same manner as on the tile 60H in FIG. 7, but that a temperature changes to 27° C. with the passage of time. Furthermore, the tile 60M is set to have a smaller size than the tile 60H in FIG. 7, and thus a comment on the weather is not displayed. In this manner, although sizes of pieces of recommendation information are the same, information that is displayed according to the size of the tile 60 may be changed.

[Example of the Recommendation Information and the Layout during Every Time Span (Night)]

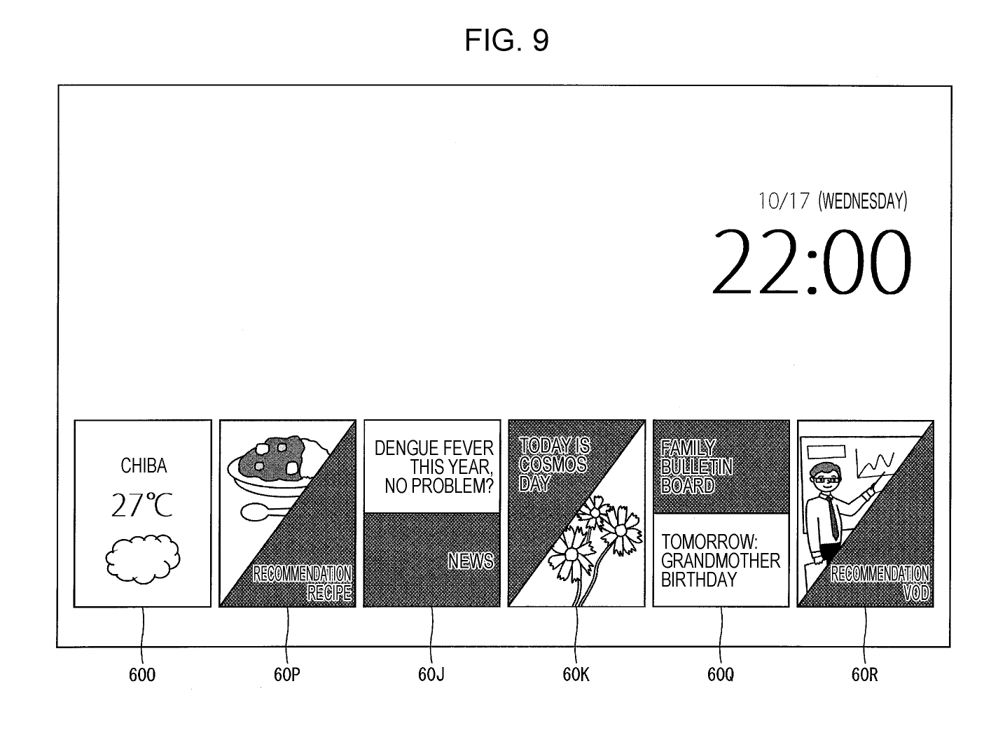

Subsequently, an example of the recommendation information and the layout dedicated for night hours will be described with reference to FIG. 9. FIG. 9 is a diagram illustrating an example of the recommendation screen on which the recommendation information dedicated for the night hours is displayed in a layout dedicated for the night hours.

The recommendation screen in FIG. 9 is in a layout in which tiles 60O, 60P, 60J, 60K, 60Q, and 60R in this order is horizontally arranged in a single row in the direction from left to right and a date, a day, and a point in time are displayed on the upper right side of the screen. All sizes of the tiles 60 that are displayed are the same. There are also many users who are relaxed at night and want to waste time while viewing content that suits his/her mood when relaxed. Thus, it is not preferable that the user is pressed to view content that does not suit his/her mood. For this reason, it is preferable that during the night hours, as in this example, the tile 60 is set to be the same so that the user does not feel as if the user were pressed to view the recommendation information on a specific tile 60.

Regarding to the recommendation information dedicated for the night hours, it is considered that during the night hours, there are also many users who want to check. Because of this, in an example that is illustrated, weather information for the following day is displayed on the tile 60O on the leftmost tile. Furthermore, because it is assumed that there is also a user who, at night, considers a menu for the following day, information on a recommendation recipe is displayed on the tile 60P and registration information for the following day is displayed, as scheduling information, on the tile 60Q. In this manner, it is preferable that information relating to the following day is included in the recommendation information during the night hours. Then, because it is considered that there are also many users who view Internet content at night, information indicating recommendation Internet content is displayed on the rightmost tile 60R. A thumbnail image (an image that is captured from the Internet content may be available) of the Internet content is displayed on the tile 60R, and it is easy for the user to recognize details of the thumbnail image. It is noted that, even in a case where the broadcast content or the internal content is presented as the recommendation information, it is preferable that an image of content is displayed in the same manner as in this example.

[Example of the Layout in which User-specified Recommendation Information is Displayed in a Highlighted Manner]

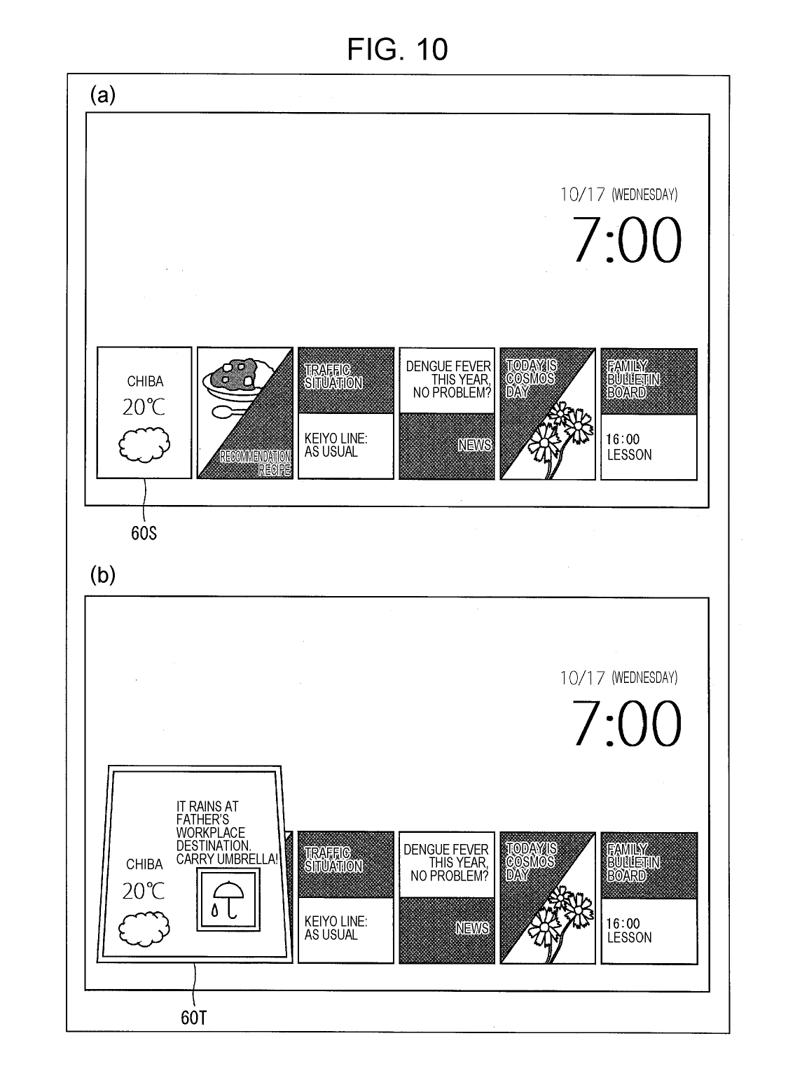

In FIGS. 7 to 9, the examples in which different pieces of recommendation information and different layout are applied according to the time spans are illustrated, but different pieces of recommendation information and different layouts may be applied according to a condition (for example, a history of viewing by the user, a timeline, or the like) other than the time span. Furthermore, in a case where the recommendation information specified for the user (only a prescribed user is set to be a target) is present, it is preferable that the user-specified recommendation information is displayed in a more highlighted manner than other pieces of recommendation information. At this point, an example of the layout in which the user-specified recommendation information is displayed in a highlighted manner is described with reference to FIG. 10. FIG. 10 is a diagram illustrating the example in which the user-specified recommendation information is displayed in a highlighted manner.

On the recommendation screen in (a) of FIG. 10, pieces of recommendation information are displayed on the tiles 60, respectively, that have the same size, without the user-specified recommendation information being included. The weather information (fair weather) for the district where the user's house is located is displayed on the leftmost tile 60S among the tiles 60.

On the other hand, on the recommendation screen in (b) of FIG. 10, the user-specified recommendation information is included. The user-specified recommendation information is displayed on the tile 60T that has a greater than the other tiles 60. Furthermore, the tile 60T is different from the other tiles 60 in that an outer edge portion is lined with a white edge of the tile 60T and in that a shape of the tile 60T is a trapezium. Thus, the tile 60T attracts user's attention more easily than the other tiles 60.

Not only the weather information (fair weather) for the district where the user's house is located, but also a message saying that a weather condition for a prescribed workplace where a user (father) works is rain and that an umbrella is carried is displayed on the tile 60T. More precisely, in a case where it is specified that users that are targets to which the recommendation information is presented include “father”, the terminal apparatus 2 acquires the weather information for the workplace where “father” works, which is registered in advance, as the recommendation information, and displays the recommendation information in a more highlighted manner than other pieces of recommendation information. Furthermore, after normal office-going hours during which “father” goes to the workplace, it is unnecessary to present the weather information for the workplace. Because of this, the terminal apparatus 2 may return the recommendation screen to the display as illustrated in (a) of FIG. 10.

[Example of the Layout (Vertical Arrangement of a Plurality of Tiles 60)]

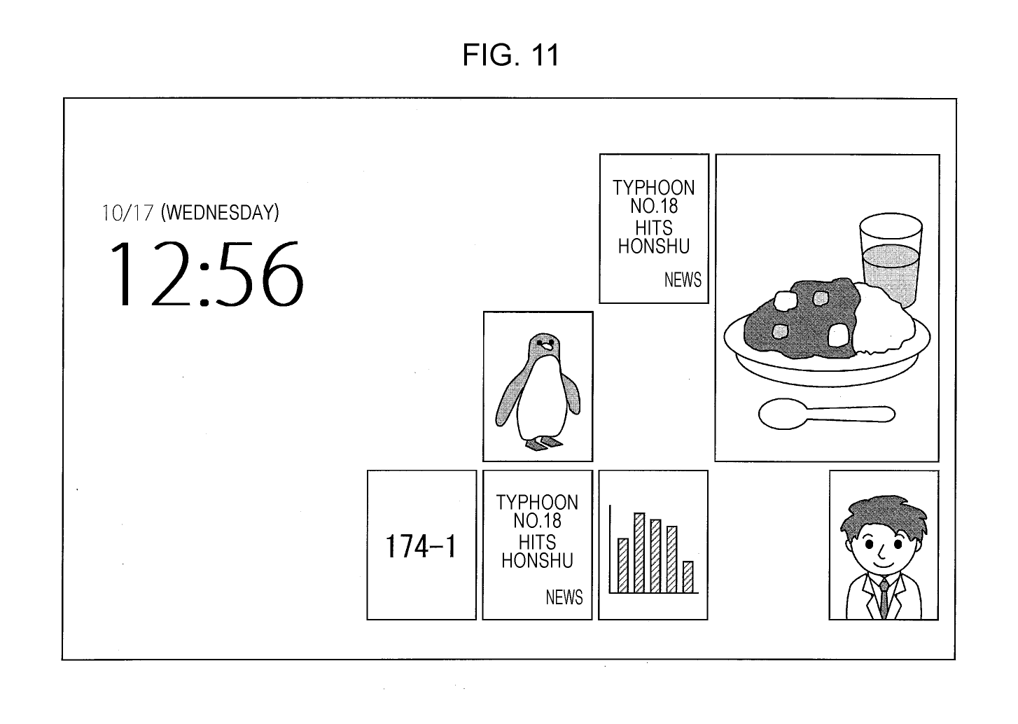

A layout in which a plurality of tiles 60 are vertically arranged side by side may be set to be available. This is described with reference to FIG. 11. FIG. 11 is a diagram illustrating an example of the recommendation screen in the layout in which the plurality of tiles 60 are vertically arranged. In an example that is illustrated, the tiles 60 are arranged in a stepwise manner, or the tile 60 that has a great size and the tile 60 that has a small size are combined with each other, and thus a layout is set to attract the user's attention.

[Example of a Layout (Circular Tile)]

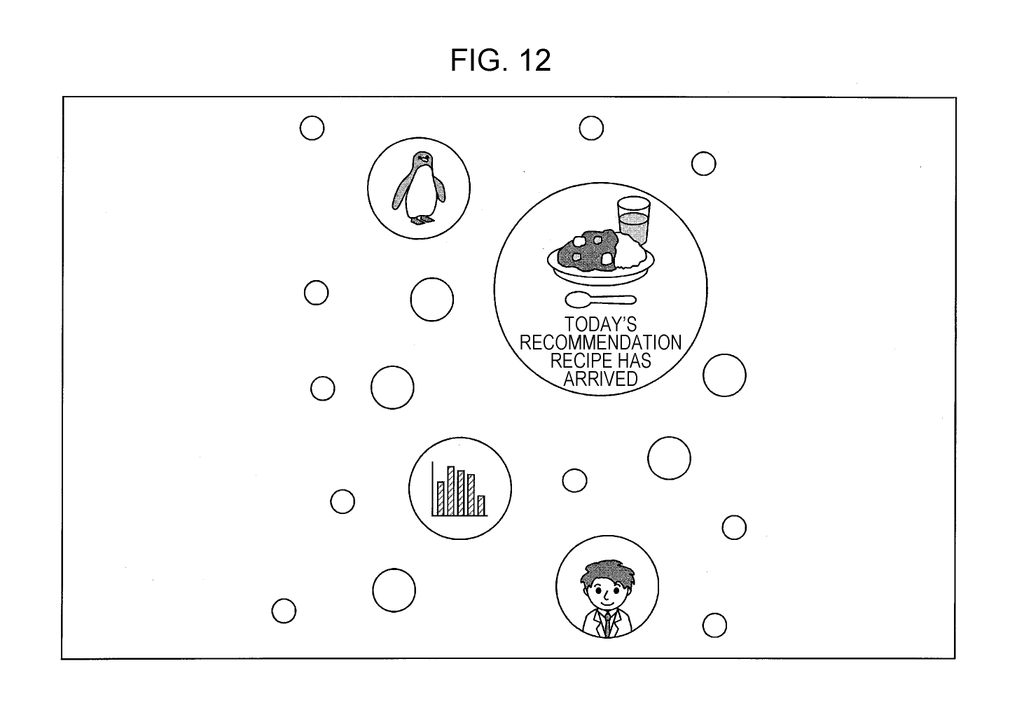

The shape of the tile is not limited to a rectangle. This is described with reference to FIG. 12. FIG. 12 is a diagram illustrating an example of the recommendation screen on which the recommendation information is displayed on a circular tile. In this example, circular tiles that have different diameters are vertically arranged side by side, and the recommendation screen is set to have an external appearance that looks like a bubble that rises in water. In the same manner as in the examples described above, it is preferable in the present example that the recommendation information which has a high priority level is displayed on a tile that has a great diameter.

[Example of a Layout (Text)]

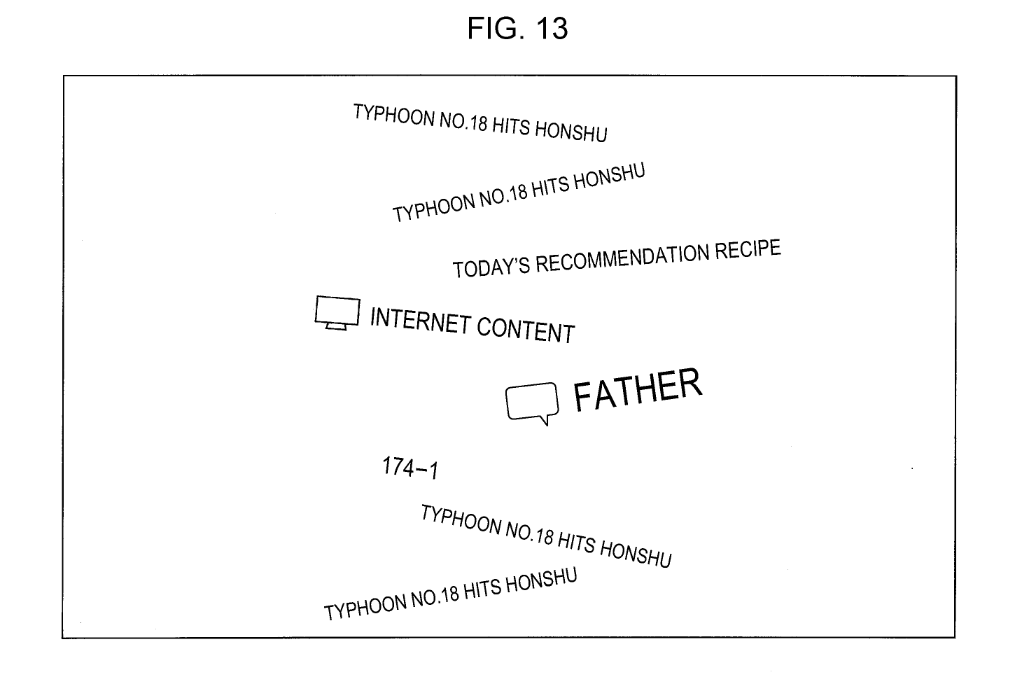

The recommendation information may be presented without the use of the tile 60. This is described with reference to FIG. 13. FIG. 13 is a diagram illustrating an example of the recommendation screen on which the recommendation information is displayed in text. In this example, the text that is the recommendation information is displayed without the tiles in the examples described above. With the text display, the recommendation information can be simply presented. In the present example, it is preferable that the recommendation information that has a high priority level is displayed in a large font.

It is noted that because a case where only with the text, details of the recommendation information is difficult to understand is also considered, a mark or the like is additionally created adjacent to the text. For example, in the example that is illustrated, a mark indicating image content is added to the recommendation information on the Internet content, and a mark that is a balloon is additionally created adjacent to the recommendation information relating to the family bulletin board.

[Supplement to the Recommendation Information and the Layout]

The terminal apparatus 2 may change a screen layout according to the time span. For example, the user cannot leisurely watch the television set during the morning hours. For this reason, it is desirable that the terminal apparatus 2 displays only information, such as a weather forecast or a recommendation action (for example, “an umbrella has to be carried”), on one portion of the screen, during the morning hours. On the other hand, it is desirable that the terminal apparatus 2 displays many tiles on the entire screen during the night hours.

The terminal apparatus 2 may change a tendency of a tile that is displayed, according to the time span. For example, the terminal apparatus 2 displays a tile for a movie that makes the user feel easily relaxed, most of the time during a midnight time span. On the other hand, the terminal apparatus 2 displays a tile for news or the weather information most of the time during the morning hours. The terminal apparatus 2 learns the preference of the user based on the historical information on the operation by the user or the historical information on the operating of the terminal apparatus 2. Then, it is desirable that a tendency of content that is included in the recommendation information is determined based on a result of the learning. However, in a case where much time has not elapsed after the user purchased the terminal apparatus 2, the terminal apparatus 2 or the server 1 may set the tendency of the content that is to be included in the recommendation information.

It is desirable that the terminal apparatus 2 determines whether or not the speech output is performed, according to the time span. For example, during the morning hours, in a case where a weather warning is issued to the district where the user resides, the terminal apparatus 2 may report only once in speech that the weather warning is issued. At this point, the terminal apparatus 2 may generate speech from text, using a technology that converts text into synthetic speech. It is noted that the conversion to the synthetic speech may be performed by the terminal apparatus 2, be performed by the server 1, and be performed by another external server. Furthermore, only when the user approves speech output or provides an instruction to perform the speech output, the terminal apparatus 2 may output speech. For example, the terminal apparatus 2 (for example, displays an icon of a speaker) displays the fact that the traffic information which has to be reported is present, using a method a specific method. Then, in a case where the user approves the reporting or provides an instruction to perform the reporting (for example, the user performs an operation of selecting the icon described above), a detail of the traffic information that has to be reported may be read.

Based on historical information on the use of, and historical information on operating of, another item of equipment (for example, a smartphone) that is owned by the user, the terminal apparatus 2 may provide the recommendation information. For example, in a case where, from a history of positional information that is recorded in the smartphone, it is determined that the user has visited Kyoto, the terminal apparatus 2 causes a priority level of a program for traveling to Kyoto to be raised for a prescribed period of time (for example, for two or three days before the day when the user visited Kyoto). Accordingly, the program for traveling to Kyoto is easy to display, as the recommendation information, on the screen.

An advertisement may be included in the recommendation information. With this configuration, the terminal apparatus 2 makes a connection to an external advertisement server, and transmits a request for a tile resource. The external advertisement server selects an advertisement suitable to the user based on the historical information (a cookie) of the use within the terminal apparatus 2, and transmits a tile resource for the selected advertisement to the terminal apparatus 2.

The terminal apparatus 2 may acquire the tile resource for a webpage of a shopping site from a server of e-commerce (EC) business operator. With this configuration, the terminal apparatus 2 transmits the user ID to the server of the EC business operator through the server 1. The server of the EC business operator determines a recommendation product based on the user ID, and transmits a tile resource that is generated from a webpage on which the recommendation product is posted, to the terminal apparatus 2 through the server 1. It is noted that because the user is busy during the morning hours, there is a low likelihood that the user will do the shopping. For this reason, according to the time span, the terminal apparatus 2 may switch between the presence and absence of display of a tile for the webpage of the shopping site, and may change a size of the tile.

The terminal apparatus 2 may transmit the recommendation information to another item of equipment and may cause the transmitted recommendation information to be output. For example, in a case where the recommendation information is a cooking recipe, the terminal apparatus 2 may cause the recommendation information to be displayed on a portable terminal apparatus such as a smartphone that is owned by the user. Furthermore, in a case where the user is a member of a two-income family, the terminal apparatus 2 may display the recipe on the terminal apparatus 2, and on the other hand, may display the recipe on the smartphone of the user on working days. With this configuration, the recipe can be checked on the way home on working days, using the smartphone, and the recipe can be checked on a holiday using the terminal apparatus 2. It is noted that it is desirable that even with this configuration, the terminal apparatus 2 generates a recommendation recipe that is selected based on the historical information of the viewing by the user or the historical information of the operation by the user, as the recommendation information. Furthermore, in a case where another apparatus is caused to output the recommendation information, the server 1 may transmit the recommendation information to the other item of equipment.

The terminal apparatus 2 may be a household robot. In this case, in addition to displaying the recommendation information as described above, in a case where the recommendation information is urgent information (for example, the message “An evacuation advisory was issued to the district where the user resides”), the message may be output in speech. In a case where the urgent information is detected, although the display by the terminal apparatus 2 is turned off, it is preferable that the urgent information is output in speech. Furthermore, when the urgent information is detected, the display may be turned on, and thus the urgent information may be displayed.

The terminal apparatus 2 may be vehicle-mounted equipment, such as a navigation apparatus of a vehicle. In this case, for example, it may be detected that the vicinity of the store that appeared on the television program that the user has viewed a week before is approached, and thus information on the store may be output (at least displayed or output in speech) as the recommendation information.

The terminal apparatus 2 may determine content that is included in the recommendation information, according to the preference of the user. The preference of the user, for example, may refer to a tendency of the user, such as a tendency of the user to watch a drama, a tendency to the user to watch an animation, or a tendency of the user to watch a soccer. It is noted that even in a case where the user (one user) spends much time in viewing dramas, in a case where another user has a child, the terminal apparatus 2 may determine the recommendation information taking into consideration an animation that the child watches.

Furthermore, the terminal apparatus 2 may cause the user to select a category of his/her favorite content, and may include the selected category of his/her favorite content in the recommendation information. Furthermore, the terminal apparatus 2 may set a character that is displayed on the screen, according to the preference of the user. With this configuration, the terminal apparatus 2 displays an avatar on a portion of the screen, or outputs voice with an avatar's tone of voice. Accordingly, the user can determine a tendency of the recommendation information.

[Flow for Processing (the Entire Recommending System 5)]

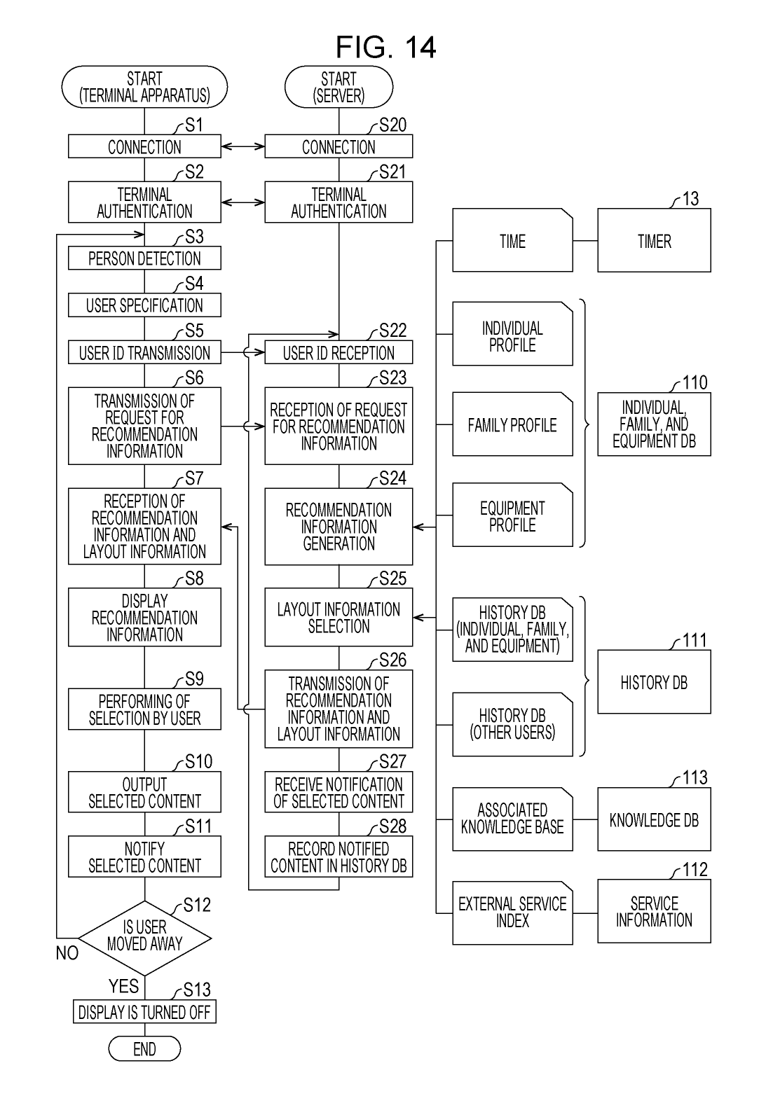

Next, a flow for processing that is performed in the recommending system 5 will be described with reference to FIG. 14. FIG. 14 is a flowchart illustrating an example of the flow for the processing that is performed in the recommending system 5. It is noted that in FIG. 14, various pieces of data that are used for generation of the recommendation information and selection of the layout information are also described.

First, processing by the terminal apparatus 2 is described. The terminal authentication unit 204 establishes a communication connection with the server 1 through the terminal communication unit 22 (S1), and performs authentication processing by the terminal apparatus 2 (S2). At this point, when the user's presence-and-absence determination unit 201 determines that a person (a user) is detected from a result of the detection by the person detecting sensor 24 (S3), the user specification unit 202 analyzes an image that is captured by the image capture unit 25 and specifies who the user detected in S3 is (S4).

It is noted that the frequency with which the processing is performed in S3 may be changed according to the time span. For example, there is a high likelihood that the user will pass before the terminal apparatus 2 many times during the morning hours. For this reason, during the morning hours, user's presence-and-absence determination unit 201 turns off the display. Then, for a prescribed time (for example, five minutes), even in a case where the user is detected, user's presence-and-absence determination unit 201 may not turn on the display. Furthermore, for example, even in a case where during the midnight time span or an early morning time span (for example, 0:00 am to 05:00 am), the user is detected, the display may not be turned on. Accordingly, this results in user's sleep being not interrupted. Alternatively, ambient brightness in the vicinity of the terminal apparatus 2 may be detected, and the display may be turned on depending on luminance in accordance with the detected brightness.

Next, the recommendation information acquisition unit 203 not only transmits a user ID of the user who is specified in S4, to the server 1 (S5), but also transmits a request for transmission of the recommendation information in the same manner to the server 1 (S6). Then, the recommendation information acquisition unit 203 receives the recommendation information and the layout information from the server 1 (S7), and the recommendation screen generation unit 208 displays the recommendation information that is received in S7, in a layout that is indicated by the layout information which is received in S7, on the display unit 27 (S8). It is noted that, in a case where there are many pieces of recommendation information of which the number is greater than the number of pieces of recommendation information that can be displayed in the layout that is indicated by the layout information which is received in S7, the recommendation information that is to be displayed may be selected according to a priority level that is set in advance.

At this point, when the user performs a selection (a selection of the recommendation information that is displayed in S8)) on the gesture recognition unit 200 or the input unit 28 (S9), the selected content is output (S10). More specifically, if the selected content is the broadcast content, the broadcast content control unit 205 causes the selected content to be output. Furthermore, if the selected content is the internal content, the internal content control unit 206 causes the selected content to be output. Furthermore, if the selected content is the external content, the external content control unit 207 causes the selected content to be output.

Furthermore, when the selection of the content is performed, the recommendation information acquisition unit 203 notifies the server 1 of the content that is selected by the user (S11). At this point, the user's presence-and-absence determination unit 201 detects the user in S3, and then monitors whether or not the user moves away from the terminal apparatus 2, that is, whether or not the user is continuously detected (S12). Then, if the user does not move away from the terminal apparatus 2 (NO in S12), the processing returns S3, and if the user moves away from the terminal apparatus (YES in S12), switching to turning-off of the display on the display unit 27 takes place (S13) and the processing is ended.

Subsequently, processing by the server 1 is described. The terminal authentication unit 100 establishes a communication connection with the terminal apparatus 2 through the server communication unit 12 (S20) and performs authentication the processing by the terminal apparatus 2 (S21). As described above, because the terminal apparatus 2 detects the user and transmits the user ID of the user to the server 1 (S5), the user specification unit 101 receives the user ID (S22). Accordingly, the user specification unit 101 specifies that the user who is indicated by the user ID is a target to which the recommendation information is presented. Furthermore, because the terminal apparatus 2 that, as described above, detects the user transmits a request for the recommendation information (S6), the recommendation information generation unit 102 receives the request for the recommendation information (S23).

Next, the recommendation information generation unit 102 that receives the request for the recommendation information acquires various pieces of information from the information management unit 103, and generates the recommendation information referring to these pieces of information (S24). It is noted that the recommendation information may be selected, for example, from among candidates for the recommendation information, which are prepared in advance, without needing to be necessarily generated. Next, the recommendation information generation unit 102 notifies the layout selection unit 104 of the generated recommendation information. Furthermore, the layout selection unit 104 selects the layout information that is used for positioning the notified recommendation information, from among a plurality of pieces of layout information 114 that are stored in the server storage unit 11 (S25). It is noted that generation of the recommendation information and a detail of the selection of the layout information will be described below.

Then, the information transmission unit 105 transmits the recommendation information that is generated in S24 and the layout information that is selected in S25 to the terminal apparatus 2 (S26). It is noted that in a case where the recommendation information was transmitted in the past to the terminal apparatus 2, only a difference (for example, the recommendation information that is updated) between the recommendation information that was previously transmitted and the recommendation information that is to be transmitted this time may be transmitted. In this case, the terminal apparatus 2 can cache the recommendation information that was previously transmitted by the server 1, and can display the cached recommendation information. In the same manner, the terminal apparatus 2 employs a configuration in which the layout information is cached. Thus, in a case where the layout is not changed, the transmission of the layout information can be omitted and an amount of communication between the server 1 and the terminal apparatus 2 can be reduced.

Thereafter, because the terminal apparatus 2 notifies the server 1 of the selected content, the information management unit 103 receives a notification (S27), and records the notified content in the history DB 111 (S28). Thereafter, the processing returns to S22.

(Supplement to the Flow Described Above)

In S5, the user ID that is transmitted by the terminal apparatus 2 to the server 1 may be an ID of equipment (for example, a smartphone or a wearable device) that is personally owned by the user.

In S24, the server 1 integrally gathers (i) information on a current point in time, (ii) a profile of each of the individual user and the user's family equipment, (iii) pieces of historical information that are associated with the user, the family, and the equipment, respectively, (iv) pieces of historical information that are associated with other users, (v) information relating to details or attributions of content, or the like, (vi) others, such as knowledge (for example, an annual event, information relating to the district where the user resides, a distance between words, or an output phrase for speech output or text output) that the server 1 collects and learns by making periodic visits to other servers, and performs analysis of these. Thus, the server 1 determines a user's favorite service or the tendency of the content. Then, the server 1 generates the recommendation information, referring to an index information on a service and content that are provided by an Internet service business operator.

Included in the index information on the content are, for example, a program broadcast schedule, a title (a title during delivery in a case where a recommendation service is a VOD service), the age limitation of viewing, details, a manufacturer, performers, a viewer's evaluation, a category, a genre, and the like.

The server 1 may determine the recommendation information based on text information that is included in the index information. For example, in a case where the user has a preference for dancing or cooking, the server 1 may determine content, in a title of which words such as “dancing” or “cooking” are included, as one piece of recommendation information. Alternatively, the server 1 may determine the recommendation information based on an impression or an ambience (for example, brightness, a volume of sound, or color) of the content.

A service that the server 1 determines as the recommendation service is not particularly limited, but for example, and may be an image delivery (VOD) service, an EC service, an SNS service, a schedule service, or an application providing service.

Furthermore, pieces of recommendation information may include recommendation information on the past content (video-recorded content), recommendation information on current program (a program that is currently being broadcast), and recommendation information on future content (content that is registered for viewing reservation or video recording reservation). In order to determine the recommendation information, in addition to the index information described above, the server 1 may acquire information (a broadcasting station, a broadcast point in time, and information that is associated with a broadcast title (a title, details, performers, a viewing rate, or the like)) in the district where the user resides, from an external server. Moreover, the server 1 may acquire the broadcast-associated information described above, from SI information that accompanies a broadcast wave.

The server 1 may determine content that is to be included in the recommendation information, from among pieces of internal content that are stored in the terminal apparatus 2. With this configuration, the server 1 acquires the index information on the internal content (for example, a photograph or a video), from the terminal apparatus 2, and stores the acquired index information as a service index. Then, when generating the tile resource as the recommendation information, the server 1 refers to not only the service index that is provided by the Internet service business operator, but also the index information of the internal content that is acquired from the terminal apparatus 2. It is noted that the terminal apparatus 2 may determine the content that is to be included in the recommendation information, from among the pieces of internal content.

In S25, the server 1 determines a data format that is to be used when the recommendation information is transmitted, and converts the recommendation information into transmission information (in compliance with a prescribed format) in the data format. It is noted that the recommendation information may be information for displaying one tile and may be information that describes (information for displaying the recommendation screen) the entire display screen which includes a plurality of tiles. Furthermore, the server 1 may transmit only the tile resource as the recommendation information. With this configuration, the terminal apparatus 2 stores a plurality of pieces of layout information, and layout-displays the recommendation information using the layout information that is selected from among the plurality of pieces of layout information. Furthermore, the terminal apparatus 2 may display not only a tile for the content that is included on the recommendation information which is received from the server 1, but also a tile for the content that is selected from among the pieces of internal content. In this case, the internal content that is set to be the recommendation information may be determined based on information such as details of the content that is video-recorded in the terminal apparatus 2, or a title. In addition to an acquisition destination of content, information such as a thumbnail image (including a moving image) is also included in the tile resource.

It is noted that the server 1 can also include the external content in the recommendation information. With this configuration, in a case where the user selects the external content from among pieces of recommendation information (including the recommendation content), a request for the external content is made from the terminal apparatus 2. The server 1 acquires the external content that is requested, from a server of a content providing business operator, and transmits the acquired content to the terminal apparatus 2. Of course, the terminal apparatus 2 may acquire the external content without involving the server 1.

[Flow for Processing (Dynamic Change of the Layout)]

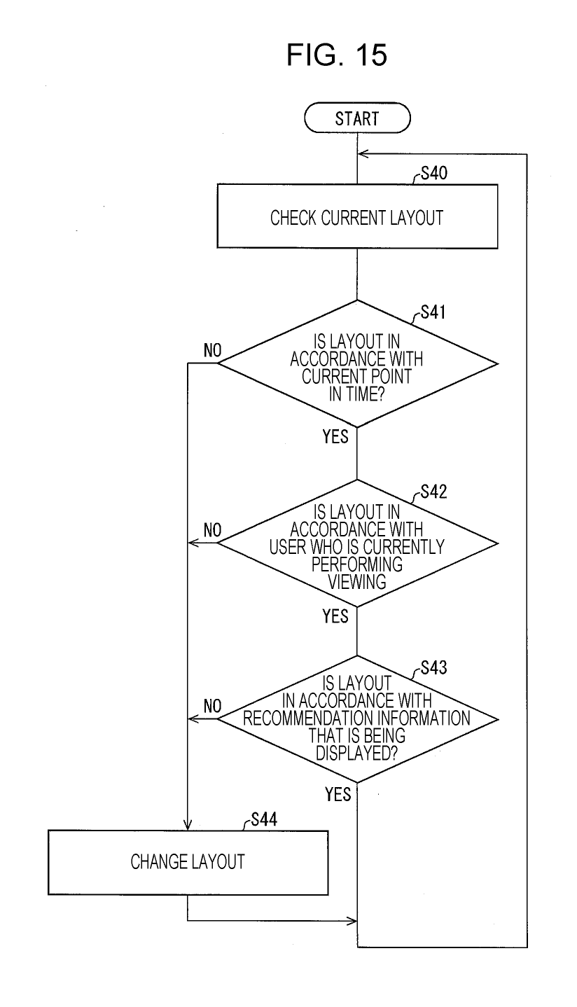

Next, a flow for processing in which that the terminal apparatus 2 dynamically changes the layout for the recommendation information will be described with reference to FIG. 15. FIG. 15 is a flowchart illustrating an example of the processing that dynamically changes the layout for the recommendation information.

When a prescribed time has elapsed after the recommendation screen was generated and was displayed on the display unit 27, the recommendation screen generation unit 208 checks which layout the layout for the recommendation screen is (S40). Then, the recommendation screen generation unit 208 determines whether or not a layout resulting from the checking is a layout in accordance with a current point in time (or a current time span) at which the timer 23 is output (S41).

At this point, in a case where it is determined that the layout resulting from the checking is not the layout in accordance with the current point in time (or the current time span) (NO in S41), the recommendation screen generation unit 208 performs changing to the layout in accordance with the current point in time (or the current time span) (S44). It is noted that regarding the layout information that is to be used for the changing of the layout, the layout information that is stored in the terminal apparatus 2 may be used and that if the layout information is not stored, the layout information to be used may be acquired from the server 1.

On the other hand, in a case where it is determined that the layout resulting from the checking is the layout in accordance with the current point in time (or the current time span) (YES in S41), the recommendation screen generation unit 208 determines whether or not the layout resulting from the checking in S40 is the layout in accordance with the user who currently views an image that is output by the terminal apparatus 2 (S42). It is noted that the determination is made based on the latest user ID that is received by the user specification unit 202.

Then, in a case where it is determined that the layout resulting from the checking is not the layout in accordance with the user (NO in S42), the recommendation screen generation unit 208 performs changing to the layout in accordance with the user, in the same manner as in the case of the changing to the layout in accordance with the current point in time (or the current time span) (S44). On the other hand, in a case where it is determined that the layout resulting from the checking is the layout in accordance with the user (YES in S42), the recommendation screen generation unit 208 determines whether or not the layout resulting from the checking in S40 is the layout in accordance with the recommendation information that the terminal apparatus 2 is currently caused to display (S43). It is noted that the determination is made based on the latest recommendation information that is acquired by the recommendation information acquisition unit 203.

At this point, in a case where it is determined that the layout resulting from the checking is not the layout in accordance with the recommendation information that is being displayed by the terminal apparatus 2 (NO in S43), the recommendation screen generation unit 208 performs changing to the layout in accordance with the recommendation information that is being displayed, in the same manner as in the case of the changing to the layout in accordance with the current point in time (or the current time span) (S44). On the other hand, in a case where it is determined that the layout resulting from the checking is the layout in accordance with the recommendation information that is being displayed (YES in S43), the recommendation screen generation unit 208 repeatedly performs the processing operations in S40 and subsequent steps after a prescribed time elapsed. The same is also true for a case where the layout is changed in S44, and the processing operations in S40 and subsequent steps are repeatedly performed when a prescribed time elapsed after the layout was changed.

It is noted that in the above description, the processing in the case where the dynamic change of the layout is performed is described above, but that the selection of the layout in S25 in FIG. 14 can also be performed with the same determination. That is, in S25, prescribed layout information in accordance with at least one of the point in time (or the time span), the recommendation information, and the user that is the presenting target is selected. It is noted that the layout information in accordance with the recommendation information and the layout information in accordance with the user may be determined in advance in the same manner as the layout information in accordance with the time span. For example, the layout information, characters for which are displayed in an enlarged manner, may be associated with the recommendation information dedicated for the aged. In the same manner, the layout information, characters for which are displayed in an enlarged manner, may be associated with the aged user.

[Flow for Processing (Generation of the Recommendation Information in accordance with a Plurality of Users)]

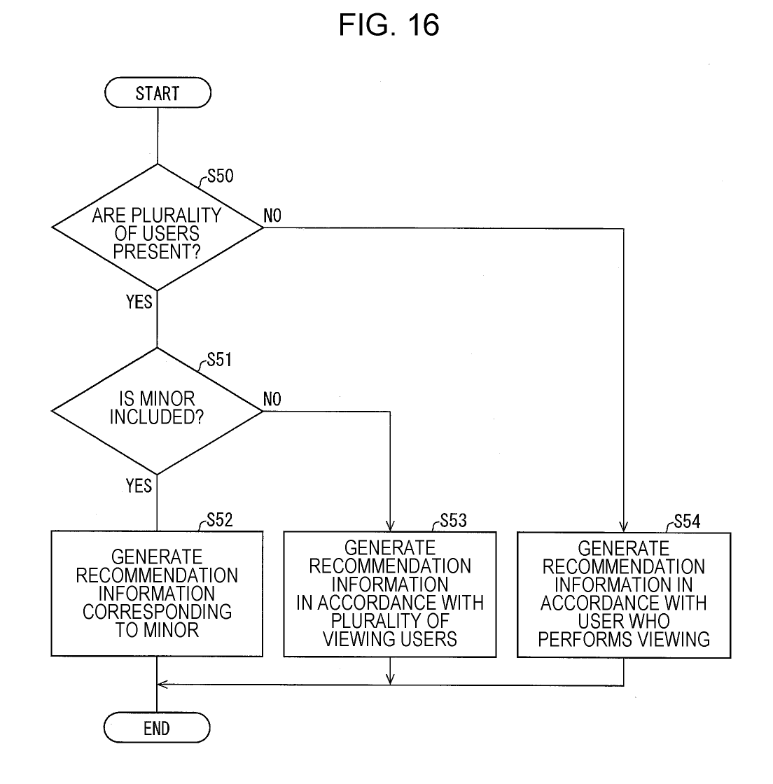

Next, a flow for processing that generates the recommendation information in accordance with a plurality of users will be described with reference to FIG. 16. FIG. 16 is a flowchart illustrating an example of the processing that generates the recommendation information in accordance with the plurality of users.

The recommendation information generation unit 102 of the server 1 determines whether or not the plurality of users view an image that is output by the terminal apparatus 2, who are specified by the user specification unit 101 (S50). Specifically, in a case where the user specification unit 101 receives a plurality of user IDs from one terminal apparatus 2 within a prescribed time, it is determined that there are a plurality of viewing users.

At this point, in a case where it is determined that there are not a plurality of viewing users (that there is one viewing user) (NO in S50), the recommendation information generation unit 102 generates the recommendation information in accordance with the one viewing user (S54) and ends the processing. On the other hand, in a case where it is determined that there are a plurality of viewing users (YES in S50), the recommendation information generation unit 102 determines whether or not a minor is present among the viewing users (S51). It is noted that a reference for determining the minor may be suitably and that for example, the minor may be set to be someone who is at the age of 15 or less.

At this point, in a case where it is determined that the minor is not present among the plurality of viewing users (NO in S51), the recommendation information generation unit 102 generates the recommendation information in accordance with the plurality of viewing users (S53) and end the processing. On the other hand, in a case where it is determined that the minor is present among the plurality of viewing users (YES in S51), the recommendation information generation unit 102 generates the recommendation information that corresponds to the minor (S52) and ends the processing.

[Flow for Processing (Acquisition of the Recommendation Information and the Layout Information in Accordance with the Time Span)]

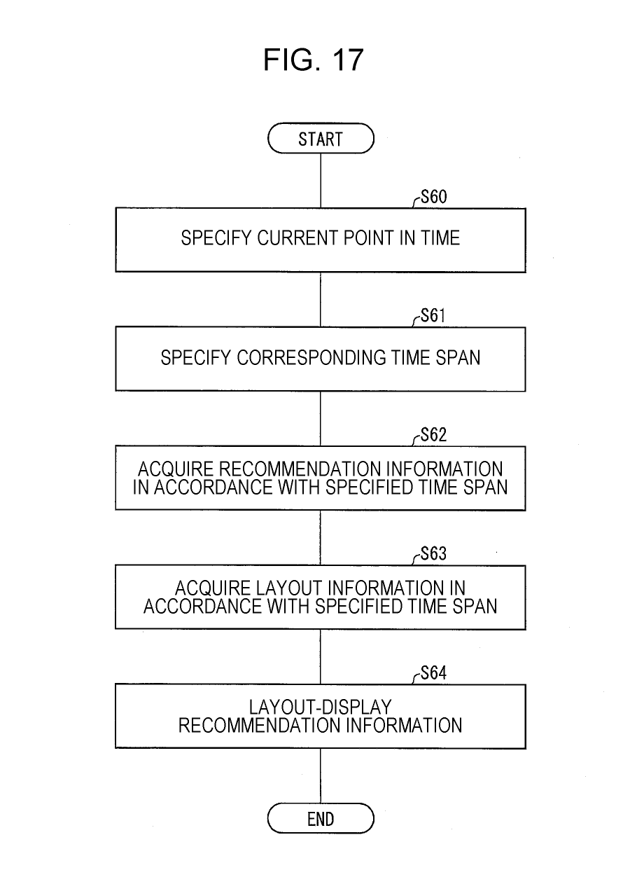

Next, a flow for processing that acquires the recommendation information and the layout information in accordance with the time span will be described with reference to FIG. 17. FIG. 17 is a flowchart illustrating an example of the processing that acquires the recommendation information and the layout information in accordance with the time span.

The recommendation information acquisition unit 203 of the terminal apparatus 2 specifies a current point in time from an output of the timer 23 (S60) and specifies which one of the plurality of time spans that are determined in advance is the current point in time corresponds to (S61). For example, 05:00 am to 09:00 am, 09:00 am to 12:00 am, 12:00 to 06:00 pm, and 07:00 pm to 12:00 pm may be set to be morning, forenoon, afternoon, and night, respectively. Other time spans may be set to be midnight and early morning, respectively.

Then, the recommendation information acquisition unit 203 transmits not only information indicating a time span specified, but also the request for the recommendation information to the server 1, and acquires the recommendation information and the layout information in accordance with the time span that is specified in S61, from the server 1 (S62 and S63). Thereafter, the recommendation screen, on which the recommendation information that is acquired in S62 is arranged at the layout that is indicated by the layout information that is acquired in S63, is generated by the recommendation screen generation unit 208 and is displayed on the display unit 27 (S64), and the processing is ended.

[Other Examples of the Recommendation Screen]

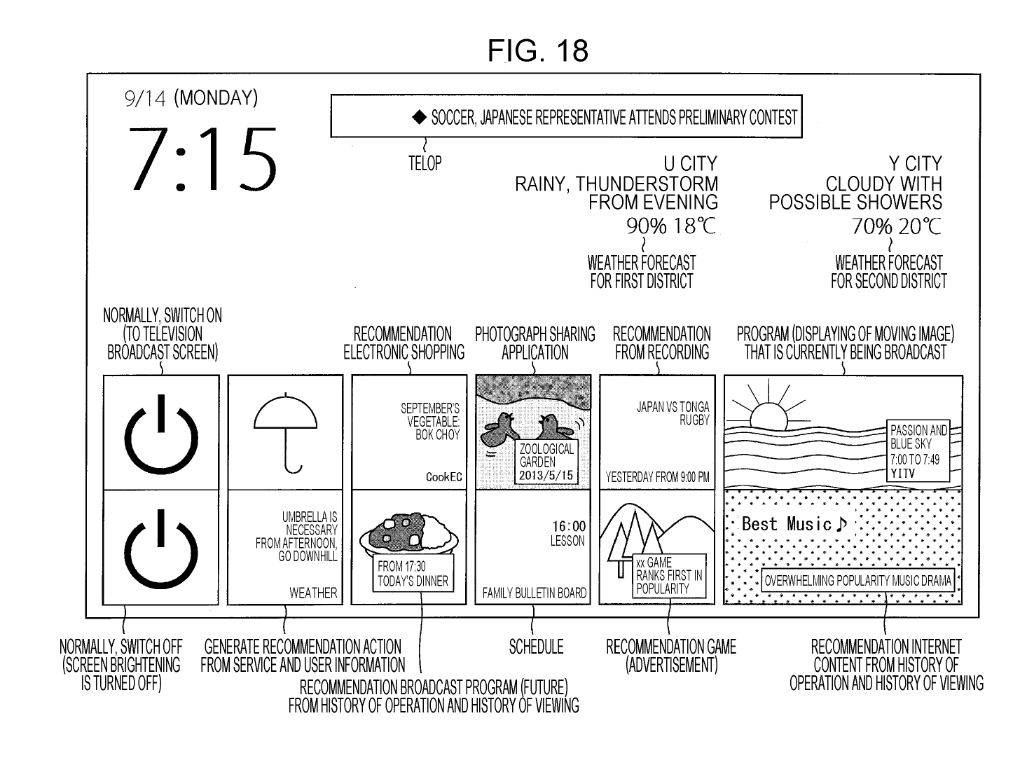

The recommendation screen may be as illustrated in FIG. 18. FIG. 18 is a diagram illustrating an example of the recommendation screen. The following information is included in the recommendation screen that is illustrated.

(i) Current date and time

(ii) Telop of news

(iii) Weather Information (weather for a current location, weather for a district that is registered in advance, or weather for one or more places)

(iv) Button (a tile) for switching between power-on and power-off of the terminal apparatus 2

(v) Recommendation action information (This information is generated from the service and the user information. For example, recommendation action information “Because the weather will get worse this afternoon, please carry an umbrella when leaving the house” is generated from the weather information)

(vi) Recommendation Program Information (This information is generated from historical information on the operation by the user, historical information on the viewing by the user, and information on a program that is video-recorded by the user. For example, in a case where the user wants to view a program titled “00”, recommendation program information “00 from 17:30” is displayed.)

(vii) Advertisement of a Recommendation product or a recommendation service (for example, a recommendation game)

(viii) Recommendation Internet content (which is generated from the historical information on the operation and the historical information on the viewing)

(ix) Information on a program that is being broadcast (for example, a program name, broadcast time, and a name of a television station (or a channel that is allocated to the television station) are displayed. Furthermore, a portion of the program, a thumbnail image of the program or the like is displayed)

(x) Webpage of a shopping site that introduces the recommendation product

(xi) User's schedule (for example, a schedule event “ΔΔ from 16:00” (ΔΔ is details of the event) is displayed)

(xii) Photograph (a photograph sharing application. Information that is attached to the photograph is displayed)

[Example of a Hardware Configuration for Detection of the User by the Terminal Apparatus 2]

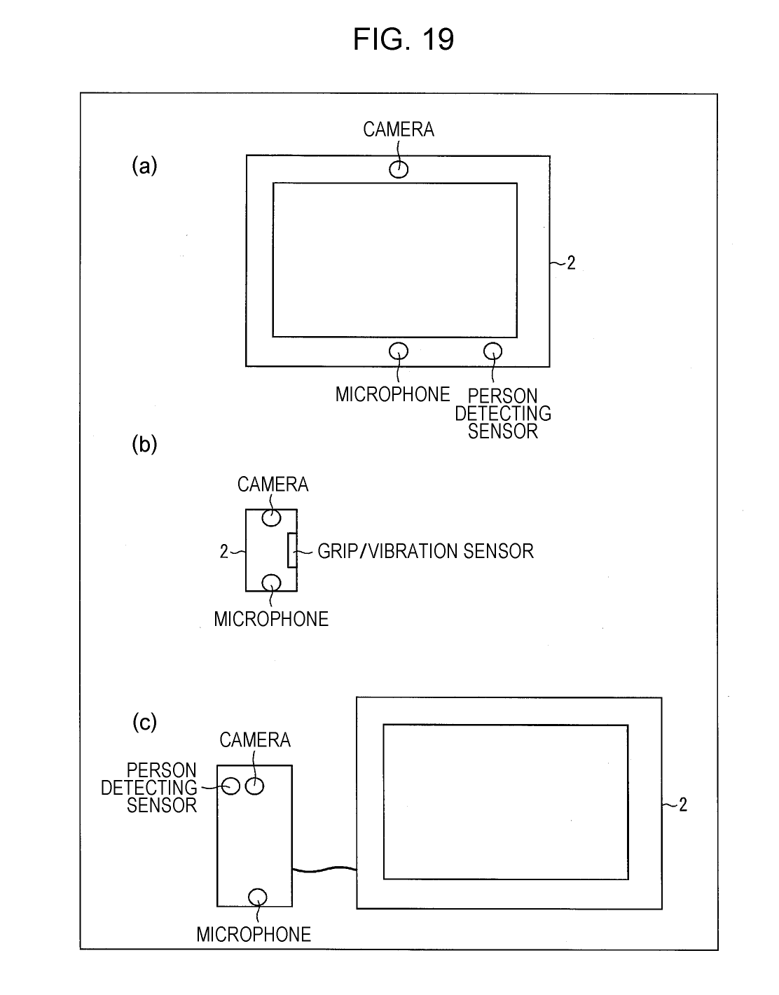

An example of a hardware configuration for detection of the user by the terminal apparatus 2 will be described with reference to FIG. 19. FIG. 19 is a diagram illustrating the example of the hardware configuration for the detection of the user by the terminal apparatus 2.

The terminal apparatus 2 in (a) of FIG. 19 includes a camera, a microphone, and a person detecting sensor. In the terminal apparatus 2, the user can be detected using at least one of an analysis of an image that is captured by the camera, an analysis of speech that is acquired with the microphone, and a result of detection by the person detecting sensor. The terminal apparatus 2 in this case may be, for example, a PC or a television set.

The terminal apparatuses 2 in (b) of FIG. 19 include a camera, a vibration sensor, and a microphone. In the terminal apparatus 2, the user can be detected using at least one of an analysis of an image that is captured by the camera, an analysis of speech that is acquired with the microphone, and a result of detection by the vibration sensor. It is noted that although a grip sensor which detects that the user grips the terminal apparatus 2 is applied instead of the vibration sensor, the detection of the user is possible.

The terminal apparatus 2 in (b) of FIG. 19 is connected to another terminal apparatus that includes a camera, a microphone, and a person detecting sensor. In this case, because the other terminal possibly detects the user, the terminal apparatus 2 can detect the user by receiving a result of the detection. It is noted that the terminal apparatus 2 may be connected to the other terminal apparatus for wired communication and may be connected to the other terminal apparatus for wireless communication.

[State Transition of the Terminal Apparatus 2]

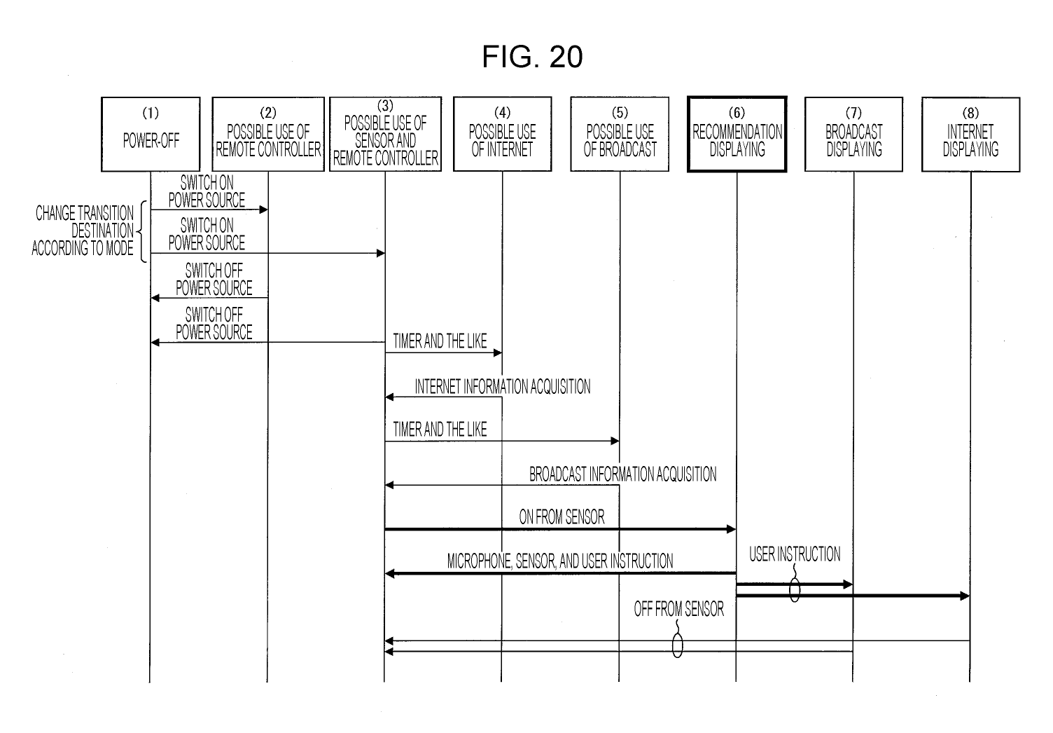

State transition of the terminal apparatus 2 will be described with reference to FIG. 20. FIG. 20 is a sequence diagram illustrating an example of the state transition of the terminal apparatus 2. It is noted that in FIG. 20, states (1) to (8) that will be described below are illustrated, but that the state to which the terminal apparatus 2 transitions is not limited to these examples.

(1) Power-off

(2) Possible use of the remote controller

(3) Possible use of the sensor and the remote controller

(4) Possible use of the Internet

(5) Possible use of the broadcast

(6) Display of the recommendation information

(7) Display of the broadcast content

(8) Display of the Internet content

In a state of (1) (power-off) described above, a transition destination of the terminal apparatus 2 in a case where the terminal apparatus 2 is powered off varies according to a mode of the terminal apparatus 2 at that point of time. Specifically, the terminal apparatus 2 transitions to a state of (2) or (3) described above according to a mode at a point of time at which the terminal apparatus 2 is powered off. That is, in a case where the terminal apparatus 2 is powered on when the terminal apparatus 2 is in a prescribed mode, the terminal apparatus transitions to the state of (2) in which an operation by the remote controller is performed on the terminal apparatus 2. It is noted that although not illustrated, in the state of (2), in the same manner as in a general television set in the related art, with the operation by the remote controller, the user can cause desired content to be output to the terminal apparatus 2.

On the other hand, in a case where the terminal apparatus 2 is powered on when the terminal apparatus 2 is in a different mode from the prescribed mode, the terminal apparatus 2 transitions to the state of (3) described above. In the state of (3), not only the operation by the remote controller is performed on the terminal apparatus 2, but also the user is recognized by the person detecting sensor 24 (the grip sensor or the vibration sensor as illustrated in FIG. 19 may be available and the microphone or the camera may be available).

The terminal apparatus 2 transitions to the state of (3), and then transitions to a state of (4) in which the terminal apparatus 2 is connected to the Internet and the server 1, under the timer control after a first prescribed time elapsed. Accordingly, the terminal apparatus 2 can output the Internet content, and can acquire the historical information on the use of, and the historical information on the operating, of the equipment that is owned by the user, and the like, from the server 1 or the Internet. It is noted that output of the Internet content starts according to the user operation.

Furthermore, the terminal apparatus 2 transitions to the state of (3) described above, and then transitions to a state of (5) in which reception of a broadcast wave such as one for digital broadcast or one for BS and CS broadcast, that is, the broadcast content is possible, under the timer control after a second prescribed time elapsed. Accordingly, the terminal apparatus 2 can output the broadcast content, and can acquire broadcast information such as a program guide or a program information. It is noted that output of the broadcast content starts according to the user operation.

Then, the terminal apparatus 2 transitions to the state of (3) described above, and then, when the user is detected in the person detecting sensor 24, transitions to a state of (6) described above. In a case where the terminal apparatus 2 is powered off, a prescribed time elapsed without any operation being performed on the terminal apparatus 2, or the user is not detected in the person detecting sensor 24, the terminal apparatus 2 transitions from the state of (6) to the state of (3) described above. It is noted that, in a case where the terminal apparatus 2 is in a specific mode, the terminal apparatus 2 may transition from the state of (6) to (1) or (2) described above instead of transitioning to (3) described above.

The terminal apparatus 2 transitions to the state of (6) described above, and then transitions to a state of (7) in which the broadcast content is output, in a case where an operation (for example, an operation of selecting a channel that is used for viewing) for viewing the broadcast content is performed on the terminal apparatus 2. In a case where in the state (7), the user is not detected in the person detecting sensor 24, the terminal apparatus 2 transitions to (3) described above. It is noted that, in the case where the terminal apparatus 2 is in a specific mode, the terminal apparatus 2 may transition from (7) described above to (1) or (2) described above instead of transitioning to (3) described above.

On the other hand, after the transitioning to the state of (6) described above, in a case where an operation for reading the Internet content (for example, an operation of selecting the recommendation information that corresponding the Internet content, or an icon of a shortcut) is performed, transitioning to a state of (8) in which the Internet content is output takes place. In the case where in the state of (8), the user is not detected in the person detecting sensor 24, the terminal apparatus 2 transitions to (3) described above. It is noted that, in the case where the terminal apparatus 2 is in a specific mode, the terminal apparatus 2 may transition from (8) described above to (1) or (2) described above instead of transitioning to (3) described above.

[Flow for Processing (Generation of the Recommendation Information)]

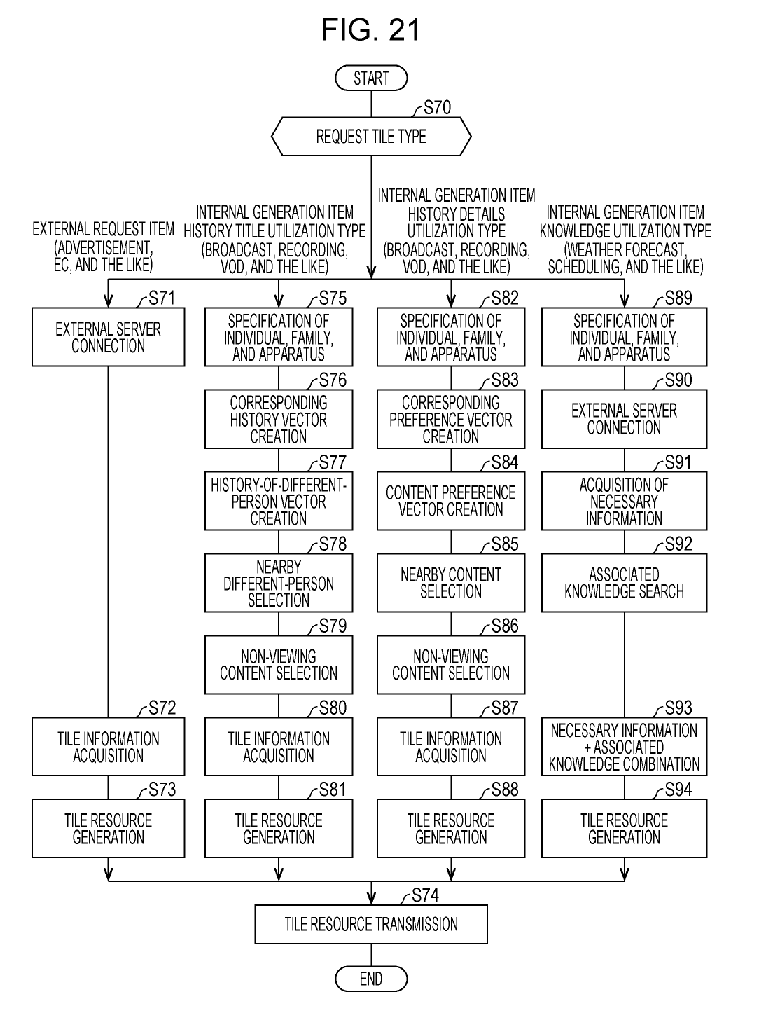

Next, detail of processing that generates the recommendation information, which is performed in S24 in FIG. 14 will be described with reference to FIG. 21. FIG. 21 is a flowchart illustrating an example of a flow for the processing for the generation of the recommendation information. It is noted that the “tile resource” in FIG. 21 corresponds to the recommendation information described above. Furthermore, at this point, processing in which the request for the recommendation information, which designates any of types (A) to (D) that will be described, is received from the recommendation information acquisition unit 203 of the terminal apparatus 2.

(A) External request item

(B) Internal generation item (a history title utilization type)

(C) Internal generation item (a history details utilization type)

(D) Internal generation item (knowledge utilization type)

The external request item (A) described above is the recommendation information whose presentation to the terminal apparatus 2 is requested by an external service such as an advertisement or EC. In the case of a general EC site, because the user has access to the site with equipment such as the terminal apparatus 2 and performs a purchasing action, a list of purchased items, a list of visited pages, and the like do not remain within the server 1. Consequently, a server of an EC business operator is requested to transmit the recommendation information (tile information), and the tile resource is generated based on the recommendation information that is received according to this request, and the generated tile resource is transmitted to the terminal apparatus 2. Furthermore, in the case of the advertisement, an advertisement server knows an action history of the user who uses a cookie, a request is made to the advertisement server and the recommendation information (an advertisement) is acquired. Of course, a recommendation advertisement or a shopping item is selected from a personal history or a preference information in the server 1, and the tile resource that recommends those may be generated.

More precisely, in a case where the recommendation information on the external request item is requested, the information management unit 103 makes a connection to an external server (S71) and acquires the tile information (information such as an advertisement that makes a recommendation the user) from the external server (S72). Then, the tile resource (the recommendation information) is generated from the acquired tile information (S73), and the information transmission unit 105 transmits the generated tile resource to the terminal apparatus 2 (S74).

The internal generation item (the history title utilization type) (B) described above is the recommendation information that is generated with a relationship with another person based on histories of an individual, a family, and equipment. A typical technique is illustrated in FIG. 21, but the technique does not matter.

The user specification unit 101 specifies the user from the user ID that is acquired from the terminal apparatus 2. Furthermore, referring to the individual, family, and equipment DB 110, the information management unit 103 specifies a family of the user and equipment that is owned by the user or the family, which are associated with equipment ID and the user ID described above that are acquired from the terminal apparatus 2 (S75).

Moreover, referring to the history DB 111, the information management unit 103 generates a correspondence history vector (a person-in-question vector) that has, for example, the content title as an element, from viewing, operation, and access histories, which are associated with the user with the user ID described above (S76). In this case, the processing is performed on every category that has to be recommended, such as a movie or a broadcast. A method in which a title that is viewed is set to 1 and the other titles are set to 0 is a method of generating a typical vector.

Furthermore, because in addition to the user of the terminal apparatus 2, pieces of historical information on many users are stored in the history DB 111, the information management unit 103 generates a history-of-different-person vector that has the content title as an element, in the same manner as described above (S77). Furthermore, the same vector may be generated for items of equipment that are owned by other users.

It is noted that the information management unit 103 may generate the history-of-different-person vector in advance, and may store the generated history-of-different-person vector. Furthermore, because many items of content are broadcast every day, only a title of a television program that is broadcast within the latest period of time that is prescribed may be included in components of the correspondence history vector and the history-of-different-person vector.

Next, the information management unit 103 obtains a likelihood between the correspondence history vector that is generated in S76, and the history-of-different-person vector that is generated in S77, and the history-of-different-person vectors are arranged in a line in order of decreasing likelihood (a high likelihood is close to 1). Because it is considered that a different person that has a high likelihood has a preference similar to that of the user himself/herself, the information management unit 103 selects one from among the history-of-different-person vectors each of which has a likelihood that is greater than a prescribed value (S78). The selection may be randomly performed made and the history-of-different-person vector that has the highest likelihood may be selected.

Subsequently, the information management unit 103 selects an element that is to be recommended from among elements (tiles) of the history-of-different-person vector (S79). As described above, in a case where the title that is viewed is set to 1 and the others are set to 0, an element that has a correspondence history vector (the person-in-question vector) value of 0 may be selected from among elements that have a value of 1 in the history-of-different-person vector. It is noted that in a case where there are a plurality of elements, each of which has a correspondence history vector value of 0, only a desired number (the number of necessary pieces of recommendation information) of elements may be selected from the plurality of elements, and this selection may be randomly performed. Accordingly, a title of content that is not viewed by the user, but is viewed by another user who has a preference similar to that of the user can be specified.

Then, the information management unit 103 acquires the tile information from an external server (a server that provides meta information relating to content on the specific title, or the like) (S80). Then, the tile resource (the recommendation information) is generated from the acquired tile information (S81), and the information transmission unit 105 transmits the generated tile resource to the terminal apparatus 2 (S74).

In addition to the content title, for example, the correspondence history vector and the history-of-different-person vector may be generated based on performers, a playwright, or the like. Furthermore, because, with the recommendation information on the broadcast content, a current or future title has to be recommended, only program that is currently being broadcast or will be broadcast from now on is selected. In this case, not only the history of the viewing, but also a video recording reservation history may be utilized. It is noted that a title that is to be recommended may be content that is video-recorded by the terminal apparatus 2, and in this case, content that is set to be the recommendation information is selected from among items of content that are recorded.

The internal generation item (the history details utilization type) (C) described above is the recommendation information that is generated with a relationship with details of a program or the like based on histories of an individual, a family, and equipment. In (C), unknown content (a new movie or a new book) or the like that is difficult to set to be a recommendation target with (B) described above can also be set to be a recommendation target.

For the recommendation information of (C), as is the case with (B), content that is a recommendation target is selected using the vector. However, the recommendation information of (C) is different from the recommendation information of (B) in that a correspondence preference vector is used that is generated based on details information (text) that is included in metadata that accompanies content which was viewed by the user in the past.

In a case where the recommendation information of (C) is generated, first, the information management unit 103 specifies a user, a family, and equipment (S82) in the same manner as in S75. Next, the information management unit 103 generates the correspondence preference vector (S83). Specifically, the information management unit 103 performs a morphological analysis on a text that accompanies the content which was viewed by the user in the past, extracts words, and further extracts feature words from the extracted words. In the extraction of the feature words, dictionary information in which feature words are registered may be used, and it is possible that dictionary information that serves as a base is created by learning of a lot of sentences in advance. A TF-IDF method (https://ja.wikipedia.org/wiki/Tf-idf) is typical, but this technique does not matter. Next, the information management unit 103 vectorizes each of the obtained feature words. As a technique for the vectorization, for example, wordtovec (https://code.google.com/p/word2vec/) is given. With this technique, a feature of a word can be expressed with a vector with a fixed length by learning of a lot of natural languages. It is noted that in addition, a technique for expressing a word with a vector is also present and that the technique that applies in S83 is not limited to wordtovec. Then, the information management unit 103 adds up the vectors of the feature words that are obtained as described above, and thus generates a feature vector (the correspondence preference vector) that expresses entire content.

Furthermore, for each item of content (content that is not viewed by the user) that is a recommendation candidate, the information management unit 103 also generates a content preference vector (S84) by performing the same processing as described above. Then, using a likelihood in the same manner as in S78, the information management unit 103 selects items of content that are not viewed, of which details are similar to those of the content that was viewed by the user in the past (S85), and selects content that is set to be the recommendation target, from among the selected items of content (S86). Processing operations in subsequent S87 and S88 are the same as those in S80 and S80, respectively.

It is noted that in the above description, the vectors of the feature words are added up and the correspondence preference vector is generated, but that it is also possible that a likelihood between items of content is calculated with the vector of the feature word, as is, serving as the correspondence preference vector.

The internal generation item (the knowledge utilization type) (D) described above is the recommendation information that is generated by utilizing information relating to the IDs of the individual, the family, and the equipment, which are acquired from the external server or the knowledge DB 113. In a case where the recommendation information of (D) is generated, first, the information management unit 103 specifies a user, a family, and equipment in the same manner as in S75 (S89). Next, the information management unit 103 makes a connection to an external server and thus acquires information relating to at least one of the IDs of the individual, the family, and the equipment that are specified in S89 (S90 and S91). For example, a weather forecast for a district where the equipment with the equipment ID described above is present, or information indicating a family's schedule or the like may be acquired. Furthermore, general information not relating to a specific result in S89, such as the information indicating what day today is, may be available. Then, an acquisition destination of information is not limited to an external server, but may be the knowledge DB 113 or the like.

Furthermore, the information management unit 103 searches the knowledge DB 113 for associated knowledge that accompanies at least one of the details that are specified in S89 and the information that is acquired in S91 (S92), and determines the details of the recommendation information by combining the associated knowledge that is detected and the information that is acquired in S91 (S93). Subsequent S94 is the same as S73.

For example, in a case where a rule base that results from associating a prescribed weather information and an output phrase that corresponds to the prescribed weather information with each other is included in the knowledge DB 113, the weather information may be acquired in S91 and the output phrase that corresponds to the weather information may be detected as the associated knowledge in S92. Accordingly, in a case where it is currently not raining, but a forecast that predicts that it will rain until night is issued, it is also possible that an output phrase for encouraging, which expresses that an umbrella is carried, is caused to be displayed as the recommendation information. The output phrase described above may be suitably set, but for example, the phrase “Today, you may as well carry an umbrella. Today in the U city, it is fine and is later cloudy and it will rain from the evening” may be available. In a case where the phrase is displayed in this manner, if the weather changes for the worse, a rule base specifying that the output phrase for encouraging, which expresses that an umbrella is carried, is caused to be displayed may be included in the knowledge DB 113. It is noted that a storage destination of the rule base is not limited to the knowledge DB 113, and may be external equipment such as an external server.

It is noted that it is also possible that (C) and (D) described above are calculated in parallel. Furthermore, the user may be requested to set whether or not to properly use (C) or (D) for every tile or whether or not to probabilistically switch between (C) and (D), or to set which one of (C) and (D) to apply, and thus one of (C) and (D) may be used. In this manner, the recommendation information on each tile may be determined using a different technique.

[Example of a Configuration of the Recommending System 5]

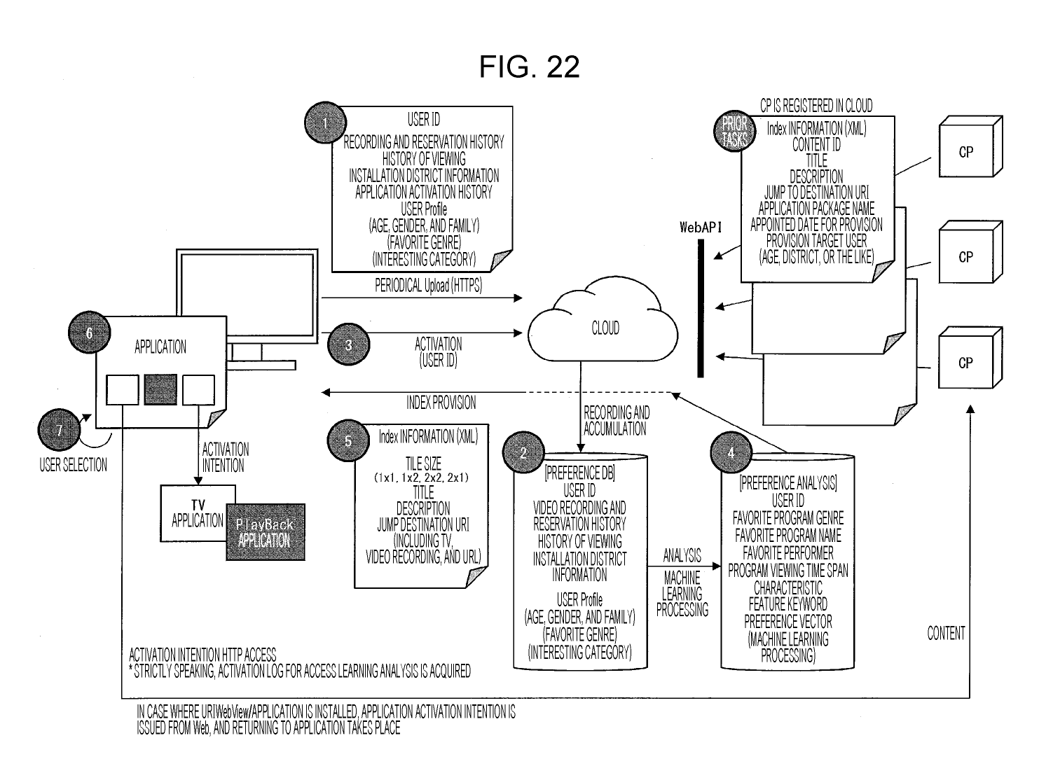

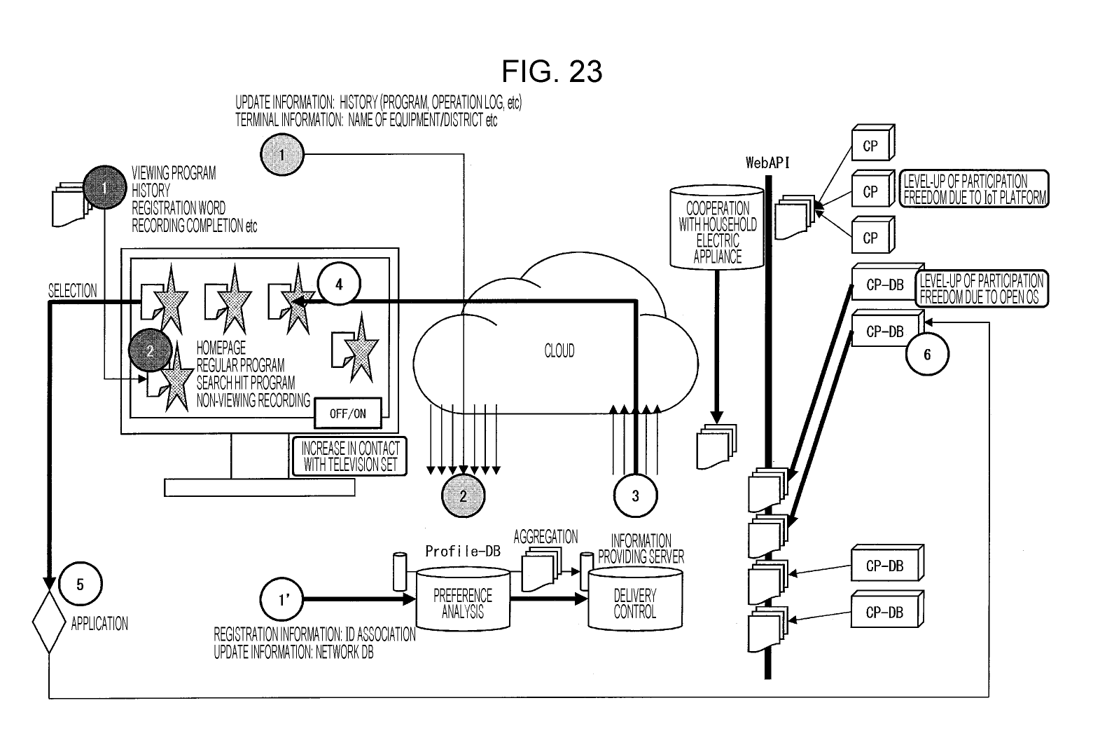

The recommending system 5 may be configured as in FIGS. 22 and 23. FIGS. 22 and 23 are diagrams, each illustrating an example of a configuration of the recommending system 5. It is noted that the server 1 is included in “cloud” in the vicinity of the center of each of these figures, and that a television set that is present to the left side of “cloud” corresponds to terminal apparatus 2.

In examples in FIGS. 22 and 23, a plurality of content providers (CPs) are registered in such a manner that information (a content ID, a title, or the like) relating to content that is provided by each of the plurality of CPs can be referred in advance through a Web Application Programming Interface (WebAPI).

Furthermore, as illustrated in FIG. 22, the terminal apparatus 2 periodically uploads various pieces of information (a video recording history, a reservation history, a viewing history, a user profile, and the like) relating to the user of the terminal apparatus 2 itself, as well as the user ID of the user of the terminal apparatus 2 itself, to the server 1 (1). Then, the server 1 records and accumulates the various pieces of information described above that are uploaded from the terminal apparatus 2 and other one terminal apparatus 2 (2). Accordingly, a DB in which various preferences of the user are reflected can be generated.

At this point, when the terminal apparatus 2 is activated, the user ID of the user of the terminal apparatus 2 itself is notified to the server 1 (3). Then, the server 1 interprets the preference of the user with the notified user ID based on the various pieces of information that are stored in the DB described above (4) and generates the recommendation information (described as the index information in FIG. 22) that meets the preference of the user and transmits the generated recommendation information to the terminal apparatus 2 (5). As illustrated, information such as a size of a tile on which the recommendation information is displayed is included in the recommendation information.

Next, in the terminal apparatus 2, with a prescribed application, the recommendation information described above is displayed (6) and the user selection is performed (7). If the recommendation information that is selected here is the internal content of the terminal apparatus 2, an application (a TV application or a PlayBack application in the example that is illustrated) that corresponds to the internal content of the terminal apparatus 2 itself is activated, and the internal content is output. Furthermore, if the selected recommendation information is content that is to be provided by the CP, the content is acquired from the CP and the acquired content is output.

Furthermore, as described above, when the user approaches the terminal apparatus 2, the terminal apparatus 2 displays the recommendation screen, and content other than the broadcast content is also presented on the recommendation screen. For this reason, in a case where the television set is set to be the terminal apparatus 2, as illustrated in FIG. 23, a contact between the television set and the user can be increased.

With the recommending system 5 described above, the server 1 interprets the preference of the user using the historical information on each user, big data that is a collection of pieces of historical information on the users, and a cloud ID-Profile (a profile that is managed in a state of being associated with the user ID and the equipment ID on the cloud). By combining these three pieces of information, the preference of the user can be exactly known.

Furthermore, the server 1 causes content in accordance with a pattern of the user, which is derived from the preference interpretation, to be displayed, as the recommendation information, on the terminal apparatus 2. Then, the recommendation information may include a rule for causing an application, which corresponds to content that is a recommendation target, to be activated. More precisely, the recommendation information may include information for causing an application (for example, an application that outputs the content) within the terminal apparatus 2, in accordance with the content, to be activated, instead of information indicating a link destination of the content.

Furthermore, it is also possible that the server 1 presents a plurality of application activation rules according to a user pattern by using an action history of an individual user. Accordingly, an application that is suitable for an individual user can be caused to be activated.

Furthermore, the terminal apparatus 2 activates an application based on the application activation rule, instead of using a shortcut of a webpage or an application, and thus can output prescribed content.

Then, the terminal apparatus 2 uploads which recommendation information the user selects, as the action history of the user, to the server 1. Accordingly, it is possible that the recommendation information in which the preference of the user is caused to be more accurately reflected is generated. More precisely, the action history of the user is caused to cycle, and thus the precision of the recommendation can be increased. Furthermore, it is also possible that which recommendation information the user selects is used as a parameter for measuring an effect of posting the recommendation information. For example, in a case where the recommendation information is an advertisement or the like, it is also possible that the frequency with which the recommendation information is selected is used, as a parameter for indicating an effect of the advertisement, for an advertisement business and the like.

Furthermore, it is also possible that the terminal apparatus 2 applies the weighting of the priority level to event information (information that is possibly presented as the recommendation information) that is possibly output without involving the server 1, using various pieces of historical information or big data that is information that results from combining the various pieces of historical information, which are stored in the server 1. More precisely, it is possible that a priority level is attached by the server 1 to information to which a priority level cannot be attached with a single terminal apparatus 2.

[Recommendation Information in Accordance with a Cycle and a Timing of the Action History]

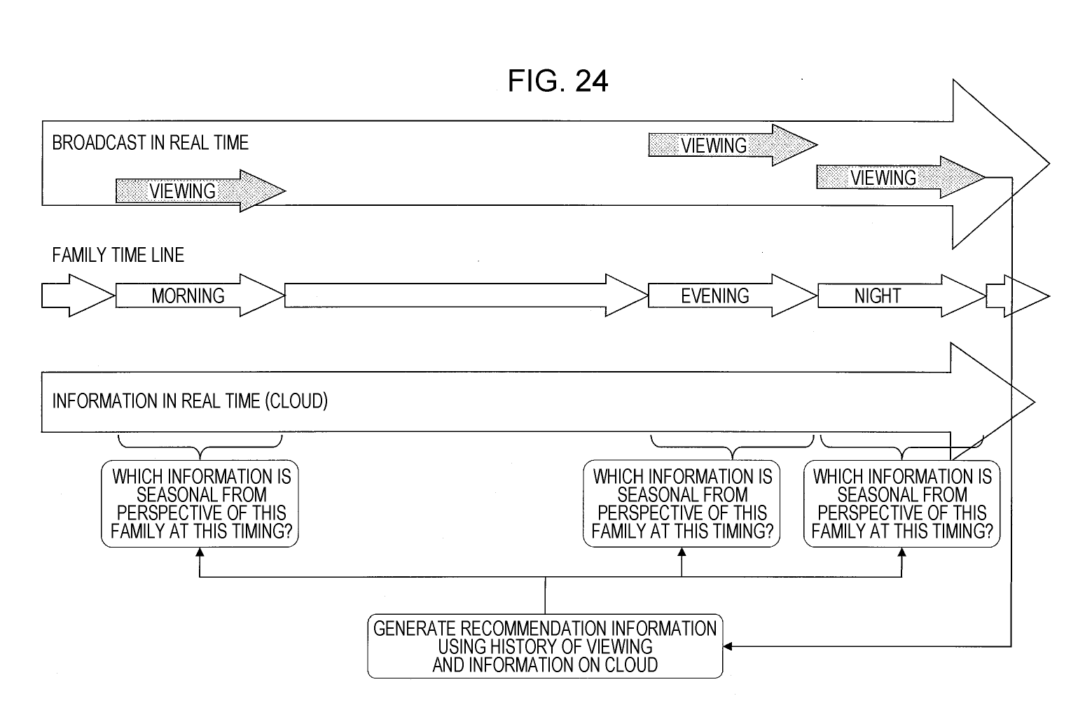

Next, the recommendation information in accordance with a cycle and a timing of the action history will be described with reference to FIG. 24. FIG. 24 is a diagram for describing the recommendation information in accordance with the cycle and the timing of the action history.

As described, generally, broadcast is performed all day long. Furthermore, the user and the family of the user take an action in accordance with each time span of the day, and the actions include viewing of the broadcast content as well. Then, a history of this action is uploaded to the server 1 on the cloud. Consequently, considering not only the user that is a target to which the recommendation information is presented, but also the time span during which the recommendation information is present and the family of the user, the server 1 can set seasonal information suitable for the time span, the family, and the user, to be the recommendation information.

[Other Supplementary Matters]

(Determination of the Recommendation Information in Accordance with Time)

In order to present the recommendation information that fits in a life of the user, it is desirable that the terminal apparatus 2 determines the recommendation information according to date and time, time, or a point in time. For example, it is desirable that during the morning hours, the terminal apparatus 2 presents the recommendation information in conjunction with weather for the day, traffic information, a today's schedule, and the like. On the other hand, it is desirable that during an evening time span, the terminal apparatus 2 presents recommendation recipe information and the like. Furthermore, it is desirable that during the night hours, the terminal apparatus 2 presents a recommendation program (content) information.

Furthermore, it is desirable that the terminal apparatus 2 causes recommendation information on a user's holiday and recommendation information on a user's working day to be differentiated from each other. At this point, based on a history of operation of equipment, the frequency of whose use is high, such as the television set, the history of the viewing, or the like, the terminal apparatus 2 can estimate a day when the user is more likely to stay in the house, a day when the user returns home at the regular time, and the like.

For example, the terminal apparatus 2 performs a clustering process on viewing patterns of the television viewing by the user, and compares a typical viewing pattern with teacher data (data that has a viewing pattern of a person whose working day and holiday day are already known). Accordingly, the terminal apparatus 2 can determine a day when the user does not work, a day when the user works, or the like.

Furthermore, the terminal apparatus 2 may change the recommendation information according to a month or a year. For example, in November, the terminal apparatus 2 may display not only information which recommends hot pot dish cooking, but may also display recommendation information that is linked to a webpage which introduces a pot recipe. Furthermore, the terminal apparatus 2 may change the recommendation information according to a point in time. For example, when determining the recommendation information that is to be displayed, the terminal apparatus 2 may raise a priority level of the content that the user has viewed during the same time span.

(Case where a Plurality of Users are Present)

With a configuration in which the terminal apparatus 2 identifies (face recognition) the user with a camera, the terminal apparatus 2 can specify a plurality of faces (a plurality of users). In a case where a plurality of users performs operations, it is desirable that in addition to the historical information on the operation by each user, the terminal apparatus 2 stores pieces of historical information on the operation by a plurality of users as well. With this configuration, the terminal apparatus 2 can determine the recommendation information based on the pieces of historical information on the operation by the plurality of users. It is noted that the terminal apparatus 2 can specify the user based on user's voice.

Alternatively, the terminal apparatus 2 selects a class to which the user belongs, using a general clustering method, and thus may distinguish a plurality of users. This configuration has an advantage in that individual data of the user does not need to be registered in advance.

Furthermore, the terminal apparatus 2 may change the recommendation information according to a time span. For example, during a midday time span, the terminal apparatus 2 presents a program dedicated for a baby, as the recommendation program, considering the likelihood that a family (a plurality of users) that includes a baby will view content. On the other hand, during the midnight time span, the terminal apparatus 2 may present the recommendation program in accordance with the identified user.

(Presentation of the Recommendation Information by Speech)

In a case where the recommendation information, such as the weather forecast, the news, or the traffic information, is selected, the terminal apparatus 2 may read these pieces of information in speech. Equipment that performs speech synthesis may be the terminal apparatus 2, and may be another apparatus.

(Time Span during which the Recommendation Information is Displayed)

It is desirable that a time span during which the terminal apparatus 2 presents the recommendation information is adjustable. The user may set the time span, and the system (the terminal apparatus 2 or the server 1) may set the time span. For example, it is considered that the user sleeps in the middle of the night. For this reason, it is desirable that the terminal apparatus 2 does not post the recommendation information during a time span in the middle of the night. Furthermore, the terminal apparatus 2 may estimate a time span during which the user uses the terminal apparatus 2, based on the history of the operation by the user, and may present the recommendation information during the estimated time span or a time span near the estimated time span.

(Setting of the Tendency of the Recommendation Information and Setting of a Character)

It is desirable that the terminal apparatus 2 possibly sets the tendency of the recommendation information. For example, the tendencies may include dedication for more of animation, dedication for children, and dedication for adults. Furthermore, the terminal apparatus 2 may display a character (for example, an avatar character) in accordance with the tendency of the recommendation information. Furthermore, in this case, the recommendation information may be output in a mode or speech in accordance with the displayed character.

(Relationship with Another Item of Equipment)

It is desirable that the terminal apparatus 2 displays the recommendation information on another item of equipment (for example, a smartphone) that is owned by the user, depending on the time span. For example, the terminal apparatus 2 transmits the recommendation recipe information and the recommendation program information to the smartphone during the time from 17:00 pm to 18:00 pm. Accordingly, the user checks the recommendation information that is displayed on the smartphone, on the way from the company, and thus can a dish for dinner or can make a reservation for a program in the night. It is noted that it is desirable that the terminal apparatus 2 switched an output destination of the recommendation information according to the tendency of the recommendation information. For example, it is desirable that the terminal apparatus 2 posts the recommendation information for all family members on the family bulletin board, and on the other hand, posts the recommendation information for one family member on the SNS that is used by the one family member. Notably, it is desirable that it is possible that from the smartphone as the terminal apparatus 2, a reservation is made for video-recording the recommendation program, or operation control (for example, turning-on and turning-off control of an air-conditioner) of another item of equipment is performed.

In a case where the terminal apparatus 2 is a television set, when a person (a child) is detected and the recommendation information is displayed, the terminal apparatus 2, for example, may transmit the notification that the recommendation information is displayed, to a portable telephone of the child's mother. With this configuration, the mother can know that the child came home from school. Moreover, with this configuration, an image of the child that is captured by the terminal apparatus 2 may be displayed on the mother's portable telephone according to operation of the portable telephone by the mother.

In a case where the same user uses a plurality of terminal apparatuses 2 (for example, a television set or a portable telephone), these terminal apparatuses 2 may determine the recommendation information using all pieces of historical information on the use of, and the historical information on the operating, of each of terminal apparatuses 2. Accordingly, the recommendation information can be presented that is consistent with the preference of the user.

(Presentation of the Recommendation Information While Content is Viewing)

Basically, when the user is detected and the switching to the turning-on of the display takes place, the terminal apparatus 2 presents the recommendation information. However, in a case where the recommendation information that is useful to the user is present, or in a case where, although the user is viewing content, the user wants to check the recommendation information, the terminal apparatus 2 may present the recommendation information according to the operation by the remote controller, the gesture operation, or speech input. For example, the terminal apparatus 2 may display the recommendation information in such a manner that the recommendation information is superimposed on the content that is being displayed, and may display the recommendation information in such a manner that the display of the content is temporarily reduced. It is noted that, in a case where the terminal apparatus 2 has urgent recommendation information, the terminal apparatus 2, although the user is viewing content, it is desirable that the urgent recommendation information is presented. For example, the announcement of a warning and the issuance of an evacuation advisory and the like are included in the urgent recommendation information. Furthermore, in a case where the user participates in an auction, another persons' bid price exceeds than the user's bid price may be included in the urgent recommendation information.

(Setting of a Distance within which the User is Detected)

The terminal apparatus 2 may change a distance within which the user is detected, according to a size of a screen of the display unit 27. For example, it is considered that, in a case where the screen is large-sized, a room in which the terminal apparatus 2 is positioned is comparatively large-sized. For this reason, the terminal apparatus 2 increases the distance within which the user is detected. On the other hand, in a case where the screen is small, the terminal apparatus 2 decreases the distance within which the user is detected. Accordingly, only in a case where the user is present within the room in which the terminal apparatus 2 is positioned, the terminal apparatus 2 can detect the user and can present the recommendation information. In a case where the user is detected using the image capture unit 25, the terminal apparatus 2 may estimate the distance to the user, based on a size of a face in the captured image.

(Gesture Recognition)

It is desirable that the terminal apparatus 2 possibly recognizes a gesture in such a manner that the user can simply switch content. With this configuration, even in a case where the user does not retain the remote controller, the user can operate the terminal apparatus 2. It is noted that the terminal apparatus 2 may perform gesture recognition using a twin-lens camera, and may perform the gesture recognition using infrared light and an infrared light sensor. It is desirable that the terminal apparatus 2 possibly identifies a small movement of a destination of a user's fingertip.

It is desirable that the terminal apparatus 2 arranges tiles for pieces of recommendation information in a single row horizontally and vertically. With this configuration, the user can select the recommendation information with the intuitive and simple gesture operation that results from moving his/her finger or hand horizontally. Furthermore, from the perspective of the structure of the human body, when moving horizontally, the hand easily shakes vertically. However, in a case where the pieces of recommendation information are arranged in a single row, the recommendation information that is not intended due to this shaking is not selected.

(Learning of the Recommendation Information)

It is desirable that the terminal apparatus 2 utilizes user feedback in order to display the recommendation information suitable for the user. Specifically, the terminal apparatus 2 may raise a priority level of content that is similar to the content (the recommendation information) that was selected one or more times, and may add the similar content to the recommendation information. Furthermore, the terminal apparatus 2 may lower a priority level of content that is similar to the content that was not selected at all over a period of time or longer, and may delete the content that was not selected, from the recommendation information.

For example, the terminal apparatus 2 may store evaluation numerical values of each item of content that is included in the recommendation information and of a category of such an item of content, and may cause the evaluation numerical values to be decreased according the number of times that the content is selected. Furthermore, the terminal apparatus 2 may determine whether or not the content and items of content in the category of the content are included in the recommendation information, according to the evaluation numerical value of the content.

(Recommendation Information)

The recommendation information that is presented by the terminal apparatus 2 to the user may be information that is selected or generated in an arbitrary apparatus, such as the server 1 or the terminal apparatus 2, or an arbitrary service, that is, information that is recommended by an arbitrary apparatus or service to the user. For example, the recommendation information may be information indicating content of which viewing is recommended by the server 1 or the terminal apparatus 2, or an external server to the user, and may be information on the Internet, in which the user has an interest, such as weather information or news.

Furthermore, a data format of the recommendation information and a mode in which the recommendation information is presented to the user are not particularly limited. For example, the recommendation information may be text data, image data, speech data, or a combination of these. Then, the recommendation information that is text data, for example, can be presented to the user in the form of display output, speech output, printing output, or a combination of these. Furthermore, the recommendation information that is image data can be presented to the user in the form of display output, printing output, or a combination of these, and the recommendation information that is speech data can be presented to the user in the form of speech output.

(Format)

In the examples described above, the configuration in which the display layout is selected is described as an example in which a format in which the recommendation information is output is selected from among a plurality of formats. However, the format that is a target for selection is not limited to the display layout. It is noted that the format is information indicating an output format or an output mode of the recommendation information. For example, in a case where the recommendation information that is text data is output, a typeface of text may be set to be the format described above. Furthermore, for example, in a case where the recommendation information that is speech data is output in speech, a volume of sound, a musical interval, a tone, and a tempo (speed) may be the formats described above. With these configurations, for example, the recommendation information can be presented to the user in a mode to user's liking and in accordance with the details of the recommendation information, and the like.

Furthermore, the format described above may be information that indicates to which apparatus the recommendation information is output. For example, a format that designates a television set as output equipment, and a format that designates a portable terminal apparatus as the output equipment may be prepared in advance, and any of the formats may be selected according to the details of the recommendation information. Accordingly, for example, the recommendation information on a movie that is encouraged to be viewed with the television set can be caused to be output to the television set and the recommendation information that the user checks with his/her hand, such as the recipe information can be caused to be output to the portable terminal apparatus 2.

### Embodiment 2

In the embodiment, the example in which the server 1 generates the recommendation information and the layout information is selected is described, but a configuration in which the terminal apparatus 2 performs at least one of the generation of the recommendation information and the selection of the layout information may be set to be employed. More precisely, the terminal apparatus 2 may include a format selection unit that selects the format in which the recommendation information is output, from among a plurality of formats, and a recommendation information generation unit that generates the recommendation information.

Furthermore, various pieces of information that are used for the generation of the recommendation information may be acquired from the server 1 or an external server, and, if they are pieces of information that can be stored in the terminal apparatus 2, may be stored in the terminal apparatus 2. The same is also true for the layout information. The layout information may be stored in advance in the terminal apparatus 2, and may be acquired from the server 1 or the external server. The point is that a plurality of pieces of layout information that are selectable may be present when the recommendation screen is displayed.

Furthermore, in a case where the terminal apparatus 2 includes the recommendation information generation unit, the terminal apparatus 2 may further include an information acquisition unit that acquires various pieces of information that are used for the generation of the recommendation information. Then, the information acquisition unit may acquire at least one of the situation information that indicates the situation which results when the terminal apparatus 2 outputs the recommendation information, and historical information on operation of another item of equipment that is different from the terminal apparatus 2.

### Embodiment 3

In each of the embodiments described above, the example in which one server 1 is used is described, but each function that the server 1 has may be realized in an individual server. Furthermore, the server 1 or another server may be caused to perform at least one or several of the functions that the terminal apparatus 2 has. Then, in a case where a plurality of servers are applied, each server may be managed by the same business operator, and may be managed by different business operators, respectively.

### Embodiment 4

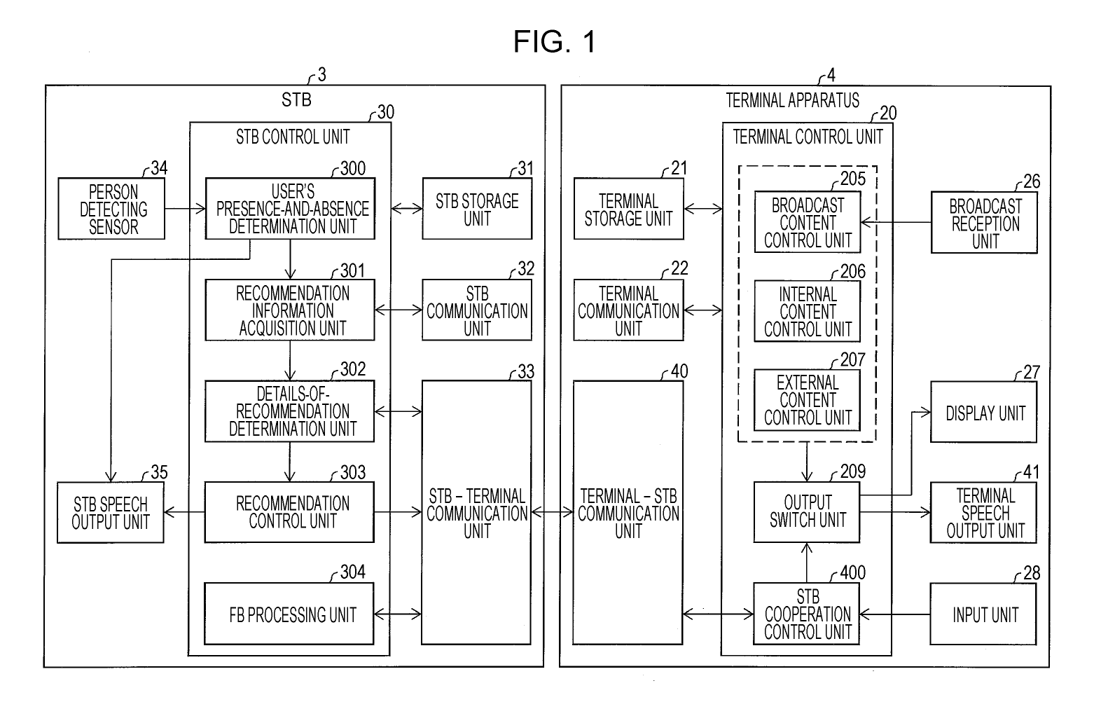

An embodiment of the present invention will be described with reference to FIGS. 1 and 25 to 32. It is noted that a constituent element that is the same as that in each of the embodiments described above is given the same reference numeral, and that a description thereof is omitted.

[Outline]

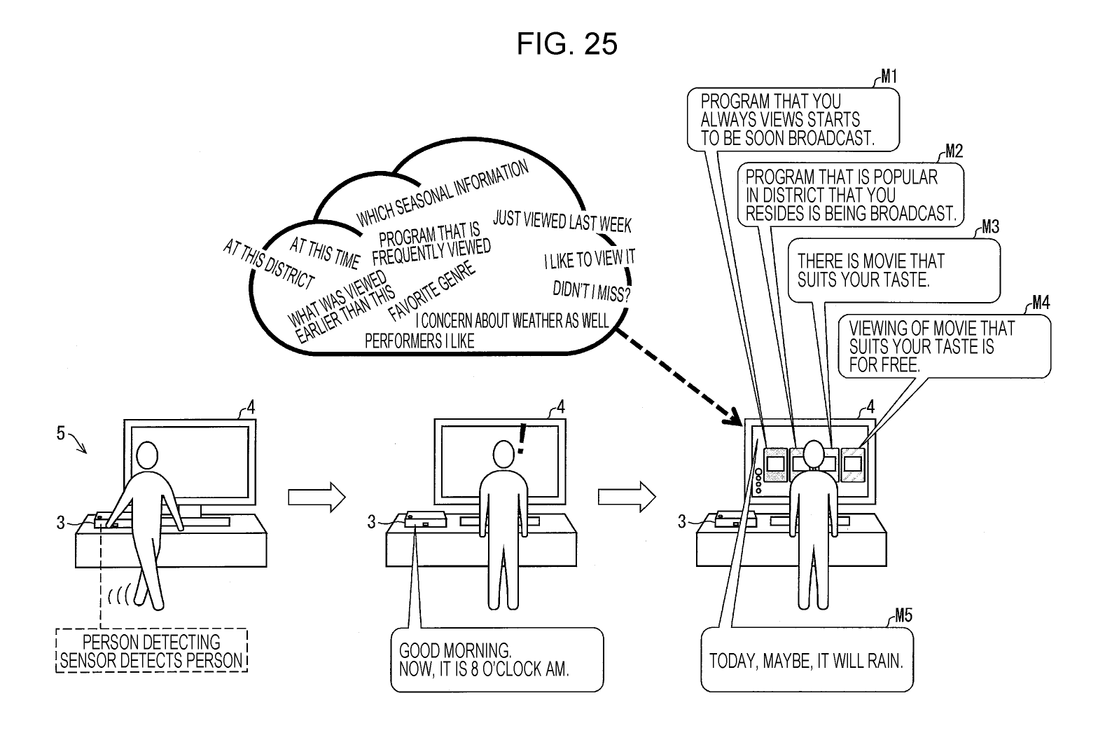

An overview of the recommending system 5 according to an embodiment of the present invention will be described with reference to FIG. 25. FIG. 25 is a diagram for describing operation of the recommending system 5 according to the present embodiment. As illustrated, the recommending system 5 includes a Set Top Box (STB) 3 (a control apparatus) and a terminal apparatus (a display apparatus) 4. The STB 3 is an apparatus that causes the terminal apparatus 4 to display the recommendation information on content. It is noted that in the present embodiment, the example in which the terminal apparatus 4 is a television receiver (hereinafter referred to as TV in some cases), but the terminal apparatus 4 is not limited to the television receiver. Furthermore, the STB 3 and the terminal apparatus 4 will be described in detail below.

In the recommending system 5 that is illustrated, the STB 3 detects the user with the person detecting sensor, and speech-produces the greeting expression to the detected user. Then, the STB 3 acquires the recommendation information from the server 1 that is not illustrated, and causes the terminal apparatus 4 to display the acquired recommendation information. Furthermore, the STB 3 causes the terminal apparatus 4 to perform speech production (referred to as the reason speech-production) of the reason for recommending the recommendation information, or the speech-production (referred to chatting speech-production) of details that is not related at least directly to the recommendation information. In FIG. 25, five messages M1 to M5 are illustrated. Among M1 to M5, M1 to M4 are for the reason speech-production, and M5 is for the chatting speech-production. The STB 3 causes the terminal apparatus 4 to speech-produce any of these messages.

[Recommendation Screen]

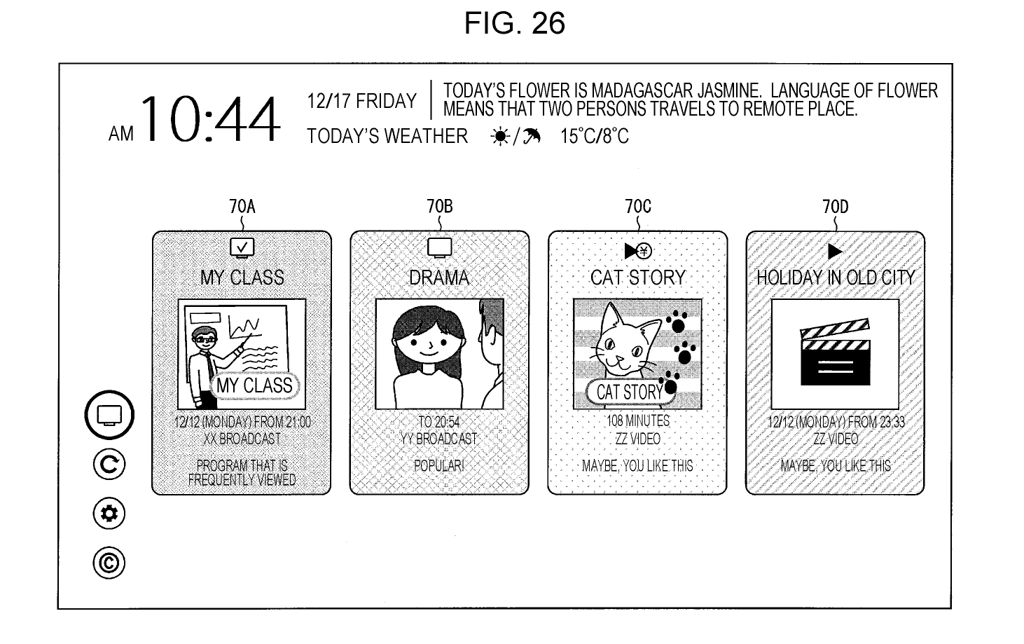

The recommendation screen that the STB 3 causes to be displayed will be described with reference to FIG. 26. FIG. 26 is a diagram illustrating an example of the recommendation screen. In an example that is illustrated, four rectangles that are the same as the shapes of the tiles 60 that are described in the embodiment 1 are arranged in a single row in the vicinity of the center of a screen. In the present embodiment, these rectangles are referred to as cards 70A to 70D, respectively. It is noted that the cards are referred to as the card 70, the cards 70A to 70D do not need to be distinguished from each other. It is noted that information that is included in the card 70 will be described in detail below.

The cards 70 that are arranged on the recommendation screen are selectable with the input operation by the user. In other words, each card 70 is an object for causing content, which is recommended in each card 70, to be selected. As illustrated, in a case where the card 70 is for recommending content such as the broadcast content or the Internet content, the STB 3 causes the terminal apparatus 4 to display the content according to the input operation described above or causes the terminal apparatus 4 to perform content viewing reservation or content recording reservation. It is noted that the input operation is not particularly limited. For example, any of the cards 70A to 70D may be selected according to which of color buttons (prescribed selection keys) of the remote controller (a remote control device) for the terminal apparatus 4 is held down by the user. In the case of this example, as illustrated, colors of the cards 70A to 70D are different from each other. Thus, it is preferable that a combination of these colors is consistent with a color of the color button in question. Furthermore, it is preferable that order in which color buttons are arranged in a row is consistent with order in which the cards 70A to 70D are arranged in a row. Accordingly, the user can easily understand an association between the card 70 and the color button.

Furthermore, as illustrated, a recommendation screen may include information other than the card 70. The information is not particularly limited, and for example, may be information that is displayed in the vicinity of the upper side of the recommendation screen that is illustrated. The information is a current point in time, a current date and day, a today's weather (weather forecast), a today′ highest temperature and lowest temperature, or information on a today's flower (a message that is associated with a current date). These pieces of information are periodically acquired by the STB 3 from the server, and are updated.

Furthermore, four icons are vertically displayed in a column in the vicinity of the lower left side of the recommendation screen that is illustrated. When the icon is selected with the input operation by the user, the STB 3 and the terminal apparatus 4 performs processing in accordance with the icon.

The uppermost icon is an object for causing the terminal apparatus 4 to end the display of the recommendation screen and thus to start to display the broadcast content. In a case where this icon is selected, the STB 3 causes the terminal apparatus 4 to display the broadcast content instead of the recommendation screen. More precisely, the terminal apparatus 4 is caused to perform output switching from external output (output of the STB 3) to internal output (output of the terminal apparatus 4).

Furthermore, the second uppermost icon is an object for causing to the card 70 that is positioned on the recommendation screen to be updated. In a case where this icon is selected, the STB 3 performs update of the card 70. More specifically, new four cards 70 are caused to be horizontally in a row in the vicinity of the center of the screen. It is noted that in a case where the number of cards 70 that are possibly displayed is smaller than 4, the number of the cards 70 that are caused to be displayed may be equal to or smaller than 3. It is noted that the second uppermost icon is successively selected a prescribed number of times, because it is considered that the user searches for content that the user wants to view, the number of the cards 70 may be increased to 5 or greater.

Furthermore, the third uppermost icon is an object for causing the user to perform setting of the recommendation screen. In a case where this icon is selected, the STB 3 causes the terminal apparatus 4 to display a setting screen for performing the setting of the recommendation screen, instead of the recommendation screen.

Furthermore, the lowest icon is an object for causing information on the relations of right to be displayed. In a case where this icon is selected, the STB 3 causes the terminal apparatus 4 to display a screen for presenting information relating to the right to each item of content that is displayed on the recommendation screen as the card 70, instead of the recommendation screen. It is noted that processing in a case where an icon displayed on the recommendation screen and where the icon is selected by the user is not limited to the example described above.

[Outline of the Recommending System 5]

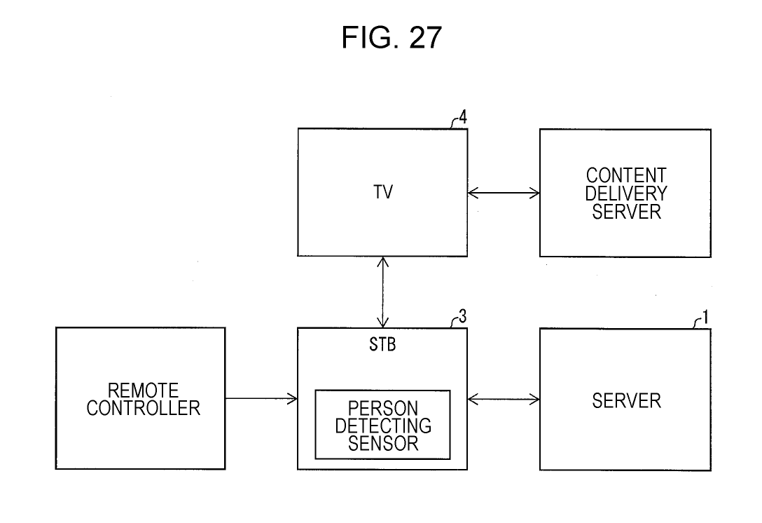

Next, an outline of the recommending system 5 according to the present embodiment will be described with reference to FIG. 27. FIG. 27 is a block diagram illustrating an outline of the recommending system 5 according to the present embodiment. As illustrated, the recommending system 5 according to the present embodiment includes the server 1, the STB 3, a TV (the terminal apparatus 4), a content delivery server, and a remote controller.

The server 1 according to the present embodiment is different from the server 1 that is described in the embodiment 1, and the recommendation information that is generated based on the history of the viewing by the user, to the STB 3 instead of the terminal apparatus. Furthermore, in a case where the number of types of display layouts for the recommendation information is 1 (for example, in a case where only the display layout for the recommendation screen that is illustrated in FIG. 26 is present), the server 1 according to the present embodiment may not transmit the layout information to the STB 3. It is noted that each function that the server 1 has may be realized in an individual server.

The STB 3 receives the recommendation information that is transmitted by the server 1, generates the recommendation screen (refer to FIG. 26), and causes the TV (the terminal apparatus 4) to display the generated recommendation screen. Furthermore, the STB 3, as described above, causes the terminal apparatus 4 to perform the display of the content (the broadcast content or the external content) that is selected from the recommendation screen, the viewing reservation for the broadcast content, and the like. Furthermore, the STB 3, as described above, includes the person detecting sensor, and speech-produces the greeting expression to the detected user.

The TV is the terminal apparatus 4 described above. In addition to a function of displaying the broadcast content, which a general TV has, the terminal apparatus 4 has a function of acquiring and displaying the external content (the Internet content that is delivered through the Internet, or the like). Accordingly, the terminal apparatus 4 can display the external content that is selected from the recommendation screen.

The memory that is illustrated is the same as the memory in the related art. It is noted that in FIG. 27, an arrow is illustrated in such a manner that the STB 3 directly receives a signal that is output by the remote controller, but that in a case where the remote controller for the terminal apparatus 4 is used, the signal that is output from the remote controller is received by the terminal apparatus 4. Then, the terminal apparatus 4 transfers the signal described above, which is received, to the STB 3, and thus, the STB 3 recognizes details of operation by the remote controller. For example, in a state where the recommendation screen is displayed, in a case where the terminal apparatus 4 acquires a signal indicating which one of the color buttons of the remote controller is held down, the terminal apparatus 4 transmits the signal to the STB 3. As described above, because the color button corresponds to the card 70, the STB 3 can specify which card 70 is selected, with the signal described above.

Of course, the STB 3 may be set in such a manner that the STB 3 can be operated directly in the remote controller (the remote control device). In this case, it is preferable that color buttons with four different colors are also provided in the remote controller and the card 70 with a color in accordance with each color button can be selected.

The content delivery server transmits the external content to the terminal apparatus 4. It is noted that a plurality of content delivery servers may be available.

[Flow from Generation of the Card to the Display of the Card]

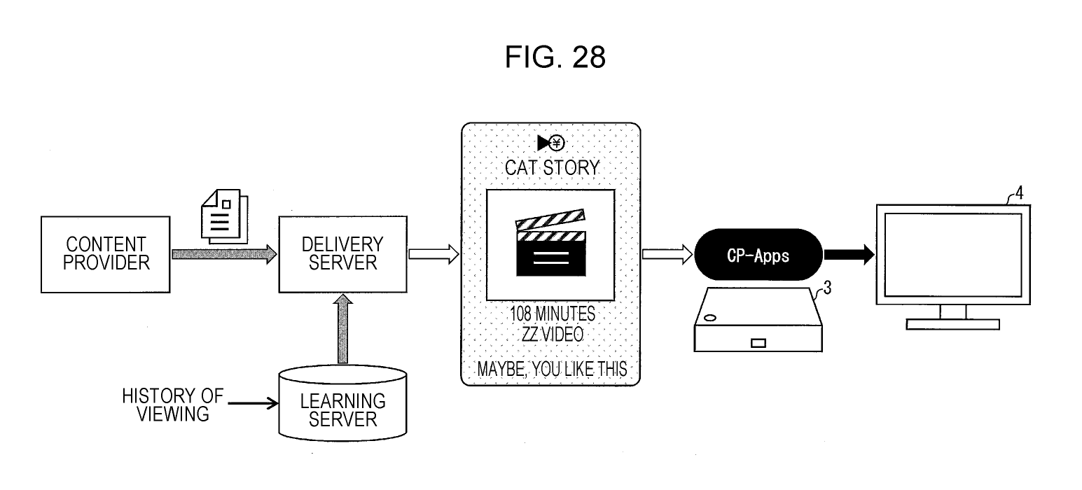

Next, a flow from the generation of the card to the display of the card will be described with reference to FIG. 28. FIG. 28 is a diagram illustrating the flow from the generation of the card to the display of the card. A learning server acquires a history of viewing of the content in the terminal apparatus 4 from the STB 3 or the terminal apparatus 4, and records the acquired history of viewing of the content as the history of viewing in the STB 3 or the terminal apparatus 4. It is noted that in a case where the identification of the user who viewed the content is performed, the acquired history of viewing of the content may be recorded as the history of viewing by the user.

The delivery server acquires meta information that is a source of the card 70, from s content provider. Furthermore, on this occasion, intention information indicating an intention or a desire of the content provider, relating to the display of the card 70, may also be acquired. The intention information, for example, may be information indicating the display and non-display of, or a display expiration date, of a thumbnail image, a priority level, or the like.

Then, the delivery server determines the card 70 that has to cause the terminal apparatus 4 to display, from the meta information and the history of viewing, which are described above, and transmits the determined card 70 to the STB 3. In this manner, the delivery server determines the card 70, and thus can present to the user pieces of recommendation information on items of content that are provided by various content providers, in a single format such as the card 70. More precisely, the delivery server provides a platform that can perform recommendation on content regardless of the content provider.

Then, the STB 3 causes the terminal apparatus 4 to display the received card 70. At this time, the STB 3 may change display details of the card 70 based on the intention information on the card 70, and so forth. It is noted that processing by the STB 3 on this occasion may be performed by installing application software (CP-Apps) of the content provider on the STB 3.

[Processing that is Performed by the Server]

Functions of the learning server and the delivery server, which are described above, can be realized in one server 1 that is illustrated in FIG. 2. This will be described with reference to FIG. 2.

The information management unit 103 performs the acquisition and the video recording of the history of viewing of the content in the terminal apparatus 4. It is noted that the history of viewing may be acquired directly from the terminal apparatus 4 and may be acquired through the STB 3. The acquired history of viewing is stored in the history DB 111, in a state of being associated with the equipment ID of the terminal apparatus 4.

The recommendation information generation unit 102 generates the recommendation information that is associated with various pieces of data and the intention information which are necessary to display the card 70. One piece of recommendation information is generated for one item of content that is recommended, and thus, one card 70 is displayed for one item of content. The generation of the recommendation information will be described below.

First, the recommendation information generation unit 102 determines content that is recommended with three methods that will be described below. It is preferable that a plurality of items of content according to each method are determined in such a manner that items of content that are recommended are not one-sided. It is noted that a method of determining content that is recommended is not particularly limited, and for example, the content that is recommended may be determined in the method as in the embodiments described above.

(1) Recommendation that is based on the history of viewing

(2) Recommendation from the external service

(3) Recommendation that is based on ranking

(1) described above defines that in the terminal apparatus 4, content that is frequently viewed, content that belongs to a genre that is frequently viewed, or content in which a performer who appears in all items of content that is frequently viewed appears is set to be the recommendation content. Furthermore, (2) described defines that content that is designated by the content provider, or content that ranks high in the number of times of viewing or the number of video recording or viewing reservations in the content provider is set to be the recommendation content. Then, (3) described above defines that content that has a high viewing rate or the great number of viewers at that point of time is set to be the recommendation content.

Next, the recommendation information generation unit 102 acquires intention information and meta information on the content that is recommended, from the content provider that provides the recommended content, and the like. Furthermore, the recommendation information generation unit 102 acquires a message for the reason speech-production in accordance with the reason for the recommendation of content. It is noted that it is preferable that, although the reasons for the recommendation are the same, the message for the reason speech-production is acquired from a plurality of types (for example, four types). Messages may differ in the end of a word, a word that is used, and a pitch or a volume of voice. Accordingly, because the STB 3 increases a variation in voice that is output, there is an advantage in that the user does not lose interest. This message may be prepared in advance for every reason for the recommendation. It is noted that the message may be speech data and may be text data. However, in a case where the message is the text data, the STB 3 needs to include a function of reading the text data.

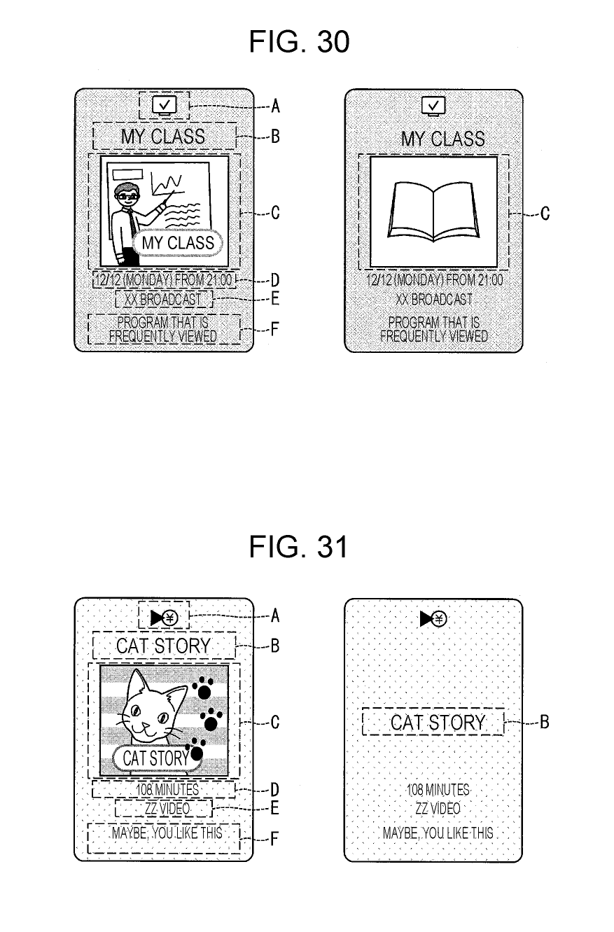

Moreover, the recommendation information generation unit 102 generates each item of data (which will be described in detail with reference to FIGS. 30 and 31) that has to be caused to be displayed on the card 70, from the acquired meta information. Then, the recommendation information that results from associating each generated or acquired item of data, which is described above, and the intention information with each other is generated in a manner that corresponds to one card 70.

The recommendation information that is generated by the recommendation information generation unit 102 is transmitted by the information transmission unit 105 to the STB 3. The recommendation information in a case where the content is the broadcast content may include, for example, the reason for recommending the content, the name of the broadcasting station, date and time for broadcasting, the tile for the content, and details of the content. Furthermore, in a case where the content is the external content, the name of the broadcasting station, which is described above, and the data and time for broadcasting may be changed in the name of the content provider and the reproduction time, respectively. It is noted that it is preferable that the number of pieces of recommendation information, that is, the number of cards 70 is set to 5 or greater. Accordingly, there occurs room for selecting the card 70 that, on the STB 3 side, is caused to be displayed.

Furthermore, the recommendation information generation unit 102 acquires a message for the chatting speech-production (M5 in FIG. 25), and the information transmission unit 105 transmits the message to the STB 3 as well. It is preferable that in order for the user to lose interest, a plurality of types of messages for the chatting speech-production are transmitted. Details of the message are not particularly limited, and for example, a message relating to weather, a message relating to a time span, a message relating to entire content, a message relating to news, and the like are given. It is noted that the message that is stored in advance may be acquired as the message for the chatting speech-production, and the recommendation information generation unit 102 may generate the message for the chatting speech-production. In a case where the message for the chatting speech-production is generated, the message for the chatting speech-production may be generated from information that is acquired from an external server (for example, a server that manages weather forecast information), and an audio format (not illustrated) that is stored in the server storage unit 11.

It is noted that the recommendation information generation unit 102 may generate the card 70 as the recommendation information, that the layout selection unit 104 may generate the recommendation screen on which the card 70 is positioned at a layout as illustrated in FIG. 26, and that the information transmission unit 105 may transmit the generated recommendation screen to the STB 3. In this case, the STB 3 may cause the terminal apparatus 4 to display the received recommendation screen, as is.

[Main Configuration of the STB]

A main configuration of the STB 3 will be described with reference to FIG. 1. FIG. 1 is a block diagram illustrating an example of configurations of the constituents of the STB 3 and the terminal apparatus 4. As illustrated, the STB 3 includes an STB control unit 30, an STB storage unit 31, an STB communication unit 32, an STB-terminal communication unit 33, a person detecting sensor 34, and an STB speech output unit (a first speech output unit) 35. Furthermore, the STB control unit 30 includes a user's presence-and-absence determination unit (a user detection unit or a speech output control unit) 300, a recommendation information acquisition unit 301, a details-of-recommendation determination unit (a message selection unit or a details-of-recommendation changing unit) 302, a recommendation control unit (a speech output control unit) 303, and an FB processing unit (a result-of-selection notification unit) 304. It is noted that because the person detecting sensor 34 is the same as the person detecting sensor 24 in FIG. 3, a description thereof is omitted.

The STB control unit 30 controls each unit of the STB 3 in an integrated manner. Various pieces of data that are used by the STB 3 are stored in the STB storage unit 31. Furthermore, through the STB communication unit 32, the STB 3 communicates with an external apparatus (for example, the server 1), and through the STB-terminal communication unit 33, the STB 3 communicates with the terminal apparatus 4. It is noted that a scheme for communication between the STB 3 and the terminal apparatus 4 is not particularly limited, but that an example in which a wired connection in compliance with HDMI (a registered trademark) is made is described. Then, the STB speech output unit 35 outputs speech under the control of the STB control unit 30.

The user's presence-and-absence determination unit 300 detects the user in the vicinity of the STB 3 and cause the STB 3 to be activated (causes the terminal apparatus 4 to transition to a state where an image is possibly output. Furthermore, according to the detection of the user, the user's presence-and-absence determination unit 300 causes the STB speech output unit 35 to output a message destined for the user in speech.

The recommendation information acquisition unit 301 acquires the recommendation information from the server 1, that is, information that results from associating various pieces of data necessary for displaying the card 70 and the intention information with each other. Furthermore, the recommendation information acquisition unit 301 acquires the message for the reason speech-production and the message for the chatting speech-production from the server 1 as well.

The details-of-recommendation determination unit 302 determines the recommendation information that the terminal apparatus 4 is caused to display. On this occasion, it is preferable that the details-of-recommendation determination unit 302 does not set the broadcast content, the broadcast time for which is a prescribed time or shorter (two thirds of the broadcast time has elapsed and so forth), to be the recommendation information that the terminal apparatus 4 is caused to display. It is noted that the “prescribed time” described above may be a time that is determined according to a length of the broadcast time for the broadcast content that is recommended, as in the example described above, and for example, may be a fixed time such as 10 minutes. Furthermore, it is preferable that regarding the broadcast content immediately before the broadcast starts (for example, 5 minutes before the broadcast starts, and so forth), the recommendation information that recommends the video recording reservation for the broadcast content is not set to be the recommendation information that the terminal apparatus 4 is caused to display. Accordingly, a situation where the recommendation information is selected, but the recommended content cannot be video-recorded from the beginning thereof can be prevented.

It is noted that the details-of-recommendation determination unit 302 may determine the recommendation information that the terminal apparatus 4 is caused to display, according to at least one of the terminal apparatus 4 and the user of the terminal apparatus 4. For example, the terminal apparatus 4 through which a user subject to an age restriction views content may not be caused to display the recommendation information on the content on which the age restriction is imposed. Furthermore, a setting may be performed in such a manner that the user sets which content the recommendation information that is caused to be displayed (or is not caused to be displayed) relates to. In this case, the details-of-recommendation determination unit 302 selects the recommendation information according to a user's setting. In this manner, the setting is performed in such a manner that a selection reference point for the recommendation information is possibly set, in the user-owned STB 3 side, instead of the server 1 side. Thus, it is possible that the server 1 transmits at a time the recommendation information that is common to a plurality of STBs 3. As a result, efficient transmission is possible. Furthermore, the STB 3 completed the reception of the recommendation information from the server 1, but does not have to display due to the selection reference point. Because of this, if the selection reference point is changed, the recommendation information can be caused to be displayed without having access to the server 1.

Moreover, the details-of-recommendation determination unit 302 changes display details of the recommendation information according to a timing at which the recommendation information is caused to be displayed. Specifically, in a case where a thumbnail image of content is included in the recommendation information, the details-of-recommendation determination unit 302 determines whether or not information that approves display of the thumbnail image, as the intention information. Then, in a case where it is determined that such information is included, the thumbnail image is determined as being displayed, and in a case where it is determined that such information is not included, the thumbnail image is determined as not being displayed. It is noted that, in a case where information indicating a period of time during which the display of the thumbnail image is approved is included in the intention information, the details-of-recommendation determination unit 302 determines whether or not a current point in time is within the period of time, and, if not, determines that the thumbnail image is not displayed. In a case where the thumbnail image is not displayed, the details-of-recommendation determination unit 302 may set an image display area to be a blank space, and may display an image (a genre icon that will be described below) indicating a genre of content that is recommended, on the image display area.

Furthermore, in a case where priority levels are set for a plurality of pieces of recommendation information, respectively, that are acquired by the recommendation information acquisition unit 301, the details-of-recommendation determination unit 302 determines the pieces of recommendation information that are caused to be displayed, according to their respective priority levels. Information indicating the priority level of the recommendation information may be included, for example, in the intention information. Then, in a case where indispensable recommendation information, which includes display-indispensable information indicating that the display is indispensable, is included in the recommendation information that is acquired by the recommendation information acquisition unit 301, the details-of-recommendation determination unit 302 causes the indispensable recommendation information to be displayed regardless of the priority level described above. The display-indispensable information may also be included in the intention information. In this case, the display of the recommendation information can be controlled on the content provider side. More precisely, the content provider includes the display-indispensable information or a high-priority-level setting in the intention information, and thus it is possible that the recommendation information on specific content is caused to be necessarily displayed or to be displayed with high probability.

Moreover, the details-of-recommendation determination unit 302 selects a message from among a plurality of messages including a message relating to the recommendation information and a message that is not associated at least directly with the recommendation information. Specifically, the details-of-recommendation determination unit 302 selects a message that causes the terminal apparatus 4 to perform the speech production, from among a plurality of messages including a message for the reason speech-production that corresponds to each of the cards 70 that is caused to be displayed and a message for the chatting speech-production that is received by the server 1.

The recommendation control unit 303 causes the terminal apparatus 4 to output the recommendation information that is determined by the details-of-recommendation determination unit 302. It is noted that in a case where content relating to the recommendation information that is caused to be displayed is the broadcast content, when the broadcast time for the content is a prescribed time or shorter, the recommendation control unit 303 causes the display of the recommendation information to be ended. In this case, the recommendation information on the broadcast content, the broadcast time for which is longer than the prescribed time, or the recommendation information on the external content or the like may continue to be displayed, and new recommendation information may be added instead of the recommendation information, the display of which is caused to be ended. In a case where the new recommendation information is added, it is preferable that recommendation information (for example, recommendation information that is recommended for the same reason, or recommendation information that recommends viewing of the broadcast content) that is associated with the recommendation information, the display of which is caused to be ended, is added. Furthermore, all pieces of recommendation information may be updated.

Furthermore, the recommendation control unit 303 causes the terminal apparatus 4 to output the message (the message for the reason speech-production or the chatting speech-production) that is selected by the details-of-recommendation determination unit 302, in speech.

Moreover, the recommendation control unit 303 causes the terminal apparatus 4 to output the content relating to the recommendation information that is selected in the terminal apparatus 4. Specifically, in a state where the recommendation screen is displayed, when any of the color buttons with four different colors of the remote controller for the terminal apparatus 4 is held down, an STB cooperation control unit 400 of the terminal apparatus 4 transmits a signal that is indicated by the held-down button, to the STB 3. Then, the recommendation control unit 303 specifies the recommendation information that is selected from the signal described above, and instructs the terminal apparatus 4 to output content relating to the recommendation information.

The FB processing unit 304 specifies each of the recommendation information that is caused by the terminal apparatus 4 to be displayed and is selected, and the recommendation information that is caused by the terminal apparatus 4 to be displayed, but is not selected, and notifies a prescribed notification-destination apparatus of a result of the specification. Specifically, the result of the specification is notified to the server 1. The notified of the specification is acquired by the information management unit 103 of the server 1 and is recorded in the history DB 111. Specifically, the information management unit 103 records the content, the ID of the terminal apparatus 4 (along with the user ID in a case where the user can be identified) and the information indicating whether or not the recommendation information is selected, in a state of being associated with each other. Furthermore, the date and time when the content is recommended and the like may be recorded together. It is noted that, as in an example in FIG. 28, in a case where the delivery server and the learning server are separated from each other, the “prescribed notification-destination apparatus” described above is a server that determines the recommendation information that is provided to the STB 3, that is, a learning server.

This record is reflected in the generation of subsequent recommendation information by the recommendation information generation unit 102. More precisely, the recommendation information generation unit 102 determines that the content which is selected by the user is consistent with the preference of the user of the terminal apparatus 4. Then, content associated with the content, such as content that belongs to the same genre as the content, or content in which the same performer as in the content appears is preferentially set to be the recommendation information. Conversely, it is determined that the content which is not selected by the user is not consistent with the preference of the user of the terminal apparatus 4. Then, a priority level of content associated with the content, such as content that belongs to the same genre as the content, or content in which the same performer as in the content appears is set to be the recommendation information is lowered for the recommendation information.

However, although the recommendation information meets the preference of the user, because the recommendation information is not selected when the user does not have the time to view the content, and so forth, the recommendation information that is not selected may be evaluated as being midway between being consistent with the preference of the user and not being consistent with the preference of the user, instead of being evaluated as not being consistent with the preference of the user. Accordingly, it is possible that the content in question is recommended in preference to the content that is known not to meet the preference of the user, while decreasing the likelihood that the content in question will be recommended rather than the content that is known to meet the preference of the user.

It is noted that it is also considered that the recommendation information is selected and viewing of the content starts, but the viewing is ended without being viewed to the last. Particularly, in a case where the viewing time for content is short, there is a likelihood that the content will not meet the preference of the user. Then, the FB processing unit 304 measures the time it takes to view the content pertaining to the recommendation after the recommendation information is selected, and may notify the server 1 of the measured time. Accordingly, with a technique such as one of assigning a weighting depending on the viewing time, the server 1 can select the recommendation information on content that meets the preference of the user.

[Main Configuration of the Terminal Apparatus]

A main configuration of the terminal apparatus 4 will be described with reference to FIG. 1. The terminal apparatus 4 is different from the terminal apparatus 2 in FIG. 3 in that the terminal apparatus 4 includes a terminal-STB communication unit 40 and a terminal speech output unit (a second speech output unit) 41. Furthermore, the terminal apparatus 4 is also different from the terminal apparatus 2 in FIG. 3 in that the STB cooperation control unit 400 is included the terminal control unit 20. In the present embodiment, because the STB 3 performs processing operations, such as the detection of the user, the acquisition of the card 70, and the display control, it is possible that a configuration of the terminal apparatus 4 is set to be roughly the same as that a general TV set in the related art.

Through the terminal-STB communication unit 40, the terminal apparatus 4 communicates with the STB 3. As described above, at this point, an example in which communication is performed in compliance with HDMI (a registered trademark) will be described. Furthermore, the terminal speech output unit 41 outputs speech under the control of the terminal control unit 20.

The STB cooperation control unit 400 performs control that causes output of the terminal apparatus 4 to be switched under the control of the STB 3. Specifically, according to the reception of the recommendation screen and speech data for the reason speech-production or the chatting speech-production from the STB 3, the STB cooperation control unit 400 instructs the output switch unit 209, not only to switch an image that is caused to be output to the display unit 27, to the recommendation screen that is received from the STB 3, but also to output the speech data from the terminal speech output unit 41.

[Outline of Operation of each of the STB 3 and the Terminal Apparatus 4]

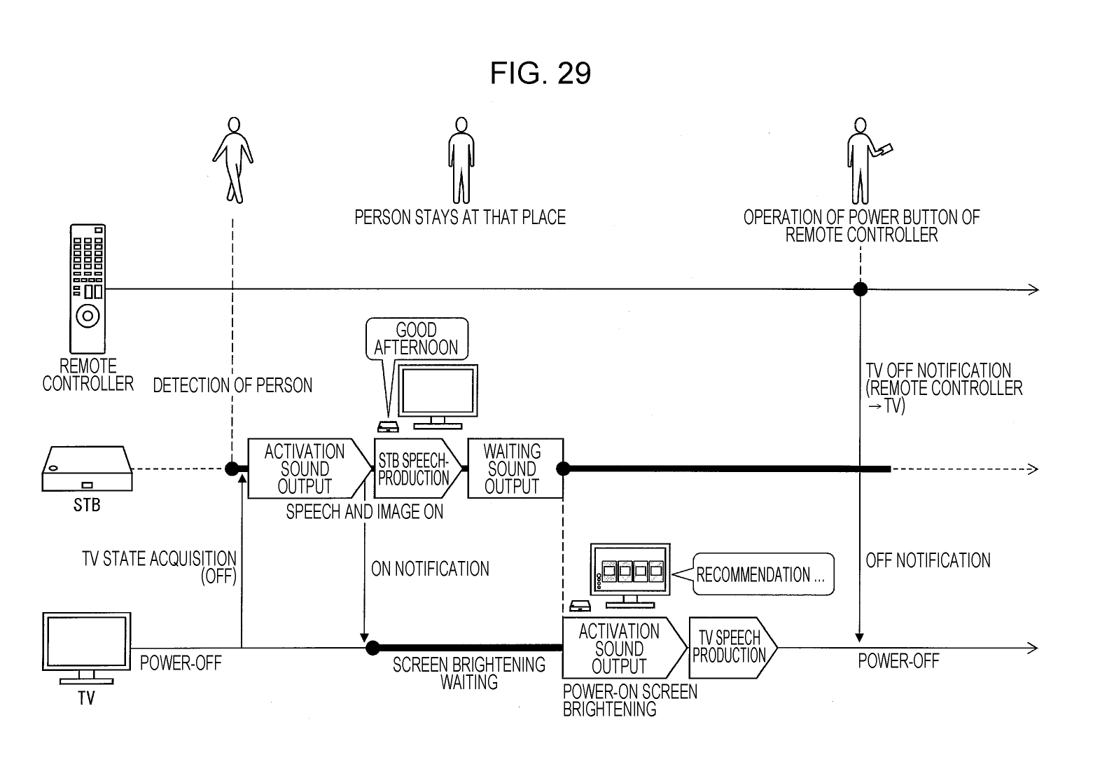

Next, an outline of operation of each of the STB 3 and the terminal apparatus 4 will be described with reference to FIG. 29. FIG. 29 is a diagram for describing the outline of the operation of each of the STB 3 and the terminal apparatus 4. As illustrated, when the user approaches the STB 3 and enters a detection range of the person detecting sensor 34, the STB 3 acquires an activation state of the terminal apparatus 4 (the TV set) (information indicating whether or not the terminal apparatus 4 is activated. At this point, when information indicating that the terminal apparatus 4 is not activated (is in an OFF state) is acquired, the STB 3 transmits an activation instruction (ON notification) to the terminal apparatus 4. At this time, after the STB 3 transmits the ON notification, a time lag of approximately 5 to 15 seconds from the transmission of the ON notification by the STB 3 to the availability of the screen display and the speech output by the terminal apparatus 4. For this reason, the STB 3 outputs activation sound, and subsequently, outputs a speech message containing a greeting (Good morning) to the user. Accordingly, the user can be kept staying before the terminal apparatus 4 until the screen display and the speech output by the terminal apparatus 4 are available.

It is noted that the greeting speech may be changed according to a time span. For example, the greeting speeches “Good morning”, “Good afternoon”, and “Good night” may be output in the morning, in the afternoon, and in the night, respectively. Furthermore, as illustrated, the STB 3 may output waiting sound from when the greeting speech is output to when the screen display and the speech output by the terminal apparatus 4 are available. In the case of this example, when the screen display and the speech output are available, the terminal apparatus 4 notifies the STB 3 of the availability of the screen display and the speech output. The STB 3 receives the notification, and stops the output of the waiting sound.

The terminal apparatus 4, as described above, performs the screen display in approximately 5 to 15 seconds after receiving the ON notification, and output speech. Specifically, the terminal apparatus 4 outputs the activation sound and displays the recommendation screen that is illustrated in FIG. 26. Then, the terminal apparatus 4 outputs any of the reason sound-production items M1 to M4, or the chatting speech-production M5 (refer to FIG. 25) in speech.

Thereafter, when the user holds down a power button of the remote controller, the terminal apparatus 4 enters an OFF state according to a signal from the remote controller. At this time, the terminal apparatus 4 transmits a notification (an OFF notification) indicating that the OFF state is entered, to the STB 3. Accordingly, the STB 3 can recognize that the terminal apparatus 4 enters the OFF state. It is noted that a method of causing the terminal apparatus 4 to enter the OFF state is not limited to this example. For example, when the user moves out of the detection range of the person detecting sensor 34, the terminal apparatus 4 may enter the OFF state. In the case of this example, when the STB 3 detects that the user moves out of the detection range of the person detecting sensor 34, the STB 3 transmits an ending instruction to the terminal apparatus 4. The terminal apparatus 4 not only enters the OFF state according to the ending instruction, but also transmits the OFF notification to the STB 3. Accordingly, the STB 3 can recognize that the terminal apparatus 4 enters the OFF state as instructed to do so.

[Detail of the Card 70 (in the Case of the Broadcast Content)]

Next, the card 70 for recommending the broadcast content to the user will be described in detail with reference to FIG. 30. FIG. 30 is a diagram illustrating an example of the card 70 for recommending the broadcast content to the user.

The card 70 includes an operation icon display area A, a title display area B, an image display area C, a time display area D, a provision source display area E, and a reason-for-recommendation display area F. Association information relating to content that is recommended is displayed on each of these areas. It is noted that the association information that is included in the card 70 is not limited to this example. As described above, the card 70 is generated by the STB 3 based on the recommendation information that is acquired from the server 1. More precisely, details that are included in the card 70 are all based on the recommendation information.

The operation icon that indicates an operation which is performed in the terminal apparatus 4 when the card 70 is selected is displayed on the operation icon display area A. The operation icon in an example that is illustrated indicates an operation of making reservation (the video recording reservation or the viewing reservation in a case where the terminal apparatus 4 has a video recording function, or the viewing reservation in a case where the terminal apparatus does not have the video recording function) for the broadcast content. The details-of-recommendation determination unit 302 determines whether or not the terminal apparatus 4 includes a video recording reservation function. If so, the details-of-recommendation determination unit 302 may display the operation icon indicating a view reservation operation. If not, the details-of-recommendation determination unit 302 may display the operation icon indicating a video recording reservation operation. It is noted that the operation icon of the card 70B in FIG. 26, which is described above, indicates an operation of starting to view broadcast content.

A title of the broadcast content that is set to be the recommendation target is displayed on the title display area B. Details of the broadcast content and the like may be displayed on the present display area. Furthermore, the name of the broadcasting station that broadcasts the broadcast content that is the recommendation target is displayed on the provision source display area E.

An image indicating content is displayed on the image display area C. In a case where a thumbnail image of the content is present, as illustrated on the left side of FIG. 30, the thumbnail image is displayed on the image display area C. On the other hand, in a case where the thumbnail image cannot be acquired, or in a case where the thumbnail image can be acquired but the intention information indicating approval to use the thumbnail cannot be acquired, as illustrated on the right side of FIG. 30, a genre icon indicating a genre of the content is displayed.

Broadcast date and time (time information) for the broadcast content that is the recommendation target is displayed on the time display area D. It is noted that, in a case where the broadcast content that is the recommendation target is not started at a point of time when the card 70 is displayed, as illustrated in an example in FIG. 30, a broadcast-start point in time (the time information) may be displayed, and display of a broadcast-end point in time may be omitted. On the other hand, in a case where the broadcast content that is the recommendation target is started at the point in time when the card 70 is displayed, as on the card 70B in FIG. 26, the broadcast-end point in time (the time information) may be displayed, and display of the broadcast-start point in time may be omitted. It is noted that in addition to these pieces of information, the time (a measurement) (the time information) from broadcast start and broadcast stop may be displayed.

The reason for the recommendation of content, in other words, a message indicating an item that serves a reference of selection of the broadcast content is displayed on the reason-for-recommendation display area F. For example, for the broadcast content that is selected based on the reference that requires high viewing frequency, the message “program that is frequently viewed” is displayed as illustrated. This message may be acquired by the server 1 and may be transmitted to the STB 3. The server 1 may notify the STB 3 of a selection reference point for a message, and the STB 3 may acquire a message in accordance with the selection reference point.

It is noted that, in a case where the operation icon, the message indicating the reason for the recommendation, and the name of the broadcasting station cannot be acquired, the STB 3 may keep the display areas A, E, and F blank without anything being displayed on them. On the other hand, in a case where the broadcast data and time and the title cannot be acquired, it is preferable that the STB 3 does not cause the card 70 to be displayed. This is because the card 70, although selected by the user, has the likelihood that the broadcast content will not be able to be output.

[Detail of the Card 70 (in the Case of the External Content)

Next, the card 70 for recommending the external content to the user will be described in detail with reference to FIG. 31. FIG. 31 is a diagram illustrating an example of the card 70 for recommending the external content to the user. In the card 70 for recommending the external content to the user, in the same manner as in the example in FIG. 30, the operation icon display area A, and the title display area B, the image display area C, and the time display area D, and the provision source display area E, and the reason-for-recommendation display area F are included.

In an example in FIG. 31, an icon indicating that when reproduction is performed, charging for the reproduction takes place (indicating fee-based content) is displayed on the operation icon display area A. For free-of-charge content, as is the case with the card 70D in FIG. 26, an icon indicating reproduction of content is displayed.

A title of content, a thumbnail image of content, the time taken for reproduction of content, a content provision source, and the reason for the recommendation are displayed on the title display area B, the image display area C, the time display area D, the provision source display area E, and the recommendation reason display area F, respectively. It is noted that “Maybe, you like this” is the reason for the recommendation that is displayed on content which is selected for the reason that such content belongs to the genre that has high frequency of viewing in the terminal apparatus 4.

In the same manner as in the example in FIG. 30, in a case where the thumbnail image cannot be acquired, or in a case where the thumbnail image can be acquired, but the intention information indicating the approval to use the thumbnail image cannot be acquired, the thumbnail image is not displayed on the image display area C. In this case, the genre icon as illustrated in FIG. 30 may be displayed, and, as illustrated in an example of the right side of FIG. 31, the image display area C may be kept blank. It is noted that, in the example in FIG. 31, when the image display area C is kept blank, the title display area B may be caused to be moved to the image display area C in such a manner that a large blank space does not occur in the vicinity of the center of the card 70. In this manner, in a case where one or several of the display areas are set to be kept blank, position of the other areas may be changed.

Furthermore, the external content may be content that has not yet been delivered. In this case, delivery date and time for content (the time information) may be displayed on the time display area D (refer to the card 70D in FIG. 26). In a case where the user selects the card 70 for the content that has not yet been delivered, a moving image for promotion of the content or a preview moving image may be reproduced, and a webpage for promotion of the content may be caused to be displayed. That is, instead of the content that is to be displayed on the card 70, another item of content that is associated with the content, which is prepared by the content provider, is caused to be displayed.

It is noted that, in a case where information cannot be acquired, a display area for the information is set to be kept blank, but that, in a case where, like a title of content, information that is indispensable for acquiring content cannot be acquired, it is preferable that the card 70 relating to this is not caused to be displayed. Accordingly, a situation where the content that is selected by the user is not displayed can be prevented.

[Flow for Processing (Display of the Recommendation Screen and the Selection of the Card 70)]

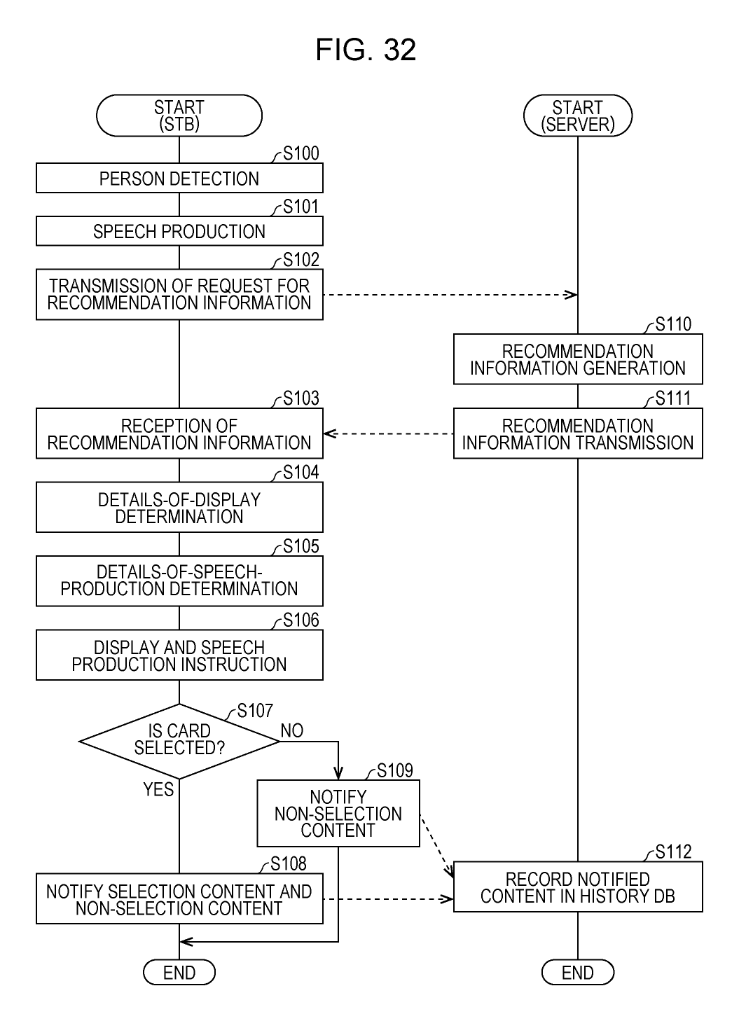

Next, a flow for processing (a control method in the control apparatus that performs control) relating to display of the recommendation screen and the selection of the card 70, which is performed by the STB 3, will be described with reference to FIG. 32. FIG. 32 is a flowchart illustrating the flow for the processing relating to the display of the recommendation screen and the selection of the card 70.

First, processing by the STB 3 will be described. When, from a result of the detection by the person detecting sensor 34, it is determined that a person (the user) is detected in the vicinity of the STB 3 (S100, that is, a user detection step), the user's presence-and-absence determination unit 300 causes the STB speech output unit 35 to speech-produce the greeting speech (S101, that is, a speech output control step). It is noted that the user's presence-and-absence determination unit 300 may cause the STB speech output unit 35 to output the activation sound before the greeting speech and may cause the STB speech output unit 35 to output waiting sound after the greeting speech (refer to FIG. 29).

Next, the recommendation information acquisition unit 301 transmits the request for the recommendation information to the server 1, along with the ID of the terminal apparatus 4 (S102). In this manner, by transmitting the ID of the terminal apparatus 4, the recommendation information that meets the preference of the user of the terminal apparatus 4 can be acquired. It is noted that, when the STB 3 is connected to another terminal apparatus, because an ID of the other terminal apparatus is transmitted, the recommendation information that meets a preference of a user of the other terminal apparatus.

Then, in response to the request for the recommendation information, the recommendation information acquisition unit 301 receives the recommendation information from the server 1 (S103), and details-of-recommendation determination unit 302 determines details that the terminal apparatus 4 is caused to display (S104). Specifically, the details-of-recommendation determination unit 302 determines four cards 70 that are caused to be displayed on the recommendation screen (refer to FIG. 26), from a plurality of pieces of recommendation information that are received, and generates the recommendation screen.

Next, the details-of-recommendation determination unit 302 determines details that is speech-produced by the terminal apparatus 4 (S105, that is, a message selection step). Specifically, the details-of-recommendation determination unit 302 selects one message that causes the terminal apparatus 4 to speech-produce (to output in speech), from among messages for the reason speech-production on the four cards 70 that are displayed on the recommendation screen and the message for the chatting speech-production.

The recommendation control unit 303 transmits the recommendation screen and speech data of the message that is caused to be speech-produced, through the STB-terminal communication unit 33 and instructs the terminal apparatus 4 to perform the display and the speech-production (S106, that is, a speech output control step and a recommendation control step). Accordingly, the STB cooperation control unit 400 of the terminal apparatus 4 instructs the output switch unit 209, not only to switch an image that is caused to be output to the display unit 27, to an image that is received from the STB 3, that is, the recommendation screen, but also to output the message from the terminal speech output unit 41. It is noted that, after the speech-production in S101, in a case where the STB speech output unit 35 is caused to output the waiting sound, the recommendation control unit 303 may instruct the STB speech output unit 35 to end the output of the waiting sound.

After the recommendation screen is caused to be displayed, the FB processing unit 304 enters a state of waiting for the card 70 to be selected (S107). In a case where the card 70 is selected (for example, in a case where a signal indicating that any of the color buttons of the remote controller is held down is received) (YES in S107), the FB processing unit 304 not only specifies the selected content, but also specifies content other than the selected content as non-selected content, and notifies the server 1 of results of the specification (S108).

On the other hand, in a case where the card 70 is not selected (for example, in a case where the signal indicating that the color button is held down is not received or a signal for setting the terminal apparatus 4 to enter the OFF state is received, from the STB cooperation control unit 400) (NO in S107), the FB processing unit 304 notifies the server 1 of items of content on all the cards 70 as items of non-selected content (S109). When all of this is performed as described above, the processing by the STB 3 is ended.

Subsequently, the processing by the server 1 is described. When receiving the request for the recommendation information that is transmitted from the STB 3, the recommendation information generation unit 102 generates the recommendation information (S110). Then, the information transmission unit 105 transmits the generated recommendation information to the STB 3 (S111). Furthermore, when the selected content and the non-selected content, or only the non-selected content is notified, the information management unit 103 records the notified content in the history DB 111 (S112). When all of this is performed as described above, the processing by the server 1 is ended.

### Modification Examples

The speech production for each card 70 may be the speech production for the message associated with the each card 70, that is, the recommendation information, and is not limited to the reason speech-production. For example, a message for performers in the content that is recommended, a title, a PR comment, or the like may be speech-produced.

In the embodiment 4 described above, the example in which the STB 3 and the terminal apparatus 4 display the recommendation information in cooperation with each other is described. However, although the STB 3 and the terminal apparatus 4 are integrated into a single apparatus in the same manner as in the embodiments 1 to 3, the same functions as in the embodiment 4 can be realized.

It is preferable that in the selection of the recommendation information (the card 70), basically, types of operation icons are set not to be one-sided impartial. Accordingly, an opportunity for the user to come in contact with various items of content can be provided. Furthermore, the recommendation information in accordance with the function of terminal apparatus 4 may be selected. For example, in a case where the terminal apparatus 4 supports 4K broadcast, the recommendation information on content for 4K may be preferentially selected.

Furthermore, in the embodiments described above, the example in which the terminal apparatus 4 is caused to perform reservation video recording is described, but in a case where video recording equipment is connected to the terminal apparatus 4, the video recording equipment may be caused to perform the reservation video recording. Furthermore, in a case where in this manner, the video recording is possible with a plurality of items of equipment, equipment that possibly performs video recording with higher image quality or equipment that supports a video-recordable recording medium which has a larger amount of free space may be caused to perform the reservation video recording. Furthermore, in this case, it is preferable that an action icon is also set to be able to cause external equipment to perform the reservation video recording.

Furthermore, in the embodiments described above, the STB 3 acquires only the recommendation information from the server 1, but may also be set to be able to cause the required recommendation information or the recommendation information that is displayed as the card 70, to be presented to another user. In this case, the server 1 groups a plurality of users that own the STB 3, in advance, for management. Then, according to the reception of a request for sharing the recommendation information from the STB 3 of a user who belongs to the group, the same recommendation information as that which is destined for the STB 3 that is a transmission source of the request is also transmitted to users other than the user, who belong the group. Accordingly, each user within the group can be provided with the same recommendation information, in the STB 3 of its own and the terminal apparatus 4.

[Example of Realization in Software]

Control logics (particularly, the server control unit 10, the terminal control unit 20, and the STB control unit 30) of the server 1, the terminal apparatus 2, and the STB 3 may be realized by a logical circuit (hardware) that is formed an integrated circuit (an IC chip) and the like, and may be realized in software that uses a Central Processing Unit (CPU).

In the case of the latter, the server 1, the terminal apparatus 2, and the STB 3 each include a CPU, which executes a command that is from a program that is software which realizes each function, a Read Only Memory (ROM) or a storage device, on which the program described above and various pieces of data are recorded in a manner that is read in a computer (or the CPU), a Random Access Memory (RAM) on which the program is loaded, and the like. Then, the computer (or the CPU) reads the program described above from the recording medium described above and executes the program that is read. Thus, the object of the present invention is accomplished. As the recording medium described above, a “non-temporary physical medium”, for example, a tape, a disk, a card, a semiconductor memory, a programmable circuit, or the like can be used. Furthermore, the program described above may be supplied to the computer described above through a prescribed transfer medium (a communication network, a broadcast wave, or the like) over which the program is possibly transferred. It is noted that the present invention can also be realized in the form of a data signal that is embodied by the program described above being electronically transferred and is modulated on a carrier wave.

### CONCLUSION 1

A terminal apparatus (2) according to an embodiment 1 of the present invention is a terminal apparatus that outputs recommendation information, including a format selection unit (a recommendation information acquisition unit 208) that selects a format in which the recommendation information is output, from among a plurality of formats (pieces of layout information 114), and an output control unit (a recommendation screen generation unit 208) that outputs the recommendation information in the format which is selected by the format selection unit.

With the configuration described above, because the recommendation information is output in the format that is selected from among the plurality of formats, an effect is archived in which diversity can be provided to an output mode of the recommendation information.

A terminal apparatus according to an embodiment 2 of the present invention is the terminal apparatus according to the embodiment 1, in which the format selection unit may select a format in accordance with the recommendation information that is output.

With the configuration described above, because the format in accordance with the recommendation information is selected, the recommendation information can be presented to a user in the output mode in accordance with the recommendation information.

A terminal apparatus according to an embodiment 3 of the present invention is the terminal apparatus according to the embodiment 2, in which the format selection unit may select at least one of a format for display output and a format for speech output, according to the recommendation information that is output.

With the configuration described above, because at least one of the format for the display output and the format for the speech output according to the recommendation information can be selected, the recommendation information of which the display output is preferable can be output for display and the recommendation information of which the speech output is preferable can be output in speech. Furthermore, the speech output as well as the display output is possible.

A terminal apparatus according to an embodiment 4 of the present invention is the terminal apparatus according to any one of the embodiments 1 to 3, in which the format selection unit may select a format in accordance with a point in time at which the recommendation information is output or a time span during which the recommendation information output.

With the configuration described above, because the format in accordance with the point in time at which the recommendation information is output or the time span during which the recommendation information output is selected, the recommendation information can be presented to the user in the output mode in accordance with the point in time and the time span.

A terminal apparatus according to an embodiment 5 of the present invention is the terminal apparatus according to any one of the embodiments 1 to 4, in which the format selection unit may select a format in accordance with the user who is detected in the vicinity of the terminal apparatus.

With the configuration described above, only by approaching the terminal apparatus, the user can be provided with the recommendation information in accordance with the user himself/herself.

A terminal apparatus according to an embodiment 6 of the present invention is the terminal apparatus according to any one of the embodiments 1 to 5, which may further include an activation control unit that causes the terminal apparatus to be activated, in a case where the user that is a target to which the recommendation information is presented is detected.

With the configuration described above, the terminal apparatus is caused to be activated in the case where the user that is the target to which the recommendation information is presented is detected. Consequently, when a situation occurs where the user of the terminal apparatus who is the presentation target is present and the recommendation information can be present to the user of the terminal apparatus, the terminal apparatus can be caused to be automatically activated and recommendation information can be presented.

A terminal apparatus according to an embodiment 7 of the present invention is the terminal apparatus according to any one of the embodiments 1 to 6, which may further include an activation control unit that causes the terminal apparatus to be activated, in a case where the user who is a target to which the recommendation information is presented is detected.

With the configuration described above, in a case where it is detected that the user who is the target to which the recommendation information is presented is absent, because the activation of terminal apparatus is caused to be stopped, the user who ends the use of the terminal apparatus can cause the terminal apparatus to be stopped, only by moving away from the terminal apparatus.

A control server (a server 1) according to an embodiment 8 of the present invention is a control server that causes a terminal apparatus (2) to output recommendation information, including a format selection unit (a layout selection unit 104) that selects a format in which the recommendation information is output, from among a plurality of formats, and an output control unit (an information transmission unit 105) that notifies the terminal apparatus of the format which is selected by the format selection unit and causes the terminal apparatus to output the recommendation information in the format.

With the configuration described above, because the recommendation information is caused to be output in the format that is selected from among the plurality of formats, an effect is archived in which diversity can be provided to an output mode of the recommendation information.

A recommending system (5) according to an embodiment 9 of the present invention is a recommending system including a terminal apparatus (2) that outputs recommendation information and a control server (a server 1) that causes the terminal apparatus to output the recommendation information, in which the control server selects a format from a plurality of formats and notifies the terminal apparatus of the selected format, and the terminal apparatus outputs the recommendation information in the format that is notified by the control server.

With the configuration described above, because the recommendation information is caused to be output in the format that is selected from among the plurality of formats, an effect is archived in which diversity can be provided to an output mode of the recommendation information.

A terminal apparatus (2) according to an embodiment 10 of the present invention is a terminal apparatus that outputs recommendation information, including an information acquisition unit (a user specification unit 202) that acquires at least one of situation information indicating a situation that occurs when the terminal apparatus outputs the recommendation information, and historical information on operation of another terminal apparatus that is different from the terminal apparatus, and a recommendation information acquisition unit (203) that acquires the recommendation information in accordance with the information that is acquired by the information acquisition unit.

With the configuration described above, at least one of the situation information and the historical information on the operation is acquired and the recommendation information in accordance with the acquired information is acquired. Consequently, the recommendation information in accordance with at least one of the situation of the terminal apparatus and the history of the operation of the other terminal apparatus can be acquired.

A terminal apparatus according to an embodiment 11 of the present invention is the terminal apparatus according to the embodiment 10 of the present invention, in which the information acquisition unit may acquire the situation information indicating the number of users that are detected in the vicinity of the terminal apparatus, and in which the recommendation information acquisition unit may acquire the recommendation information in accordance with the number of users that is indicated by the situation information.

With the configuration described above, because the recommendation information in accordance with the number of users in the vicinity of the terminal apparatus is acquired, the recommendation information in accordance with the number of users that are presentation targets can be output.

A terminal apparatus according to an embodiment 12 of the present invention is the terminal apparatus according to the embodiment 10 or 11 of the present invention, in which the information acquisition unit may acquire the situation information indicating a point in time at which the recommendation information is output or a time span during which the recommendation information is output, and the recommendation information acquisition unit may acquire the recommendation information in accordance with the point in time or the time span that is indicated by the situation information.

With the configuration described above, because the recommendation information in accordance with the point in time or the time span is acquired, the recommendation information in accordance with the point in time or the time span can be output.

A terminal apparatus according to an embodiment 13 of the present invention is the terminal apparatus according to any one of the embodiments 10 to 12 of the present invention, in which the information acquisition unit may acquire the historical information on the operation, which indicates a history of content that is viewed by the user of the other terminal apparatus in the other terminal apparatus, and the recommendation information acquisition unit may acquire the recommendation information in accordance with the history of the content, which is indicated by the historical information on the operation.

With the configuration described above, because the recommendation information in accordance with the history of the content that is viewed by the user of the other terminal apparatus in the other terminal apparatus is acquired, the recommendation information in accordance with which content is viewed by the other user can be output.

A terminal apparatus according to an embodiment 14 of the present invention is the terminal apparatus according to any one of the embodiments 10 to 13, in which the recommendation information acquisition unit may acquire information indicating content that is provided by an external server, as the recommendation information, from the external server.

With the configuration described above, because the information indicating the content that is provided by the external server is acquired as the recommendation information from the external server, the information that is not stored in the terminal apparatus can be output as the recommendation information. For example, the external server may be a server of an EC business operator. In this case, it is also possible that the user of the terminal apparatus acquires the recommendation information in accordance with a history of the past purchase that was performed through the server of the EC business server and outputs the acquired recommendation information.

A control server (a server 1) according to an embodiment 15 of the present invention is a control server that causes a terminal apparatus (2) to output recommendation information, including an information acquisition unit (an information management unit 103) that acquires at least one of situation information indicating a situation that occurs when the terminal apparatus outputs the recommendation information, and historical information on operation of another terminal apparatus that is different from the terminal apparatus, and an output control unit (an information transmission unit 105) that causes the terminal apparatus to output the recommendation information in accordance with the information that is acquired by the information acquisition unit.

With the configuration described above, at least one of the situation information and the historical information on the operation is acquired and the terminal apparatus is caused to output the recommendation information in accordance with the acquired information. Consequently, the recommendation information in accordance with at least one of the situation of the terminal apparatus and the history of the operation of the other terminal apparatus can be caused to be output.

A recommending system (5) according to an embodiment 16 of the present invention is a recommending system including a terminal apparatus (2) that outputs recommendation information and a control server (a server 1) that causes the terminal apparatus to output the recommendation information, in which the control server acquires at least one of a situation information indicating a situation that occurs when the terminal apparatus outputs the recommendation information and historical information on operation of anther terminal apparatus that is different from the terminal apparatus and notifies the terminal apparatus of the recommendation information in accordance with the acquired information, and the terminal apparatus outputs the recommendation information that is notified by the control server.

With the configuration described above, the control server acquires at least one of the situation information and the historical information on the operation and notifies the terminal apparatus of the recommendation information in accordance with the acquired information, and the terminal apparatus outputs the recommendation information. Consequently, the recommendation information in accordance with at least one of the situation of the terminal apparatus and the history of the operation of the other terminal apparatus can be output.

The terminal apparatus and the control server according to each of the embodiments of the present invention may be realized by a computer. In this case, a program for controlling the terminal apparatus, and a program for controlling the control server, which causes the computer to operate as each unit (software element) that is included in each of the terminal apparatus and the control server and thus realizes the terminal apparatus and the control server in the computer, and a computer-readable recording medium on which each of the programs is recorded fall within the scope of the present invention as well.

### CONCLUSION 2

There is room for improving a mode of presenting content that is recommended to a user in the related art that is brought up in “Background Art”. That is, in PTL 1 and PTL 2, which are described above, how a display screen has to be handled when the content that is recommended is presented to a user is not disclosed. Furthermore, in PTL 3 described above, it is disclosed that performer in performing a piece of music and a title of the piece of music are displayed. However, this display is sufficient in a case where a user intends to listen to the piece of music, which display is sufficient, but it is difficult to induce the user to take an action of listening to the piece of music when the user does not intend to listen to the piece of music.

An object of an aspect of the present invention, which was made in view of the problems described above, is to provide a control apparatus or the like that is capable of inducing a user to view content that is recommended, for example, even when the user does not intend to view the content.

A control apparatus (STB 3) according to an aspect 1 of the present invention is a control apparatus that causes a display apparatus (terminal apparatus 4) to display recommendation information (card 70) on content, including a user detection unit (user's presence-and-absence determination unit 300) that detects a user in the vicinity of the control apparatus, and a recommendation control unit (303) that causes the display apparatus to display a recommendation screen on which one or more of the pieces of recommendation information are arranged, in response the detection of the user by the user detection unit, in which a current date and a message associated with the current date, a weather forecast, an object for causing the display apparatus to end display of the recommendation screen and to start display of broadcast content, and an object for causing the display apparatus to update the recommendation information that is positioned on the recommendation screen are included in the recommendation screen, in which the one piece of recommendation information is information in which association information that is associated with the content is displayed within one object for causing the content that is recommended to be selected, and in which an image indicating an operation that is performed in the display apparatus in a case where the recommendation information is selected, a title of the content, an image indicating the content, time information relating to the content, and a message indicating the reason for the recommendation of the content are included in the association information.

With the configuration described above, the recommendation screen is caused be displayed according to the detection of the user. Consequently, the recommendation screen is displayed not only in a case where the user approaches the control apparatus in an attempt to view the content, but also when the user approaches the control apparatus without the intention to view the content.

Then, the current date, and the message and the weather forecast that are associated with the current date are displayed on the recommendation screen. These pieces of information vary from date to date, and are pieces of information in which many users are interested. Because of this, the display of these pieces of information causes the user to pay attention to the recommendation screen.

Furthermore, the object for causing the display of the recommendation screen to be ended and causing the display of broadcast content to be started, and the object for causing the recommendation information that is positioned on the recommendation screen to be updated are included in the recommendation screen. Consequently, the user who approaches the control apparatus and the display apparatus in order to view the broadcast content can quickly start to view the broadcast content. Furthermore, the user who approached the control apparatus in an attempt to view the content that is recommended can easily check another piece that is recommended.

Moreover, the recommendation information is information in which the association information that is associated with the content is displayed within the one object for causing the content that is recommended to be selected. Then, the image indicating the operation that is performed in the display apparatus at the time of the selection, the title, the image indicating the content, the time information, and the message indicating the reason for the recommendation are included in the association information. Consequently, because the user can be caused to recognize which content is recommended, the user can be motivated to start to view the content.

Consequently, an effect is achieved in which the user is induced to view the content that is recommended, not only when the user intends to view the content, but also when the user does not intend to view the content. It is noted that the control apparatus and the display apparatus may be different apparatuses that are independent of each other and may be integrally configured as a single apparatus.

A control apparatus according to an aspect 2 of the present invention is the control apparatus according to the aspect 1 that may further include a message selection unit that selects a message from among a plurality of messages that include a message relating to the recommendation information and a message that is not associated at least directly with the recommendation information; and a speech output control unit that causes the message that is selected by the message selection unit, to be output in speech.

With the configuration described above, the message is selected from among the message relating to the recommendation information and the plurality of messages that include the message that is not associated at least directly with the recommendation information, and is caused to be output in speech. Consequently, because diversity is provided to the message when compared with a case where only the message relating to the recommendation information is output in speech, the user can be caused to listen to the message relating to the recommendation information, without being sick and tired of the message.

A control apparatus according to an aspect 3 of the present invention is the control apparatus according to the aspect 1 or 2 that may employ a configuration in which the recommendation information that the display apparatus is caused to display is set to be able to be selected with a plurality of prescribed selection keys that are included in a remote control device, in which the recommendation control unit causes the display apparatus to display pieces of recommendation information that correspond to the plurality of prescribed selection keys, respectively, on one screen, and in a case where any of the selection keys is operated, the recommendation control unit causes the display apparatus to output content relating to recommendation information that corresponds to the selection key.

With the configuration described above, because the pieces of recommendation information that correspond to the plurality of prescribed selection keys, respectively, are caused to be displayed on the one screen, each piece of recommendation information can be caused to be recognized at first glance. Moreover, in a case where any of the selection keys is operated, because the content relating to the recommendation information that corresponds to the selection key is output, the recommendation information can be caused to be selected with a simple operation and thus the content relating to the recommendation information can be caused to be output.

A control apparatus according to an aspect 4 of the present invention is the control apparatus (STB 3) according to any one of the aspects 1 to 3 in which, in a case where content relating to the recommendation information that the display apparatus is caused to display is broadcast content, the recommendation control unit may cause the display apparatus to end display of the recommendation information according to the broadcast time for the content being a prescribed time or shorter.

With the configuration described above, in the case where the content relating to the recommendation information that the display apparatus is caused to display is the broadcast content, the display of the recommendation information is caused to be ended according to the broadcast time for the content being the presented time or shorter. Consequently, the broadcast content, the broadcast time for which remains short can be prevented from being recommended to the user.

A control apparatus according to an aspect 5 of the present invention is the control apparatus according to any one of the aspects 1 to 4 that may further include a recommendation information acquisition unit (301) that acquires recommendation information from a server (1) that provides the recommendation information; and a details-of-recommendation changing unit (details-of-recommendation determination unit) that changes display details of the recommendation information that is acquired by the recommendation information acquisition unit, to display details in accordance with a timing at which the display apparatus is caused to display the recommendation information.

With the configuration described above, the display details of the acquired recommendation information are changed to the display details in accordance with the timing at which the recommendation information is caused to be displayed. Consequently, the recommendation information of which suitable details is in accordance with the timing at which the recommendation information is caused to be displayed can be caused to be displayed. For example, it is also possible that, in a case where the recommendation information that includes a thumbnail image is acquired, an acquisition point in time is within a period of time for which display of the thumbnail image is approved, but a point of time for causing the recommendation information to be displayed is not within the period of time, the thumbnail image is set not to be displayed.

A control apparatus according to an aspect 6 of the present invention is the control apparatus according to the aspect 5 in which, in a case where a thumbnail image of the content is included, as an image indicating the content in the association information, in the recommendation information that is acquired by the recommendation information acquisition unit, but information that approves display of the thumbnail image is not included at least at a point of time at which the recommendation information is caused to be displayed, the details-of-recommendation changing unit may cause an image indicating a genre of the content as an image indicating the content in the association information.

With the configuration described above, in the case where thumbnail image is included in the acquired recommendation information, but information that approves display of the thumbnail image at a point of time at which at least the recommendation information is caused to be displayed is not included, the thumbnail image in the recommendation information is changed to the image indicating the genre of the content. Consequently, the thumbnail image of which the display is not approved can be prevented from being displayed, and along with this, even in a case where the thumbnail image is not displayed, the user can be caused to recognize the genre of the content and thus, can easily select the content.

A control apparatus according to an aspect 7 of the present invention is the control apparatus according to any one of the aspects 1 to 6 that may further include a recommendation information acquisition unit (301) that acquires a plurality of pieces of recommendation information from a server that provides the pieces of recommendation information; and a details-of-recommendation determination unit (302) that determines recommendation information which the display apparatus is caused to display, among the plurality of pieces of recommendation information that are acquired by the recommendation information acquisition unit, in which the details-of-recommendation determination unit may determine recommendation information that is caused to be displayed according to a priority level that is set for each of the plurality of pieces of recommendation information, and, in a case where the plurality of pieces of recommendation information include indispensable recommendation information that includes display-indispensable information indicating that display is indispensable, the details-of-recommendation determination unit may determine that the indispensable recommendation information is caused to be displayed, regardless of the priority level.

With the configuration described above, while the recommendation information is displayed according to the priority level, the indispensable recommendation information can be caused to be necessarily displayed in a case where the indispensable recommendation information is included.

A control apparatus according to an aspect 8 of the present invention is the control apparatus according to any one of the aspects 1 to 7 that may further include a recommendation information acquisition unit (301) that acquires the recommendation information from a server that provides the recommendation information; and a result-of-selection notification unit (FB processing unit) that specifies each of the recommendation information that is selected by the user and the recommendation information that not selected by the user, among the pieces of recommendation information that the display apparatus is caused to display, and notifies a prescribed notification-destination apparatus of a result of the specification.

With the configuration described above, each of the recommendation information that is selected by the user and the recommendation information that is not selected by the user is specified and the result of the specification is notified to the server. Consequently, when the recommendation information is subsequently acquired from the server, it is possible that the recommendation information that is selected based on not only a history showing which recommendation information the user selects, but also a history showing which recommendation information the user does not select.

A control apparatus according to an aspect 9 of the present invention is the control apparatus according to any one of the aspects 1 to 8 that may be configured to include a speech output control unit (user's presence-and-absence determination unit 300) that causes a message destined for the user to be output in speech from a first speech output unit (STB speech output unit 35) that is included in the control apparatus, in response to the detection of the user by the user detection unit; and a recommendation speech output control unit (recommendation control unit 303) that causes the display apparatus, not only to display the recommendation information on the display apparatus, but also to output a message relating to the recommendation information in speech from a second speech output unit (terminal speech output unit 41) that is included in the display apparatus.

With the description described above, the message destined for the user is caused to be output in speech from the first speech output unit that is included in the control apparatus, according to the detection of the user in the vicinity of the control apparatus. Because the first speech output unit is included in the control apparatus that detects the user, the message destined for the user can be quickly output in speech and thus, the detected user can be kept staying for the time that it takes to display the recommendation information on the display apparatus. Then, the recommendation information is displayed on the display apparatus, and along with this, the message relating to the recommendation information is output in speech from the second speech output unit that is included in the display apparatus. Consequently, the recommendation information that is displayed on the display apparatus gives a strong impression to the user, and can induce the user to view content relating to the recommendation information.

Furthermore, a control method in a control apparatus (STB 3) that causes a display apparatus (terminal apparatus 4) to display recommendation information on content, the same effect as in the aspect 1 is achieved by a control method including: a user detection step (S100) of detecting a user in the vicinity of the control apparatus, a recommendation control step (S106) of causing the display apparatus to display a recommendation screen on which the recommendation information is arranged, according to the detection of the user in the user detection step, in which a current date, a message and a weather forecast that are associated with the current date, an object for causing the display apparatus to end display of the recommendation screen and to start display of broadcast content, and an object for causing the display apparatus to update the recommendation information that is positioned on the recommendation screen are included in the recommendation screen, in which the recommendation information is information in which, for one item of content that is recommended, association information that is associated with the content is displayed within one area that is selectable by the user, and in which an image indicating an operation that is performed in the display apparatus in a case where the recommendation information is selected, a title of the content, an image indicating the content, a broadcast point in time for the content, a delivery start point in time for the content or the time indicating a full running time of the content, and a message indicating the reason for recommending the content are included in the association information; a message selection step (S105) of selecting a message relating to recommendation of the content and a plurality of messages that include a message which is not associated at least directly with the content; and a speech output control step (S106) of causing the message that is selected in the message selection step, to be output in speech.

The terminal apparatus according to each of the aspects of the present invention may be realized by a computer. In this case, a program for controlling the control apparatus, and a control program in the control apparatus, which causes the computer to operate as each unit (software element) that is included in the control apparatus and thus realizes the control apparatus in the computer, and a computer-readable recording medium on which the control program is recorded fall within the scope of the present invention as well.

The present invention is not limited to the embodiments described above, and various changes are possible within the scope as defined by claims. Embodiments that are implemented by suitably combining technical means that are disclosed in the different embodiments fall within the technical scope of the present invention as well. Moreover, novel technological features can be formed by combining the technical means that are disclosed in the embodiments.

### REFERENCE SIGNS LIST

1 SERVER (CONTROL SERVER OR PRESCRIBED NOTIFICATION-DESTINATION APPARATUS)
103 INFORMATION MANAGEMENT UNIT (INFORMATION ACQUISITION UNIT)
104 LAYOUT SELECTION UNIT (FORMAT SELECTION UNIT)
105 INFORMATION TRANSMISSION UNIT (OUTPUT CONTROL UNIT)
114 LAYOUT INFORMATION (FORMAT)
2 TERMINAL APPARATUS
201 USER'S PRESENCE-AND-ABSENCE DETERMINATION UNIT (ACTIVATION CONTROL UNIT)
202 USER SPECIFICATION UNIT (INFORMATION ACQUISITION UNIT)
203 RECOMMENDATION INFORMATION ACQUISITION UNIT (FORMAT SELECTION UNIT)
208 RECOMMENDATION SCREEN GENERATION UNIT (OUTPUT CONTROL UNIT)
3 STB (CONTROL APPARATUS)
35 STB SPEECH OUTPUT UNIT (FIRST SPEECH OUTPUT UNIT)
300 USER'S PRESENCE-AND-ABSENCE DETERMINATION UNIT (USER DETECTION UNIT OR SPEECH OUTPUT CONTROL UNIT)
301 RECOMMENDATION INFORMATION ACQUISITION UNIT
302 DETAILS-OF-RECOMMENDATION DETERMINATION UNIT (MESSAGE SELECTION UNIT OR DETAILS-OF-RECOMMENDATION CHANGING UNIT)
303 RECOMMENDATION CONTROL UNIT (RECOMMENDATION SPEECH OUTPUT CONTROL UNIT)
304 FB PROCESSING UNIT (RESULT-OF-SELECTION NOTIFICATION UNIT)
4 TERMINAL APPARATUS (DISPLAY APPARATUS)
41 TERMINAL SPEECH OUTPUT UNIT (SECOND SPEECH OUTPUT UNIT)
5 RECOMMENDING SYSTEM

1.-11. (canceled)

12. A terminal apparatus comprising:
a recommendation control unit that causes the terminal apparatus to display a recommendation screen on which one or more of the pieces of recommendation information are arranged,
wherein an object for causing the terminal apparatus to update the recommendation information that is positioned on the recommendation screen is included in the recommendation screen.

13. The terminal apparatus according to claim 12, further comprising:
a message selection unit that selects a message from among a plurality of messages that include a message relating to the recommendation information and a message that is not associated at least directly with the recommendation information; and
a speech output control unit that causes the message that is selected by the message selection unit, to be output in speech.

14. The terminal apparatus according to claim 12,
wherein the recommendation information that the terminal apparatus is caused to display is set to be able to be selected with a plurality of prescribed selection keys that are included in a remote control device,
wherein the recommendation control unit causes the terminal apparatus to display pieces of recommendation information that correspond to the plurality of prescribed selection keys, respectively, on one screen, and in a case where any of the selection keys is operated, the recommendation control unit causes the terminal apparatus to output content relating to recommendation information that corresponds to the selection key.

15. The terminal apparatus according to claim 12,
wherein, in a case where content relating to the recommendation information that the terminal apparatus is caused to display is broadcast content, the recommendation control unit causes the terminal apparatus to end display of the recommendation information according to the broadcast time for the content being a prescribed time or shorter.

16. The terminal apparatus according to claim 12, further comprising:
a recommendation information acquisition unit that acquires the recommendation information from a server that provides the recommendation information; and
a details-of-recommendation changing unit that changes display details of the recommendation information that is acquired by the recommendation information acquisition unit, to display details in accordance with a timing at which the terminal apparatus is caused to display the recommendation information.

17. The terminal apparatus according to claim 16,
wherein, in a case where a thumbnail image of the content is included, as an image indicating the content, in the recommendation information that is acquired by the recommendation information acquisition unit, but information that approves display of the thumbnail image is not included at least at a point of time at which the recommendation information is caused to be displayed, the details-of-recommendation changing unit causes an image indicating a genre of the content as an image indicating the content.

18. The terminal apparatus according to claim 12, further comprising:
a recommendation information acquisition unit that acquires a plurality of pieces of recommendation information from a server that provides the pieces of recommendation information; and
a details-of-recommendation determination unit that determines recommendation information which the terminal apparatus is caused to display, among the plurality of pieces of recommendation information that are acquired by the recommendation information acquisition unit,
wherein the details-of-recommendation determination unit determines recommendation information that is caused to be displayed according to a priority level that is set for each of the plurality of pieces of recommendation information, and, in a case where the plurality of pieces of recommendation information include indispensable recommendation information that includes display-indispensable information indicating that display is indispensable, the details-of-recommendation determination unit determines that the indispensable recommendation information is caused to be displayed, regardless of the priority level.

19. The terminal apparatus according to claim 12, further comprising:
a recommendation information acquisition unit that acquires the recommendation information from a server that provides the recommendation information; and
a result-of-selection notification unit that specifies each of the recommendation information that is selected by the user and the recommendation information that is not selected by the user, among the pieces of recommendation information that the terminal apparatus is caused to display, and notifies a prescribed notification-destination apparatus of a result of the specification.

20. The terminal apparatus according to claim 12, further comprising:
a user detection unit that detects a user in the vicinity of the terminal apparatus,
a speech output control unit that causes a message destined for the user to be output in speech from a first speech output unit that is included in the terminal apparatus, in response to the detection of the user by the user detection unit; and
a recommendation speech output control unit that causes the terminal apparatus, not only to display the recommendation information, but also to output a message relating to the recommendation information in speech from a second speech output unit that is included in the terminal apparatus.

21. The terminal apparatus according to claim 12, further comprising:
a format selection unit that selects a format in which the recommendation information is output, from among a plurality of formats; and
an output control unit that outputs the recommendation information in the format that is selected by the format selection unit.

22. The terminal apparatus according to claim 21,
wherein the format selection unit selects a format in accordance with at least one of the recommendation information that is output, a point in time at which the recommendation information is output or a time span during which the recommendation information is output, and a user who is detected in the vicinity of the terminal apparatus.

23. The terminal apparatus according to claim 22,
wherein the format selection unit selects at least one of a format for display output and a format for speech output, in accordance with the recommendation information that is output.

24. The terminal apparatus according to claim 12, further comprising:
an activation control unit that causes the terminal apparatus to be activated in a case where a user who is a target to which the recommendation information is presented is detected and that stops the activation of the terminal apparatus in a case where the user who is the target to which the recommendation information is presented is absent.

25. The terminal apparatus according to claim 12, further comprising:
an information acquisition unit that acquires historical information on operation of another terminal apparatus that is different from the terminal apparatus; and
a recommendation information acquisition unit that acquires the recommendation information in accordance with the information that is acquired by the information acquisition unit.

26. The terminal apparatus according to claim 25,
wherein the information acquisition unit acquires a situation information indicating the number of users that are detected in the vicinity of the terminal apparatus, and
wherein the recommendation information acquisition unit acquires the recommendation information in accordance with the number of users that is indicated by the situation information.

27. The terminal apparatus according to claim 25,
wherein the information acquisition unit acquires a situation information indicating a point in time at which the recommendation information is output or a time span during which the recommendation information is output, and
wherein the recommendation information acquisition unit acquires the recommendation information in accordance with the point in time or the time span that is indicated by the situation information.

28. The terminal apparatus according to claim 25,
wherein the information acquisition unit acquires the historical information on the operation that indicates a history of content that is viewed by the user of the other terminal apparatus with the other terminal apparatus, and
wherein the recommendation information acquisition unit acquires the recommendation information in accordance with the history of the content indicated by the historical information on the operation.

29. The terminal apparatus according to claim 25,
wherein the recommendation information acquisition unit acquires information indicating content that is provided by an external server, as the recommendation information, from the external server.

30. A control server that causes a terminal apparatus to output recommendation information, comprising:
an information acquisition unit that acquires historical information on operation of another terminal apparatus that is different from the terminal apparatus; and
an output control unit that causes the terminal apparatus to output the recommendation information in accordance with the information that is acquired by the information acquisition unit.

31. The control server according to claim 30, further comprising:
a format selection unit that selects a format in which the recommendation information is output, from among a plurality of formats; and
wherein the output control unit notifies the terminal apparatus of the format which is selected by the format selection unit and causes the terminal apparatus to output the recommendation information in the format.

32. A television receiver comprising:
a recommendation control unit that causes the television receiver to display a recommendation screen on which one or more of the pieces of recommendation information are arranged,
wherein an object for causing the television receiver to update the recommendation information that is positioned on the recommendation screen is included in the recommendation screen.

33. A control method in the terminal apparatus, the method comprising:
a step of causing the terminal apparatus to display a recommendation screen on which one or more of the pieces of recommendation information are arranged,
wherein an object for causing the terminal apparatus to update the recommendation information that is positioned on the recommendation screen is included in the recommendation screen.

34. A computer-readable non-transitory recording medium containing a control program for causing a computer to serve as a terminal apparatus, the control program causing the computer to execute the step according to claim 33.
